(19) United States
(12) Patent Application Publication
(10) Pub. No.: US 2024/0044851 A1
(43) Pub. Date: Feb. 8, 2024

(54) METHOD FOR DETECTING CONTENT OF ACTIVE INGREDIENTS OF COMPOUND SOPHORAE FLAVESCENTIS RADIX INJECTION AND FINGERPRINT SPECTRUM THEREOF

(71) Applicant: BEIJING ZHENDONG GUANGMING PHARMACEUTICAL RESEARCH INSTITUTE CO., LTD., Shangdi, Haidian District Beijing (CN)

(72) Inventors: Lina HAI, Shangdi, Haidian District Beijing (CN); Jinghui WANG, Shangdi, Haidian District Beijing (CN); Pengfei WANG, Shangdi, Haidian District Beijing (CN); Xiumei DUAN, Shangdi, Haidian District Beijing (CN); Wenjie QIN, Shangdi, Haidian District Beijing (CN); Hongyu WANG, Shangdi, Haidian District Beijing (CN)

(73) Assignee: BEIJING ZHENDONG GUANGMING PHARMACEUTICAL RESEARCH INSTITUTE CO., LTD., Shangdi, Haidian District Beijing (CN)

(21) Appl. No.: 18/255,303

(22) PCT Filed: Nov. 30, 2021
(86) PCT No.: PCT/CN2021/134477

§ 371 Date: May 31, 2023

(30) Foreign Application Priority Data
Dec. 2, 2020 (CN) 202011391813.X

(51) Int. Cl. G01N 30/34; G01N 30/86

(52) U.S. Cl. CPC G01N 30/34; G01N 30/8686; G01N 2030/027

(57) ABSTRACT

A method for detecting the content of active ingredients of a compound Sophorae flavescentis radix injection and the fingerprint spectrum thereof. The method comprises using high performance liquid chromatography to perform detection, wherein the high performance liquid chromatography is operated under the condition of a C18 chromatographic column, and active ingredients comprise matrine, oxymatrine, macrozamin, sophocarpine, oxysophocarpine, sophoridine, or/and piscidic acid. The present method is an improved method for performing detection on a compound Sophorae flavescentis radix injection, by means of same, seven ingredients in the compound Sophorae flavescentis radix injection can be simultaneously determined, and a chromatographic fingerprint spectrum can be constructed, thereby providing a technical method for quality control of a compound Sophorae flavescentis radix injection.

### TECHNICAL FIELD

The present application belongs to the field of a pharmaceutical technology, and specifically relates to an improved method for detecting a content and fingerprint of active ingredients in Compound Kushen Injection.

### BACKGROUND ART

A Compound Kushen Injection is a traditional Chinese medicine injection refined by modern scientific methods from two traditional Chinese medicines, Sophora flavescens and Heterosmilax yunnanensis Gagnep. It is included in the National Drug Standards and has the effects of clearing heat, promoting dampness, cooling blood, detoxifying, dispersing nodules and relieving pain. It is used for treating cancer pain and bleeding. Modern researches have shown that it has various pharmacological effects such as anti-tumor effect, anti-inflammatory effect, analgesic effect, and enhancing immunity of a body. It is widely used in clinical practice as an adjuvant therapy for severe diseases such as a non-small cell lung cancer, a primary liver cancer, a gastrointestinal cancer, and a malignant pleural effusion.

The main components of Sophora flavescens are alkaloids and flavonoids. Modern researches have shown that Sophora flavescens alkaloids have multiple pharmacological effects and are the main pharmacological components of the Compound Kushen Injection. At present, there are few research reports on Heterosmilax yunnanensis Gagnep both at home and abroad, and research on its chemical composition, quality, and pharmacology is relatively limited.

The existing national drug standard for Compound Kushen Injection (WS3-B-2752-97-2014) includes HPLC methods for the determination of contents of matrine and oxymatrine (Radix Sophora flavescens), and macrozamin (Heterosmilax yunnanensis Gagnep), respectively. The former method is relatively cumbersome in sample preparation, while the latter method has low column utilization. At the same time, in the detection conditions of fingerprints, there is a significant damage to the chromatographic column, and the overall spectrum has a poor peak shape. All the three determination conditions cause damage to the chromatographic column and are time-consuming and labor-intensive. Therefore, the detection and fingerprint methods for Compound Kushen Injection need to be modified and improved.

Li Huali et al. disclosed, in “Simultaneous Determination of the Contents of 6 Alkaloids in Sophora Flavescens Dispensing Granules by HPLC-DAD Method”, the establishment of an HPLC-DAD method for simultaneous determination of the contents of 6 active alkaloids in Sophora Flavescens Dispensing Granules, including Sophoranol n-oxide, oxymatrine, sophoridine, oxysophocarpine, matrine, and sophocarpine. It can be seen from the chromatographic conditions that it is relatively similar to the fingerprint chromatogram conditions included in the National Drug Standards. When examining the Compound Kushen Injection under these conditions, the chromatographic peak is slightly trailing and is not suitable for the determination of the Compound Kushen Injection.

Therefore, in order to effectively control the quality of the Compound Kushen Injection, it is necessary to provide a method that can simultaneously determine the content and fingerprint of multiple components of Compound Kushen Injection, so as to provide a fast and efficient technical method for quality control in Compound Kushen Injection, while reducing the workload for testing.

### SUMMARY

In view of the above technical status, the present application provides an improved method for detecting contents and fingerprints of active ingredients in Compound Kushen Injection. The method adopts a high-performance liquid chromatography for detection, in which conditions for the high-performance liquid chromatography include: a C₁₈ column as the chromatographic column; and active ingredients, including matrine, oxymatrine, macrozamin, sophocarpine, oxysophocarpine and sophoridine, or/and 2,3-dihydroxy-2-[(4-hydroxyphenyl)methyl]butanedioic acid (also named “piscidic acid”).

In the method of the present application, as one of the embodiments, the chromatographic column is preferably Waters XSelect CSH™ C₁₈, TechMate C₁₈-ST, Welch Ultimate AQ-C₁₈, and Waters SunFire C₁₈, more preferably Waters XSelect CSH™ C₁₈, with a dimension of 5 μm and 4.6 mm×250 mm.

In the method of the present application, as one of the embodiments, the method further includes a mobile phase consisting of methanol in the organic phase and a phosphate buffer gradient elution in the aqueous phase; preferably 0.1%-0.34% potassium dihydrogen phosphate (adjusted to pH 3.0 with phosphoric acid)-methanol gradient elution; more preferably, 0.2% potassium dihydrogen phosphate (adjusted to pH 3.0 with phosphoric acid)-methanol gradient elution.

In the method of the present application, as one of the embodiments, the pH value of potassium dihydrogen phosphate solution is adjusted with phosphoric acid, preferably to 2.9-3.1, and more preferably to 3.0.

In the method of the present application, as one of the embodiments, the gradient elution conditions are as follow:

| | | 0.2% potassium dihydrogen |
|---|---|---|
| | | phosphate (adjusted to pH3.0 |
| time (min) | methanol (%) | with phosphoric acid) (%) |
| 0-10 | 3 | 97 |
| 10-15 | 3-5 | 97-95 |
| 15-24 | 5-15 | 95-85 |
| 24-30 | 15 | 85 |
| 30-55 | 15-85 | 85-15 |
| 55-60 | 85 | 15 |
| 60-75 | 3 | 97 |

In the method of the present application, as one of the embodiments, the high performance liquid chromatography conditions in the method include a column temperature of 28-32° C., preferably 30° C.

In the method of the present application, as one of the embodiments, the high performance liquid chromatography conditions in the method include a flow rate of 0.58-0.62 ml/ml, preferably 0.6 ml/min.

In the method of the present application, as one of the embodiments, the high performance liquid chromatography conditions in the method include a detection wavelength of 209-213 nm, preferably 211 nm.

In the method of the present application, as one of the embodiments, the high performance liquid chromatography conditions in the method include an injection amount of 3-20 μl, preferred 5-15 μl, more preferred 8-12 μl, and most preferably 10 μl.

In the method of the present application, as one of the embodiments, the high performance liquid chromatography conditions in the method include preparation of a blank solution: adjusting a pH value of potassium dihydrogen phosphate solution to 3.0 with phosphoric acid, preparing a mixed solution of 0.2% potassium dihydrogen phosphate solution-methanol=85:15, and filtering.

In the method of the present application, as one of the embodiments, the high performance liquid chromatography conditions in the method include:
preparation of reference substance solution:
accurately weighing an appropriate amount of matrine reference substance, oxymatrine reference substance, and oxysophocarpine reference substance, adding the blank solution to prepare a mixed reference substance solution I containing 0.33 mg of matrine, 0.85 mg of oxymatrine, and 0.25 mg of oxysophocarpine per 1 ml, and shaking; accurately weighing an appropriate amount of sophocarpine reference substance, sophoridine reference substance, and macrozamin reference substance, adding the blank solution to prepare a mixed reference substance solution II containing 0.09 mg of sophocarpine, 0.08 mg of sophoridine, and 0.08 mg of macrozamin per 1 ml, and shaking; and accurately weighing 2 ml of the mixed reference substance solution I and II, adding to a 10 ml volumetric flask, diluting with the blank solution to scale, and shaking; or
accurately weighing an appropriate amount of 2,3-dihydroxy-2-[(4-hydroxyphenyl)methyl]butanedioic acid reference substance, adding the blank solution to prepare a reference substance stock solution containing 0.25 mg of 2,3-dihydroxy-2-[(4-hydroxyphenyl)methyl]butanedioic acid per 1 ml, and shaking; and accurately weighing 2 ml of the reference substance stock solution, adding to a 10 ml volumetric flask, diluting with the blank solution to scale, and shaking.

In the method of the present application, as one of the embodiments, the content of the reference substance in the reference substance solution can be in the following range: preferably 0.28-0.40 mg and most preferably 0.33 mg for matrine; preferably 0.72-1.06 mg and most preferably 0.85 mg for oxymatrine; preferably 0.21-0.31 mg and most preferably 0.25 mg for oxysophocarpine; preferably 0.07-0.11 mg for sophocarpine, sophoridine, and macrozamin, and most preferably, 0.09 mg, 0.08 mg, and 0.08 mg, respectively.

In the method of the present application, as one of the embodiments, the high performance liquid chromatography conditions in the method include the preparation of the test substance solution: accurately weighing 1 ml of Compound Kushen Injection, adding to a 50 ml volumetric flask, adding a blank solution to scale, shaking, filtering, and taking the subsequent filtrate as the test substance solution.

In the method of the present application, as one of the embodiments, a method for detecting the content of active ingredients in Compound Kushen Injection is provided. The method includes performing detection by using a high-performance liquid chromatography method, in which the high-performance liquid chromatography conditions include:

| | Detection conditions | | |
|---|---|---|---|
| Chromatographic | Waters XSelect CSH ™ C18 (5 μm, 4.6 mm × 250 mm) | | |
| column | | | |
| Mobile phase | 0.2% Potassium dihydrogen phosphate solution | | |
| | (adjusted to pH 3.0 with phosphoric acid)-Methanol | | |
| | gradient elution | | |
| | | Methanol | 0.2% Potassium |
| | Time (min) | (%) | dihydrogen phosphate (%) |
| Elution | 0-10 | 3 | 97 |
| gradient | 10-15 | 3-5 | 97-95 |
| | 15-24 | 5-15 | 95-85 |
| | 24-30 | 15 | 85 |
| | 30-55 | 15-85 | 85-15 |
| | 55-60 | 85 | 15 |
| | 60-75 | 3 | 97 |

| | | |
|---|---|---|
| Column | 30° | C. |
| temperature | | |
| Detection | 211 | nm |
| length | | |
| Flowing speed | 0.6 | ml/min |
| Injection | 10 | μl |
| volume | | |

(1) Preparation of a blank solution: adjusting the pH value of potassium dihydrogen phosphate solution to 3.0 with phosphoric acid, mixing 0.2% potassium dihydrogen phosphate solution (adjusting the pH value to 3.0 with phosphoric acid) with methanol at a ratio of 85:15, and filtering;
(2) Preparation of a reference substance solution: accurately weighing an appropriate amount of matrine reference substance, oxymatrine reference substance, and oxysophocarpine reference substance, adding the blank solution to prepare a mixed reference substance solution I containing 0.33 mg of matrine, 0.85 mg of oxymatrine, and 0.25 mg of oxysophocarpine per 1 ml, and shaking; accurately weighing an appropriate amount of sophocarpine reference substance, Sophoridine reference substance, and macrozamin reference substance, adding a blank solution to prepare a mixed reference substance solution II containing 0.09 mg of sophocarpine, 0.08 mg of Sophoridine, and 0.08 mg of macrozamin per 1 ml, and shaking; and accurately weighing 2 ml of mixed reference substance solution I and II, adding to a 10 ml volumetric flask, diluting with the blank solution to scale, shaking, and optionally preparing two copies using the same method;
(3) Preparation of test substance solution: accurately weighing 1 ml of Compound Kushen Injection, adding to a 50 ml volumetric flask, adding the blank solution to scale, shaking, filtering to obtain a subsequent filtrate as the test substance solution; and
(4) Injecting the blank solution, the reference substance solution, and the test substance solution into the liquid chromatograph in sequence, recording the chromatogram, and calculating the content using an external standard method.

In the method of the present application, as one of the embodiments, a method for detecting a fingerprint of a Compound Kushen Injection includes: constructing a fingerprint of the Compound Kushen Injection containing matrine, oxymatrine, macrozamin, sophocarpine, oxysophocarpine, and sophoridine.

In the method of the present application, as one of the embodiments, the present application provides a method for detecting the fingerprint of the Compound Kushen Injection, which includes:
performing detection by using a high-performance liquid chromatography, in which the conditions for the high-performance liquid chromatography include:

| | Detection conditions | | |
|---|---|---|---|
| Chromatographic | Waters XSelect CSH ™ C₁₈ (5 μm, 4.6 mm × 250 mm) | | |
| column | | | |
| Mobile phase | 0.2% Potassium dihydrogen phosphate solution | | |
| | (adjusted to pH 3.0 with phosporic acid)- | | |
| | Methanol gradient elution | | |
| | | Methanol | 0.2% Potassium |
| | Time (min) | (%) | dihydrogen phosphate (%) |
| Elution | 0-10 | 3 | 97 |
| gradient | 10-15 | 3-5 | 97-95 |
| | 15-24 | 5-15 | 95-85 |
| | 24-30 | 15 | 85 |
| | 30-55 | 15-85 | 85-15 |
| | 55-60 | 85 | 15 |
| | 60-75 | 3 | 97 |

| | | |
|---|---|---|
| Column | 30° | C. |
| temperature | | |
| Detection | 211 | nm |
| length | | |
| Flowing speed | 0.6 | ml/min |
| Injection | 10 | μl |
| volume | | |

(1) Preparation of a blank solution: adjusting the pH value of potassium dihydrogen phosphate solution to 3.0 with phosphoric acid, preparing a mixed solution of 0.2% potassium dihydrogen phosphate solution-methanol=85:15, and filtering;
(2) Preparation of reference substance solution: accurately weighing an appropriate amount of matrine reference substance, oxymatrine reference substance, and oxysophocarpine reference substance, adding the blank solution to prepare a mixed reference substance solution I containing 0.33 mg of matrine, 0.85 mg of oxymatrine, and 0.25 mg of oxysophocarpine per 1 ml, and shaking; accurately weighing an appropriate amount of sophocarpine reference substance, sophoridine reference substance, and macrozamin reference substance, adding the blank solution to prepare a mixed reference substance solution II containing 0.09 mg of sophocarpine, 0.08 mg of sophoridine, and 0.08 mg of macrozamin per 1 ml, and shake; and accurately weighing 2 ml of the mixed reference substance solution I and II, adding to a 10 ml volumetric flask, diluting with the blank solution to scale, and shaking; optionally, preparing two copies using the same method; or
accurately weighing an appropriate amount of 2,3-dihydroxy-2-[(4-hydroxyphenyl)methyl]butanedioic acid reference substance, adding the blank solution to prepare a reference substance stock solution containing 0.25 mg of 2,3-dihydroxy-2-[(4-hydroxyphenyl)methyl]butanedioic acid per 1 ml, and shaking; accurately weighing 2 ml of the reference substance stock solution, adding to a 10 ml volumetric flask, diluting with the blank solution to scale, and shaking.
(3) Preparation of test substance solution: accurately weighing 1 ml of the Compound Kushen Injection, adding to a 50 ml volumetric flask, adding the blank solution to scale, shaking, and filtering to obtain a subsequent filtrate as the test substance solution;
(4) Injecting samples in the order of the blank solution, reference substance solution, and the test substance solution to construct a fingerprint of the Compound Kushen Injection containing matrine, oxymatrine, macrozamin, sophocarpine, oxysophocarpine, and sophoridine.
(5) Detection: injecting samples in the order of the blank solution, the reference substance solution, and the test substance solution to perform detection.

In the method of the present application, as one of the embodiments, the fingerprint in step (4) has 10 common characteristic peaks, in which, based on peak 7-oxymatrine as a reference, the relative retention time of peak 1-sophoramine is 0.442; the relative retention time of peak 2-macrozamin is 0.603; the relative retention time of peak 3-matrine is 0.693; the relative retention time of peak 4-sophocarpine is 0.816; the relative retention time of peak 5-sophoridine is 0.845; the relative retention time of peak 6-oxysophocarpine is 0.941; the relative retention time of peak 7-oxymatrine is 1.0; the relative retention time of peak 8-2,3-dihydroxy-2-[(4-hydroxyphenyl)methyl]butanedioic acid is 1.149; the relative retention time of peak 9 is 1.639; and the relative retention time of peak 10-trifolirhizin is 1.888.

In the method of the present application, as one of the embodiments, in step (4), samples are injected into the liquid chromatograph in the following sequence, the chromatogram is recorded and the content is calculated by using an external standard method

| Injection sequence | Samples | Number of injections |
|---|---|---|
| 1 | Blank solution | 1 injection |
| 2 | Reference substance 1 solution | 5 injections |
| | | (continuous injections) |
| 3 | Reference substance 2 solution | 2 injections |
| 4 | Test substance solution | 1 injections |
| 5 | Reference substance 1 solution | 1 injections |

In the method of the present application, as one of the embodiments, the method further includes continuously testing the reference substance solution 5 times, with a peak area RSD not exceeding 3.0% and a retention time RSD not exceeding 3.0%.

The present application further provides a high-performance liquid chromatography fingerprint of Compound Kushen Injection constructed according to any of the aforementioned methods. The fingerprint has 10 common characteristic peaks, in which, based on peak 7 as a reference, relative retention times of the common characteristic peaks are as follow: the relative retention time of peak 1 is 0.442; the relative retention time of peak 2 is 0.603; the relative retention time of peak 3 is 0.693; the relative retention time of peak 4 is 0.816; the relative retention time of peak 5 is 0.845; the relative retention time of peak 6 is 0.941; the relative retention time of peak 7 is 1.0; the relative retention time of peak 8 is 1.149; the relative retention time of peak 9 is 1.639; and the relative retention time of peak 10 is 1.888.

In the present application, as one of the embodiments, based on peak 7 as a reference, the relative peak areas of the common characteristic peaks are as follow: the relative peak areas of peak 1 is 0.039; the relative peak area of peak 2 is 0.068; the relative peak area of peak 3 is 0.468; the relative peak area of Peak 4 is 0.184; the relative peak area of peak 5 is 0.098; the relative peak area of peak 6 is 0.425; the relative peak area of Peak 7 is 1.0; the relative peak area of peak 8 is 0.224; the relative peak area of peak 9 is 0.049; and the relative peak area of peak 10 is 0.058.

In the present application, as one of the embodiments, the peak 1 represents sophoramine alkaloid, the peak 2 represents macrozamin, the peak 3 represents matrine, the peak 4 represents sophocarpine, the peak 5 represents sophoridine, the peak 6 represents oxysophocarpine, the peak 7 represents oxymatrine, the peak 8 represents 2,3-dihydroxy-2-[(4-hydroxyphenyl)methyl]butanedioic acid, the peak 9 represents unknown, and the peak 10 represents trifolirhizin.

Compared to the existing detection methods for Compound Kushen Injection, the present application adopts a high-performance liquid chromatography method, which can simultaneously determine 7 components in the Compound Kushen Injection, and construct a chromatographic fingerprint using this method, providing a fast and efficient technical method for quality control in the Compound Kushen Injection, while reducing the workload of testing. The method of the present application combines the three conditions in the standards for Compound Kushen Injection into one condition for testing, which saves time and effort.

### BRIEF DESCRIPTION OF THE DRAWINGS

FIG. 1 shows the results of blank and negative samples in Example 1.

FIGS. 2-1 to 2-6 show the linear diagrams of the six indicator components in Example 1.

FIG. 3 shows the results of blank and negative samples in Example 2.

FIG. 4 shows the linear diagram of 2,3-dihydroxy-2-[(4-hydroxyphenyl)methyl]butanedioic acid in Example 2.

FIG. 5-1 shows the standard control fingerprint in Example 3.

FIG. 5-2 shows the overlapped spectra of the test substance in Example 3.

FIG. 6 shows the repetitive overlapped spectra in Example 3.

FIG. 7 shows the intermediate precision overlapped spectra in Example 3.

FIG. 8 shows the stability fingerprint in Example 3.

FIG. 9 shows the double-time fingerprint in Example 3.

FIG. 10-1 shows the fingerprints of different chromatographic columns in Example 3.

FIGS. 10-2 show the fingerprint spectra of different apparatuses in Example 3.

FIG. 11 shows the fingerprint of key production process points in Example 3.

FIGS. 12-1 to 12-4 show the chromatograms of different chromatographic columns in Example 4: FIGS. 12-1 show Waters XSelect CSH™ C₁₈; FIG. 12-2 shows TechMate C₁₈-ST; FIG. 12-3 shows Welch Ultimate AQ-C₁₈; and FIGS. 12-4 show the Waters SunFire C₁₈.

FIGS. 13-1 to 13-9 show the chromatograms of different mobile phase systems in Example 4. FIGS. 13-1 show acetonitrile: 0.01M ammonium acetate (9:1), 0.01M ammonium acetate (adjusted to pH 8.0), and FIGS. 13-2 shows methanol-water; FIG. 13-3 shows methanol-0.1% formic acid water; FIG. 13-4 shows methanol −0.1% acetic acid water; FIGS. 13-5 shows methanol −0.01% acetic acid water; FIG. 13-6 shows methanol 0.1% phosphoric acid; FIG. 13-7 shows acetonitrile water; FIG. 13-8 shows methanol −0.01M ammonium acetate; and FIG. 13-9 shows methanol 0.2% potassium dihydrogen phosphate (adjusted to pH 3.0 with phosphoric acid).

FIGS. 14-1 to 14-3 show the chromatograms of different pH values in Example 4: FIG. 14-1 shows methanol 0.1% potassium dihydrogen phosphate (adjusted to pH 5.0 with phosphoric acid); FIG. 14-2 shows methanol −0.1% potassium dihydrogen phosphate (adjusted to pH 4.0 with phosphoric acid); and FIG. 14-3 shows methanol 0.1% potassium dihydrogen phosphate (adjusted to pH 3.0 with phosphoric acid).

FIGS. 15-1 to 15-4 show the chromatograms of potassium dihydrogen phosphate concentration in Example 4: FIG. 15-1 shows methanol-0.1% potassium dihydrogen phosphate (adjusted to pH 3.0 with phosphoric acid); FIG. 15-2 shows methanol-0.34% potassium dihydrogen phosphate (adjusted to pH 3.0 with phosphoric acid); FIG. 15-3 shows methanol-0.2% potassium dihydrogen phosphate (adjusted to pH 3.0 with phosphoric acid); and FIG. 15-4 shows the overlapped chromatogram of methanol and potassium dihydrogen phosphate (pH=3.0, with concentrations of 0.1%, 0.2%, and 0.3%, respectively).

FIGS. 16-1 to 16-3 show gradient-optimized chromatograms in Example 4: FIG. 16-1 shows Method 1, FIG. 16-2 shows Method 2, and FIG. 16-3 shows Method 3.

FIG. 17-1 shows the full wavelength scanning image in Example 4; and FIG. 17-2 shows the UV absorption wavelength of the chromatographic peak in Example 4.

FIGS. 18-1 to 18-3 show the optimized chromatograms of the preparation method for the test substance solution in Example 4. FIG. 18-1 shows the overlapped spectra of the test substance solution (prepared with water) and the blank solution; FIG. 18-2 shows the overlapped spectra of the reference substance prepared with methanol and the test substance prepared with purified water; FIG. 18-3 shows the overlapped spectra of the test substance and control sample prepared with the blank solution.

### DETAILED DESCRIPTION

The following examples and experimental examples are used to further elaborate on the present application, but will in no way limit the effective scope of the present application.

Apparatuses

| Name | Type | Manufacturer |
|---|---|---|
| HPLC | Waters e2695 | Waterworld Technology |
| | | Co., Ltd |
| | Agilent 1260 DAD | Agilent Technology Co., |
| | | Ltd |
| | Thermo U3000 | Thermo Fisher Scientific |
| Electronic balance | XSE205DU | Mettler Toledo |
| | ME 204 | Mettler Toledo |
| Chromatographic | Waters XSelect | Waterworld Technology |
| column | CSH ™ C18 | Co., Ltd |
| pH meter | PE 28 | Mettler Toledo |

Reference Substances

| | Source of reference | | | |
|---|---|---|---|---|
| No. | substance | Name | Structure | CAS No. |
| 1 | National Institutes for Food and Drug Control | Matrine | 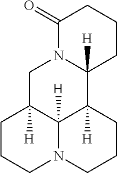 | 519-02-8 |
| 2 | Chengdu Herbpurify Co. ltd. | Oxymatrine | 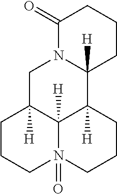 | 16837-52-8 |
| 3 | Chengdu Herbpurify Co. ltd. | Sophocarpine | 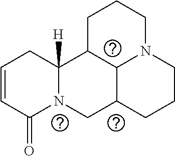 [SMILES: O=C1C=CC[C@@H]2C3CCCN4CCCC(CN12)C34] | 145572-44-7 |
| 4 | National Institutes for Food and Drug Control | Oxysophocarpine | 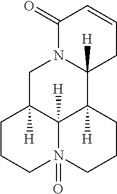 | 26904-64-3 |
| 5 | National Institutes for Food and Drug Control | Sophoridine | 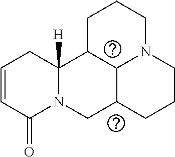 [SMILES: O=C1C=CC[C@@H]2C3CCCN4CCCC(CN12)C34] | 6882-68-4 |
| 6 | Self made | Macrozamin | 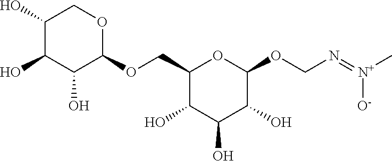 [SMILES: C/[N+]([O-])=N/CO[C@@H]1O[C@H](CO[C@@H]2OC[C@@H](O)[C@H](O)[C@H]2O)[C@@H](O)[C@H](O)[C@H]1O] | 6327-93-1 |
| 7 | Self made | piscidic acid | 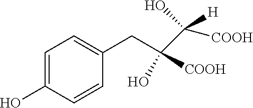 [SMILES: O=C(O)[C@@H](O)[C@](O)(Cc1ccc(O)cc1)C(=O)O] | 469-65-8 |

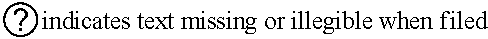

Test Substance in Example 1

| Name | Batch No. | Source |
|---|---|---|
| Compound | 20181138 | Shanxi Zhendong |
| Kushen Injection | | Pharmaceutical Co., Ltd. |
| Compound | 20181034 | Shanxi Zhendong |
| Kushen Injection | | Pharmaceutical Co., Ltd. |
| Compound | 20181139 | Shanxi Zhendong |
| Kushen Injection | | Pharmaceutical Co., Ltd. |
| Compound | 20181203 | Shanxi Zhendong |
| Kushen Injection | | Pharmaceutical Co., Ltd. |
| Compound | 20181204 | Shanxi Zhendong |
| Kushen Injection | | Pharmaceutical Co., Ltd. |
| Compound | 20181209 | Shanxi Zhendong |
| Kushen Injection | | Pharmaceutical Co., Ltd. |
| Compound | 20181212 | Shanxi Zhendong |
| Kushen Injection | | Pharmaceutical Co., Ltd. |
| Compound | 20181213 | Shanxi Zhendong |
| Kushen Injection | | Pharmaceutical Co., Ltd. |
| Compound | 20181214 | Shanxi Zhendong |
| Kushen Injection | | Pharmaceutical Co., Ltd. |
| Compound | 20181215 | Shanxi Zhendong |
| Kushen Injection | | Pharmaceutical Co., Ltd. |

Test Substance in Example 2

| Name | Batch No. | Source |
|---|---|---|
| Compound | 20181034 | Shanxi Zhendong |
| Kushen Injection | | Pharmaceutical Co., Ltd. |
| Compound | 20181138 | Shanxi Zhendong |
| Kushen Injection | | Pharmaceutical Co., Ltd. |
| Compound | 20181139 | Shanxi Zhendong |
| Kushen Injection | | Pharmaceutical Co., Ltd. |
| Compound | 20181203 | Shanxi Zhendong |
| Kushen Injection | | Pharmaceutical Co., Ltd. |
| Compound | 20181204 | Shanxi Zhendong |
| Kushen Injection | | Pharmaceutical Co., Ltd. |
| Compound | 20181209 | Shanxi Zhendong |
| Kushen Injection | | Pharmaceutical Co., Ltd. |
| Compound | 20181212 | Shanxi Zhendong |
| Kushen Injection | | Pharmaceutical Co., Ltd. |
| Compound | 20181213 | Shanxi Zhendong |
| Kushen Injection | | Pharmaceutical Co., Ltd. |
| Compound | 20181214 | Shanxi Zhendong |
| Kushen Injection | | Pharmaceutical Co., Ltd. |
| Compound | 20181215 | Shanxi Zhendong |
| Kushen Injection | | Pharmaceutical Co., Ltd. |
| Compound | 20190404 | Shanxi Zhendong |
| Kushen Injection | | Pharmaceutical Co., Ltd. |
| Compound | 20190405 | Shanxi Zhendong |
| Kushen Injection | | Pharmaceutical Co., Ltd. |
| Compound | 20190406 | Shanxi Zhendong |
| Kushen Injection | | Pharmaceutical Co., Ltd. |
| Compound | 20190407 | Shanxi Zhendong |
| Kushen Injection | | Pharmaceutical Co., Ltd. |
| Compound | 20190408 | Shanxi Zhendong |
| Kushen Injection | | Pharmaceutical Co., Ltd. |
| Compound | 20190409 | Shanxi Zhendong |
| Kushen Injection | | Pharmaceutical Co., Ltd. |
| Compound | 20190410 | Shanxi Zhendong |
| Kushen Injection | | Pharmaceutical Co., Ltd. |
| Compound | 20190412 | Shanxi Zhendong |
| Kushen Injection | | Pharmaceutical Co., Ltd. |
| Compound | 20190413 | Shanxi Zhendong |
| Kushen Injection | | Pharmaceutical Co., Ltd. |
| Compound | 20190414 | Shanxi Zhendong |
| Kushen Injection | | Pharmaceutical Co., Ltd. |
| Compound | 20180503 | Shanxi Zhendong |
| Kushen Injection | | Pharmaceutical Co., Ltd. |
| Compound | 20181010 | Shanxi Zhendong |
| Kushen Injection | | Pharmaceutical Co., Ltd. |
| Compound | 20181107 | Shanxi Zhendong |
| Kushen Injection | | Pharmaceutical Co., Ltd. |
| Compound | 20181134 | Shanxi Zhendong |
| Kushen Injection | | Pharmaceutical Co., Ltd. |
| Compound | 20181202 | Shanxi Zhendong |
| Kushen Injection | | Pharmaceutical Co., Ltd. |

Test Substance in Example 3

| Name | Batch No. | Source |
|---|---|---|
| Compound | 20181138 | Shanxi Zhendong |
| Kushen Injection | | Pharmaceutical Co., Ltd. |
| Compound | 20181034 | Shanxi Zhendong |
| Kushen Injection | | Pharmaceutical Co., Ltd. |
| Compound | 20181139 | Shanxi Zhendong |
| Kushen Injection | | Pharmaceutical Co., Ltd. |
| Compound | 20181203 | Shanxi Zhendong |
| Kushen Injection | | Pharmaceutical Co., Ltd. |
| Compound | 20181204 | Shanxi Zhendong |
| Kushen Injection | | Pharmaceutical Co., Ltd. |
| Compound | 20181209 | Shanxi Zhendong |
| Kushen Injection | | Pharmaceutical Co., Ltd. |
| Compound | 20181212 | Shanxi Zhendong |
| Kushen Injection | | Pharmaceutical Co., Ltd. |
| Compound | 20181213 | Shanxi Zhendong |
| Kushen Injection | | Pharmaceutical Co., Ltd. |
| Compound | 20181214 | Shanxi Zhendong |
| Kushen Injection | | Pharmaceutical Co., Ltd. |
| Compound | 20181215 | Shanxi Zhendong |
| Kushen Injection | | Pharmaceutical Co., Ltd. |

Agents

| Name | Batch No. | Source | Grade |
|---|---|---|---|
| Potassium | 018823 | MREAD | HPLC |
| dihydrogen | | | |
| phosphate | | | |
| Phosphoric acid | 0160318 | Beijing | Analytical |
| | | Chemical Works | Grade |
| Methanol | 10985407902 | MERCK KGAA | HPLC |
| Tween 80 | 20151222 | Nanjing Weier | For injection |
| | | Chemical Co., Ltd | |

### Example 1: Method for Detecting the Content of Compound Kushen Injection

1. Including Chromatographic Conditions, Sample Preparation, System Applicability Requirements, Calculation Formulas, and Limit Requirements

### Method Description

| Detection method | Detection conditions | | |
|---|---|---|---|
| Chromatographic | Waters XSelect CSH ™ C18 (5 μm, 4.6 mm × 250 mm) | | |
| column | | | |
| Mobile phase | 0.2% potassium dihydrogen phosphate solution | | |
| | (adjusted to pH 3.0 with phosphoric acid)- | | |
| | methanol gradient elution | | |
| | | Methanol | 0.2% Potassium |
| | Time (min) | (%) | dihydrogen phosphate |
| Elution condition | 0-10 | 3 | 97 |
| | 10-15 | 3-5 | 97-95 |
| | 15-24 | 5-15 | 95-85 |
| | 24-30 | 15 | 85 |
| | 30-55 | 15-85 | 85-15 |
| | 55-60 | 85 | 15 |
| | 60-75 | 3 | 97 |

| | | |
|---|---|---|
| Column | 30° | C. |
| temperature | | |
| Detection length | 211 | nm |
| Flowing speed | 0.6 | ml/min |
| Injection volume | 10 | μl |

| | |
|---|---|
| Solvent | 0.2% potassium dihydrogen phosphate solution- |
| | methanol (85:15) mixed solution |
| Test substance | Accurately measuring 1 ml of Compound Kusen |
| | Injection, adding to a 50 ml volumetric flask, adding |
| | a blank solution (0.2% potassium dihydrogen phosphate |
| | solution − methanol = 85:15) to scale, shaking, |
| | filtering, and taking a subsequent filtrate as the test |
| | substance solution |
| reference | Reference substance solution: accurately weighing an |
| substance | appropriate amount of matrine reference substance, |
| solution | oxymatrine reference substance, and oxysophocarpine |
| | reference substance, adding blank solution to prepare |
| | a mixed reference substance solution I containing |
| | 0.33 mg of matrine, 0.85 mg of oxymatrine, and 0.25 |
| | mg of oxysophocarpine per 1 ml, and shaking; accurately |
| | weighing an appropriate amount of sophocarpine reference |
| | substance, sophoridine reference substance, and macro- |
| | zamin reference substance, adding blank solution to |
| | prepare a mixed reference substance solution II containing |
| | 0.09 mg of sophocarpine, 0.08% mg of sophoridine, and |
| | 0.08 mg of macrozamin per 1 ml, and shaking; and accurately |
| | measuring 2 ml of the mixed reference substance solution |
| | I and II, adding to a 10 ml volumetric flask, diluting with |
| | blank solution to scale, and shaking |
| System | Mixed reference substance solution |
| applicability | |
| solution | |
| System | Testing the reference substance solution continuously for |
| applicability | 5 times, in which a peak area RSD is no more than 3.0%, |
| requirement | a retention time RSD is no more than 3.0%, a theoretical |
| | plate number is no less than 3000 for the main peak, |
| | a tailing factor is no more than 2.0, and a resolution is |
| | greater than 1.5 |
| Calculating method | External standard method |
| Standard | Based on the total amount of matrine and oxymatrine, the |
| | content of Sophora flavescens in every 1 ml should not be |
| | less than 8.0 mg; and, based on the amount of macrozamin, |
| | the content of Heterosmilax yunnanensis Gagnepin every |
| | 1 ml should not be less than 0.35 mg |

2. Verifying Specific Content

2.1 System Applicability

(1) Experimental Steps

Preparation of blank solution: preparing 0.2% potassium dihydrogen phosphate solution-methanol=85:15 mixed solution, and filtering.

Preparation of reference substance solution: accurately weighing an appropriate amount of matrine reference substance, oxymatrine reference substance, and oxysophocarpine reference substance, adding blank solution to prepare a mixed reference substance solution I containing 0.33 mg of matrine, 0.85 mg of oxymatrine, and 0.25 mg of oxysophocarpine per 1 ml, and shaking; accurately weighing an appropriate amount of sophocarpine reference substance, sophoridine reference substance, and macrozamin reference substance, adding blank solution to prepare a mixed reference substance solution II containing 0.09 mg of sophocarpine, 0.08 mg of sophoridine, and 0.08 mg of macrozamin per 1 ml, and shaking; and accurately weighing 2 ml of mixed reference substance solution I and II, adding to a 10 ml volumetric flask, diluting with blank solution to scale, and shaking.

Preparation of test substance solution: accurately weighing 1 ml of Compound Kushen Injection, adding to a 50 ml volumetric flask, adding blank solution to scale, shaking, filtering, and taking the subsequent filtrate as the test substance solution.

Requirements for Sampling Procedure

Injection Sequence

| Sequence | Sample | Injection number |
|---|---|---|
| 1 | Blank solution | 1 injection |
| 2 | Reference | 5 injections |
| | substance solution | (continuous test) |
| 3 | Test substance solution | 1 injection |

(2) Result Report

RSD values of peak area and retention time for 5 continuous injections of the reference substance solution.

TABLE 2.1-1
Peak area and retention time results of reference substance solution

| | Macrozamin | | Matrine | | sophocarpine | | Sophoridine | | Oxysophocarpine | | Oxymatrine | |
|---|---|---|---|---|---|---|---|---|---|---|---|---|
| Reference | Retention | Peak | Retention | Peak | Retention | Peak | Retention | Peak | Retention | Peak | Retention | Peak |
| substance | time | area | time | area | time | area | time | area | time | area | time | area |
| 1 | 16.804 | 299832 | 19.219 | 1625200 | 22.676 | 613077 | 23.512 | 362821 | 26.208 | 1601243 | 27.855 | 3704112 |
| 2 | 16.786 | 301982 | 19.243 | 1619597 | 22.697 | 607988 | 23.513 | 364852 | 26.231 | 1593477 | 27.842 | 3726630 |
| 3 | 16.719 | 299780 | 19.178 | 1616523 | 22.707 | 609700 | 23.532 | 363569 | 26.221 | 1591105 | 27.855 | 3698111 |
| 4 | 16.800 | 299063 | 19.232 | 1616141 | 22.667 | 608213 | 23.533 | 363066 | 26.219 | 1590745 | 27.859 | 3707737 |
| 5 | 16.802 | 300050 | 19.234 | 1614686 | 22.694 | 608479 | 23.538 | 363688 | 26.223 | 1588870 | 27.856 | 3702820 |
| RSD % | 0.21 | 0.36 | 0.13 | 0.26 | 0.07 | 0.35 | 0.05 | 0.22 | 0.03 | 0.30 | 0.02 | 0.30 |

TABLE 2.1-2
System applicability results

| | Macrozamin | | Matrine | | | sophocarpine | | | Sophoridine |
|---|---|---|---|---|---|---|---|---|---|
| Reference | Plate | Tailing | Plate | Reso- | Tailing | Plate | Reso- | Tailing | Plate |
| substance | number | factor | number | lution | factor | number | lution | factor | number |
| 1 | 17476.67 | 0.99 | 30384.96 | 5.03 | 1.19 | 78536.07 | 8,86 | 0.99 | 104440.15 |
| 2 | 17309.51 | 0.99 | 30392.70 | 5.04 | 1.18 | 79022.31 | 8.92 | 0.99 | 105065.99 |
| 3 | 17110.11 | 0.99 | 29849.04 | 5.06 | 1.19 | 79432.30 | 8.90 | 1.00 | 10574967 |
| 4 | 17418.16 | 0.99 | 30726.01 | 5.04 | 1.18 | 77228.17 | 8.91 | 0.99 | 105809.11 |
| 5 | 17240.82 | 0,99 | 30589.42 | 5.04 | 1.19 | 79305.99 | 8.93 | 0.99 | 106907.80 |
| | | Sophoridine | | Oxysophocarpine | | | Oxymatrine | | |
| | Reference | Reso- | Tailing | Plate | Reso- | Tailing | Plate | Reso- | Tailing |
| | substance | lution | factor | number | lution | factor | number | lution | factor |
| | 1 | 2.69 | 1.01 | 146804.80 | 9.37 | 1.08 | 127497.48 | 5.47 | 1.27 |
| | 2 | 2.67 | 1.01 | 145430.20 | 9.45 | 1.07 | 127994.51 | 5.47 | 1.27 |
| | 3 | 2.69 | 1.01 | 145669.71 | 9.38 | 1.07 | 128912.67 | 5.47 | 1.27 |
| | 4 | 2.68 | 1.0 | 146255.25 | 9.35 | 1.07 | 128684.75 | 5.47 | 1.27 |
| | 5 | 2.68 | 1.01 | 147366.56 | 9.36 | 1.07 | 128866.04 | 5.46 | 1.27 |

(3) Conclusion

From the results, it can be seen that after 5 consecutive injections of the reference substance solution, the RSD of the peak area measurements of oxymatrine, matrine, and oxysophocarpine are all less than 2.0%, and the RSD of the retention time are all less than 2.0%. The RSD of the peak area measurements of sophocarpine, sophoridine, and macrozamin are all less than 3.0%, and the RSD of the retention time is less than 3.0%; the theoretical number of the six indicator components is greater than 3000, and the trailing factor is less than 2.0, meeting the requirements.

2.2 Specificity

(1) Experimental Steps

Preparation of Preparation of blank solution: preparing 0.2% potassium dihydrogen phosphate solution-methanol=85:15 mixed solution, and filtering.

Preparation of negative sample solution: accurately weighing 1 ml of Single Kusen Injection (wild and cultivated) and 1 ml of Single Heterosmilax yunnanensis Gagnep Injection, adding to a 50 ml volumetric flask, adding blank solution to scale, shaking, filtering, and taking the subsequent filtrate as the negative sample solution.

Preparation of 0.25% Tween solution: weighing 0.25 g Tween 80, dissolving in water to 100 ml, shaking, filtering, and taking the subsequent filtrate as the 0.25% Tween solution.

Preparation of reference substance solution: preparing the reference substance solution according to a method under Section 2.1.

Preparation of test substance solution: accurately weighing 1 ml of Compound Kushen Injection, adding to a 50 ml volumetric flask, adding blank solution to scale, shaking, and reserving.

Preparation of filter membrane interference sample: centrifuging one portion of the test substance solution; and filtering one portion of the test substance solution, and discarding different volumes (1 ml, 3 ml, 5 ml, 7 ml, and 9 ml).

Requirements for Sampling Procedure

Injection Sequence

| Sequence | Sample | Injection |
|---|---|---|
| 1 | Blank solution | 1 injection |
| 2 | Negative sample solution | 1 injection |
| | (Sophora flavescens alone) | |
| 3 | Negative sample solution | 1 injection |
| | (Heterosmilax | |
| | yunnanensis Gagnep alone) | |
| 4 | 0.25% Tween 80 solution | 1 injection |
| 5 | reference substance solution | 1 injection |
| 6 | test substance solution-centrifuging | 1 injection |
| 7 | test substance solution-filtered 1 ml | 1 injection |
| 8 | test substance solution-filtered 3 ml | 1 injection |
| 9 | test substance solution-filtered 5 ml | 1 injection |
| 10 | test substance solution-filtered 7 ml | 1 injection |
| 11 | test substance solution-filtered 9 ml | 1 injection |

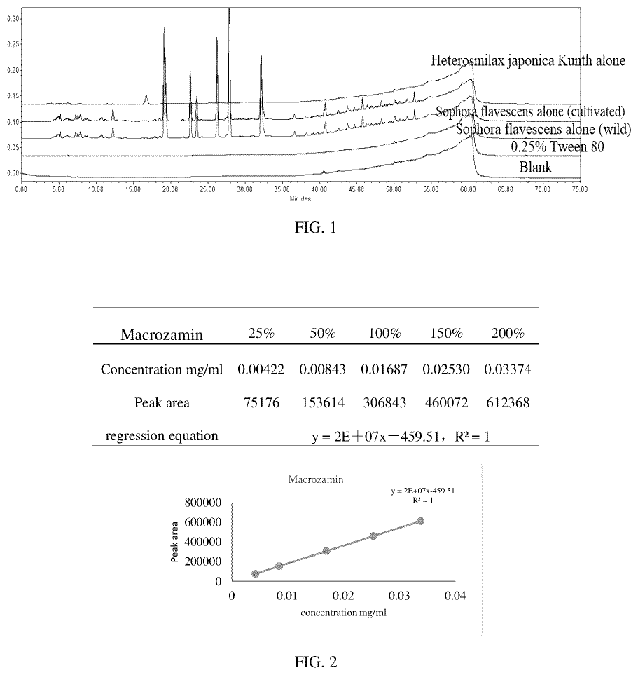

(2) The Results are Reported in FIG. 1 and the Table Below.

TABLE 2.2-1
Results of filter membrane interference experiment (area percentage of
different discarded volumes relative to centrifuged Samples)

| / | Macrozamin % | Sophoridine % | Sophocarpine % | Matrine % | Oxysophocarpine % | Oxymatrine % |
|---|---|---|---|---|---|---|
| 1 ml | 95.75 | 98.17 | 98.45 | 98.56 | 98.02 | 97.93 |
| 3 ml | 99.93 | 99.76 | 99.73 | 99.80 | 99.75 | 99.67 |
| 5 ml | 100.75 | 100.26 | 100.29 | 100.26 | 100.33 | 100.22 |
| 7 ml | 99.78 | 99.61 | 99.45 | 99.70 | 99.60 | 99.58 |
| 9 ml | 99.92 | 100.08 | 99.86 | 99.90 | 99.90 | 99.89 |

(3) Conclusion

From the results, it can be seen that the blank solution, blank mobile phase, and 0.25% Tween 80 solution have no interfere with the sample. The negative sample solution of Sophora flavescens alone (wild Sophora flavescens and cultivated Sophora flavescens) have no interfere with macrozamin, and the negative sample solution of Heterosmilax yunnanensis Gagnep alone has no interfere with alkaloids.

After discarding different volumes, the relative content between the area of the indicator components of the test substance solution and the area of the centrifuged test substance solution is 95.0%-105.0%, and the adsorption can be ignored.

2.3 Linearity and Range

(1) Experimental Steps

Preparation of Preparation of blank solution: preparing 0.2% potassium dihydrogen phosphate solution-methanol=85:15 mixed solution, and filtering.

Preparation of linear stock solution: accurately weighing an appropriate amount of matrine reference substance, oxymatrine reference substance, and oxysophocarpine reference substance, adding blank solution to prepare a mixed reference substance solution I containing 0.33 mg of matrine, 0.85 mg of oxymatrine, and 0.25 mg of oxysophocarpine per 1 ml, and shaking; accurately weighing an appropriate amount of sophocarpine reference substance, sophoridine reference substance, and macrozamin reference substance, adding blank solution to prepare a mixed reference substance solution II containing 0.09 mg of sophocarpine, 0.08 mg of sophoridine, and 0.08 mg of macrozamin per 1 ml, and shaking.

25% reference substance solution: accurately weighing 0.5 ml of mixed reference substance solutions I and II, adding to a 10 ml volumetric flask, diluting with blank solution to scale, and shaking.

50% reference substance solution: accurately weighing 1 ml of mixed reference substance solutions I and II, adding to a 10 ml volumetric flask, diluting with blank solution to scale, and shaking.

100% reference substance solution: accurately weighing 2 ml of mixed reference substance solutions I and II, adding to a 10 ml volumetric flask, diluting with blank solution to scale, and shaking.

150% reference substance solution: accurately weighing 3 ml of mixed reference substance solutions I and II, adding to a 10 ml volumetric flask, diluting with blank solution to scale, and shaking.

200% reference substance solution: accurately weighing 4 ml of mixed reference substance solutions I and II, adding to a 10 ml volumetric flask, diluting with blank solution to scale, and shaking.

Requirements for Sampling Procedure

Injection Sequence

| Sequence | Sample | Injection number |
|---|---|---|
| 1 | Blank solution | 1 injection |
| 2 | 100% reference substance solution | Continuous 5 injections |
| 3 | 25% reference substance solution | 1 injection |
| 4 | 50% reference substance solution | 1 injection |
| 5 | 100% reference substance solution | 1 injection |
| 6 | 150% reference substance solution | 1 injection |
| 7 | 200% reference substance solution | 1 injection |
| 8 | 100% reference substance solution | 1 injection |

(2) Result Report

The regression equations, correlation coefficients, and linear graph results of individual indicator components are shown in FIGS. 2-1 to 2-6.

(3) Conclusion

Macrozamin shows linearity within the range of 0.00422 mg/ml-0.03374 mg/ml; matrine shows linearity within 0.01627 mg/ml-0.13013 mg/ml; sophorocarpine shows a linearity within the range of 0.0044 mg/ml-0.03517 mg/ml; sophoridine shows linearity within a range of 0.00438 mg/ml-0.03505 mg/ml; oxysophoridine shows linearity within the range of 0.01252 mg/ml-0.10016 mg/ml; and oxymatrine shows linearity within a range of 0.04228 mg/ml-0.33742 mg/ml. The linear correlation coefficients of individual components are greater than or equal to 0.999, meeting the standard.

2.4 Sensitivity

(1) Experimental Steps

Preparation of blank solution: preparing 0.2% potassium dihydrogen phosphate solution-methanol=85:15 mixed solution, and filtering.

Preparation of reference substance solution: accurately weighing an appropriate amount of macrozamin reference substance solution, and adding blank solution to prepare a reference substance solution containing 0.085 mg per 1 ml.

Quantitation limit of and detection limit solution: diluting the blank solution stepwise to a signal-to-noise ratio (S/N) of 10:1 as the limit of quantitation solution, and diluting the blank solution stepwise to a signal-to-noise ratio (S/N) of 2-3 as the limit of detection solution.

Requirements for Sampling Procedure

Injection Sequence

| Sequence | Sample | Injection number |
|---|---|---|
| 1 | Blank solution | 1 injection |
| 2 | Reference | 5 injections |
| | substance 1 solution | (continuous test) |
| 3 | Solution for quantitation limit | 6 injections |
| 4 | Detection limit solution | 2 injections |

(2) Result Report

TABLE 2.4-1
Statistics result of quantitation limit

| | 1 | 2 | 3 | 4 | 5 | 6 | Average | RSD (%) |
|---|---|---|---|---|---|---|---|---|
| Peak area | 14189 | 12699 | 12893 | 13187 | 14209 | 13909 | 13514.3 | 4.97 |
| Retention time | 15.407 | 15.530 | 15.456 | 15.461 | 15.394 | 15.423 | 15.450 | 0.32 |
| (min) | | | | | | | | |

TABLE 2.4-2
Sensitivity Test Results

| | Quantitation limit | | Detection limit | |
|---|---|---|---|---|
| Item | Percentage | Based on | Percentage | Based on |
| | relative to test | ng | relative to test | ng |
| Name | substance (%) | (ng) | substance (%) | (ng) |
| Macrozamin | 0.112 | 8.09 | 0.033 | 2.43 |

(3) Conclusion

From the results, it can be seen that, after continuous injection of the quantitative limit solution, the RSD value of peak retention time is less than 2.0%, and the peak area is less than 5.0%; the quantification limit is 8.09 ng and the detection limit is 2.43 ng.

2.5 Repeatability

(1) Experimental Steps

Preparation of blank solution: preparing 0.2% potassium dihydrogen phosphate solution-methanol=85:15 mixed solution, and filtering.

Preparation of reference substance solution: preparing reference substance solution according to the method under Section 2.1, and preparing two copies using the same method.

Preparation of test substance solution (6 copies): accurately weighing 1 ml of Compound Kushen Injection, adding to a 50 ml volumetric flask, adding blank solution to scale, shaking, filtering, and taking the subsequent filtrate as the test substance solution; and preparing 6 copies in parallel.

Requirements for Sampling Procedure

Injection Sequence

| Sequence | Sample | Injection number |
|---|---|---|
| 1 | Blank solution | 1 injection |
| 2 | Reference substance 1 solution | 5 injections (continuous test) |
| 3 | Reference substance 2 solution | 2 injections |
| 4 | Test substance-1 solution | 1 injection |
| 5 | Test substance-2 solution | 1 injection |
| 6 | Test substance-3 solution | 1 injection |
| 7 | Test substance-4 solution | 1 injection |
| 8 | Test substance-5 solution | 1 injection |
| 9 | Test substance-6 solution | 1 injection |
| 10 | Reference substance 1 solution | 1 injection |

(2) Result Report

TABLE 2.5
Repeatability Test Results

| / | 1 | 2 | 3 | 4 | 5 | 6 | Average (%) | RSD (%) |
|---|---|---|---|---|---|---|---|---|
| Macrozamin | 0.73 | 0.73 | 0.72 | 0.71 | 0.71 | 0.72 | 0.72 | 1.24 |
| Matrine | 3.36 | 3.36 | 3.34 | 3.28 | 3.28 | 3.31 | 3.32 | 1.11 |
| sophocarpine | 0.94 | 0.93 | 0.93 | 0.91 | 0.91 | 0.92 | 0.92 | 1.09 |
| Sophoridine | 0.82 | 0.82 | 0.82 | 0.80 | 0.80 | 0.81 | 0.81 | 1.11 |
| Oxysophocarpine | 2.40 | 2.40 | 2.39 | 2.35 | 2.35 | 2.38 | 2.38 | 1.03 |
| Oxymatrine | 8.16 | 8.14 | 8.12 | 7.97 | 7.97 | 8.07 | 8.07 | 1.05 |

(3) Conclusion

From the results, it can be seen that the RSD of the content of matrine, oxymatrine, and oxysophocarpine in the six test substances is less than 3.0%, while the RSD of the content of sophocarpine, sophoridine, and macrozamin is less than 4.0%, indicating good repeatability of the test substances.

2.6 Intermediate Precision

(1) Experimental Steps

According to the repeatability measurement method, six test substance solutions of the same batch were prepared in parallel by different analysts using different apparatuses and on different dates. The solution preparation and injection procedures were under the same repeatability item.

(2) Result Report

TABLE 2.6-1
Intermediate precision test results of macrozamin

| / | Test substance | Content (%) | Average content (%) | Total average (%) | RSD (%) |
|---|---|---|---|---|---|
| Apparatus: | 1 | 0.72 | 0.72 | 0.72 | 1.18 |
| Waters | 2 | 0.72 | | | |
| CHP-020 | 3 | 0.71 | | | |
| | 4 | 0.72 | | | |
| | 5 | 0.72 | | | |
| | 6 | 0.72 | | | |
| Apparatus: | 1 | 0.73 | 0.72 | | |
| Waters | 2 | 0.73 | | | |
| CHP-017 | 3 | 0.74 | | | |

| | |
|---|---|
| 4 | 0.74 |
| 5 | 0.72 |
| 6 | 0.72 |

TABLE 2.6-2
Intermediate Precision Test Results of matrine

| | Test | | | Total | |
|---|---|---|---|---|---|
| / | substance | Content (%) | Average content (%) | Average (%) | RSD (%) |
| Apparatus: Waters | 1 | 3.44 | 3.43 | 3.43 | 0.34 |
| CHP-020 | 2 | 3.43 | | | |
| | 3 | 3.44 | | | |
| | 4 | 3.43 | | | |
| | 5 | 3.44 | | | |
| | 6 | 3.42 | | | |
| Apparatus: Waters | 1 | 3.43 | 3.42 | | |
| CHP-017 | 2 | 3.40 | | | |
| | 3 | 3.42 | | | |
| | 4 | 3.44 | | | |
| | 5 | 3.42 | | | |
| | 6 | 3.43 | | | |

TABLE 2.6-3
Intermediate Precision Test Results of sophorocarpine

| | Test | | | Total | |
|---|---|---|---|---|---|
| / | substance | Content (%) | Average content (%) | Average (%) | RSD (%) |
| Apparatus: Waters | 1 | 0.95 | 0.95 | 0.96 | 0.91 |
| CHP-020 | 2 | 0.95 | | | |
| | 3 | 0.95 | | | |
| | 4 | 0.94 | | | |
| | 5 | 0.95 | | | |
| | 6 | 0.95 | | | |
| Apparatus: Waters | 1 | 0.97 | 0.96 | | |
| CHP-017 | 2 | 0.96 | | | |
| | 3 | 0.97 | | | |
| | 4 | 0.97 | | | |
| | 5 | 0.96 | | | |
| | 6 | 0.96 | | | |

TABLE 2.6-4
Intermediate Precision Test Results of sophoridine

| | Test | Content | Average content | Total | RSD |
|---|---|---|---|---|---|
| / | substance | (%) | (%) | average (%) | (%) |
| Apparatus: | 1 | 0.83 | 0.84 | 0.83 | 0.67 |
| Waters | 2 | 0.84 | | | |
| CHP-020 | 3 | 0.84 | | | |
| | 4 | 0.84 | | | |
| | 5 | 0.84 | | | |
| | 6 | 0.84 | | | |
| Apparatus: | 1 | 0.83 | 0.83 | | |
| Waters | 2 | 0.83 | | | |
| CHP-017 | 3 | 0.83 | | | |
| | 4 | 0.83 | | | |
| | 5 | 0.82 | | | |
| | 6 | 0.82 | | | |

TABLE 2.6-5
Intermediate Precision Test Results of oxysophorocarpine

| | Test | Content | Average | Total Average | |
|---|---|---|---|---|---|
| / | substance | (%) | content (%) | (%) | RSD(%) |
| Apparatus: | 1 | 2.46 | 2.46 | 2.42 | 1.50 |
| Waters | 2 | 2.46 | | | |
| CHP-020 | 3 | 2.46 | | | |
| | 4 | 2.46 | | | |
| | 5 | 2.46 | | | |
| | 6 | 2.45 | | | |
| Apparatus: | 1 | 2.40 | 2.39 | | |
| Waters | 2 | 2.38 | | | |
| CHP-017 | 3 | 2.39 | | | |
| | 4 | 2.40 | | | |
| | 5 | 2.38 | | | |
| | 6 | 2.38 | | | |

TABLE 2.6-6
Intermediate Precision Test Results of oxymatrine

| | Test | Content | Average | Total average | RSD |
|---|---|---|---|---|---|
| / | substanc | (%) | content (%) | (%) | (%) |
| Apparatus: Waters | 1 | 8.42 | 8.44 | 8.27 | 2.12 |
| CHP-020 | 2 | 8.42 | | | |
| | 3 | 8.44 | | | |
| | 4 | 8.43 | | | |

| | | | |
|---|---|---|---|
| | 5 | 8.47 | |
| | 6 | 8.44 | |
| Apparatus: Waters | 1 | 8.14 | 8.11 |
| CHP-017 | 2 | 8.10 | |
| | 3 | 8.12 | |
| | 4 | 8.16 | |
| | 5 | 8.05 | |
| | 6 | 8.07 | |

(3) Conclusion

From the results, it can be seen that, in the 12 test substances tested by different operators with different apparatus on different dates, the RSD of matrine content is 0.34%, the RSD of oxidized matrine content is 2.12%, and the RSD of oxidized sophocarpine content is 1.50%, all less than 3.0%. The RSD of sophocarpine content is 0.91%, the RSD of sophoridine content is 0.67%, and the RSD of macrozamin content is 1.18%, all less than 4.0%, indicating good intermediate precision of the test substance.

2.7 Solution Stability

(1) Experimental Steps

Preparation of blank solvent: preparing 0.2% potassium dihydrogen phosphate solution-methanol=85:15 mixed solution, and filtering, obtained.

Preparation of reference substance solution: preparing reference substance solution according to the method provided under Section 2.1, and preparing two copies using the same method.

Preparation of test substance solution: accurately weighing 1 ml of Compound Kushen Injection, adding to a 50 ml volumetric flask, adding blank solution to scale, shaking, filtering, and taking the subsequent filtrate as the test substance solution.

Requirements for Sampling Procedure

Injection Sequence

| Sequence | Sample | Injection number |
|---|---|---|
| 1 | Blank solution | 1 injection |
| 2 | Reference substance 1 solution | 5 injections (continuous |
| | | test) |
| 3 | Reference substance 2 solution | 2 injections |
| 4 | Test substance-0 h | 1 injection |
| 5 | Reference substance-4 h | 1 injection |
| 6 | Test substance-4 h | 1 injection |
| 7 | Reference substance-8 h | 1 injection |
| 8 | Test substance-8 h | 1 injection |
| 9 | Reference substance-12 h | 1 injection |
| 10 | Test substance-12 h | 1 injection |
| 11 | Reference substance-18 h | 1 injection |
| 12 | Test substance-18 h | 1 injection |
| 13 | Reference substance-24 h | 1 injection |
| 14 | Test substance-24 h | 1 injection |
| 15 | Reference substance 1 solution | 1 injection |

(2) Result Report

TABLE 2.7
Solution Stability Test Results

| Time (h) | 0 | 4 | 8 | 12 | 18 | 24 | Average (%) | RSD (%) |
|---|---|---|---|---|---|---|---|---|
| Macrozamin Content (%) | 0.72 | 0.71 | 0.72 | 0.72 | 0.72 | 0.72 | 0.72 | 0.55 |
| Relative 0 h Content (%) | / | 98.45 | 99.38 | 99.27 | 98.94 | 98.76 | / | / |
| Matrine content (%) | 3.43 | 3.43 | 3.42 | 3.44 | 3.44 | 3.43 | 3.43 | 0.18 |
| Relative 0 h content (%) | / | 99.91 | 99.65 | 100.10 | 100.17 | 100.00 | / | / |
| Sophocarpine content (%) | 0.95 | 0.95 | 0.94 | 0.95 | 0.95 | 0.95 | 0.95 | 0.23 |
| Relative 0 h content (%) | / | 99.77 | 99.55 | 100.08 | 100.19 | 99.87 | / | / |
| Sophoridine content (%) | 0.84 | 0.84 | 0.83 | 0.84 | 0.84 | 0.84 | 0.84 | 0.18 |
| Relative 0 h content (%) | / | 99.84 | 99.58 | 100.05 | 99.99 | 99.74 | / | / |
| Oxysophocarpine content (%) | 2.46 | 2.45 | 2.45 | 2.46 | 2.46 | 2.46 | 2.46 | 0.18 |
| Relative 0 h content (%) | / | 99.88 | 99.67 | 100.05 | 100.20 | 100.03 | / | / |
| Oxymatrine content (%) | 8.43 | 8.41 | 8.40 | 8.43 | 8.44 | 8.43 | 8.42 | 0.18 |
| Relative 0 h content (%) | / | 99.86 | 99.70 | 100.10 | 100.21 | 100.01 | / | / |

(3) Conclusion

From the results, it can be seen that, 24 hours after standing the reference substance solution and the test substance solution, the RSD values of the content of matrine, oxymatrine, and oxysophocarpine in the test substance are less than 3.0%, while the RSD values of the content of sophocarpine, sophoridine, and macrozamin a less than 4.0%, indicating that the test substances are stable within 24 hours.

The percentages of the indicator component area at individual time points to the 0-hour indicator component area are calculated. Compared with the initial results, the relative content of the control and test substance solution at each time point is 98.0%-102.0%, indicating a good solution stability.

2.8 Accuracy

(1) Experimental Steps

Preparation of blank solution: Preparing 0.2% potassium dihydrogen phosphate solution-methanol=85:15 mixed solution, and filtering.

Preparation of reference substance solution: preparing a reference substance solution by the method provided under Section 2.1, and preparing two copies using the same method.

Preparation of 50% recovery solution: accurately weighing 0.5 ml of Compound Kushen Injection, adding to a 50 ml volumetric flask, adding 2.5 ml of mixed reference substance solution I and II, respectively, adding blank solution to scale, shaking, and filtering to obtain a filtrate as a 5000 recovery solution (preparing 3 copies using the same method).

Preparation of 100% recovery solution: accurately weighing 0.5 ml of Compound Kushen Injection, adding to a 50 ml volumetric flask, adding 5 ml of mixed reference substance solution I and II respectively, adding blank solution to scale, shaking, and filtering to obtain a filtrate as a 100% recovery solution (preparing 3 copies using the same method).

Preparation of 150% recovery solution: accurately weighing 0.5 ml of Compound Kushen Injection, adding to a 50 ml volumetric flask, adding 7.5 ml of mixed reference substance solution I and II respectively, adding blank solution to scale, shaking, and filtering to obtain a filtrate as a 15000 recovery solution (preparing 3 copies using the same method).

Requirements for Sampling Procedure

Injection Sequence

| Sequence | Sample | Injection number |
|---|---|---|
| 1 | Blank solution | 1 injection |
| 2 | Reference substance 1 solution | 5 injections (continuous |
| | | test) |
| 3 | Reference substance 2 solution | 2 injections |
| 4 | 50%-1 recovery rate solution | 2 injections |
| 5 | 50%-2 recovery rate solution | 2 injections |
| 6 | 50%-3 recovery rate solution | 2 injections |
| 7 | 100%-1 recovery rate solution | 2 injections |
| 8 | 100%-2 recovery rate solution | 2 injections |
| 9 | 100%-3 recovery rate solution | 2 injections |
| 10 | 150%-1 recovery rate solution | 2 injections |
| 11 | 150%-2 recovery rate solution | 2 injections |
| 12 | 150%-3 recovery rate solution | 2 injections |
| 13 | Reference substance 1 solution | 1 injection |

(2) Result Report

Recovery Rate Calculation Formula:

$$Recovery rate = \frac{\begin{matrix}measured valuet - test substance content * \\ sampling amount of test substance\end{matrix}}{added amount of control sample} \times 100 \%$$

TABLE 2.8-1
Recovery test results of macrozamin content

| | Sampling | | | | | | |
|---|---|---|---|---|---|---|---|
| | amount of | Added amount | | | | | |
| | test | of Reference | Measure | Test substance | recovery | Average/ | RSD/ |
| / | substance/ml | substance/mg | value/mg | content/mg/ml | rate/% | % | % |
| 50%-1 | 0.5 | 0.219 | 0.57 | 0.72 | 94.12 | 95.67 | 2.01 |
| 50%-2 | 0.5 | 0.219 | 0.57 | 0.72 | 93.84 | | |
| 50%-3 | 0.5 | 0.219 | 0.56 | 0.72 | 92.59 | | |
| 100%-1 | 0.5 | 0.438 | 0.78 | 0.72 | 95.11 | | |
| 100%-2 | 0.5 | 0.438 | 0.79 | 0.72 | 98.12 | | |
| 100%-3 | 0.5 | 0.438 | 0.78 | 0.72 | 96.05 | | |
| 150%-1 | 0.5 | 0.656 | 0.99 | 0.72 | 96.21 | | |
| 150%-2 | 0.5 | 0.656 | 1.00 | 0.72 | 96.75 | | |
| 150%-3 | 0.5 | 0.656 | 1.01 | 0.72 | 98.22 | | |

TABLE 2.8-2
Test results of recovery rate of matrine content

| | Sampling | | | | | | |
|---|---|---|---|---|---|---|---|
| | amount of | Added amount | | | | | |
| | test | of Reference | Measure | Test substance | recovery | Average/ | RSD/ |
| / | substance/ml | substance/mg | value/mg | content/mg/ml | rate/% | % | % |
| 50%-1 | 0.5 | 0.813 | 2.49 | 3.32 | 102.41 | 101.34 | 0.72 |
| 50%-2 | 0.5 | 0.813 | 2.49 | 3.32 | 101.97 | | |
| 50%-3 | 0.5 | 0.813 | 2.48 | 3.32 | 100.43 | | |
| 100%-1 | 0.5 | 1.625 | 3.29 | 3.32 | 100.49 | | |
| 100%-2 | 0.5 | 1.625 | 3.31 | 3.32 | 101.56 | | |
| 100%-3 | 0.5 | 1.625 | 3.31 | 3.32 | 101.60 | | |
| 150%-1 | 0.5 | 2.438 | 4.11 | 3.32 | 100.55 | | |
| 150%-2 | 0.5 | 2.438 | 4.13 | 3.32 | 101.15 | | |
| 150%-3 | 0.5 | 2.438 | 4.15 | 3.32 | 101.94 | | |

TABLE 2.8-3
Recovery rate test results of sophocarpine content

| | Sampling | | | | | | |
|---|---|---|---|---|---|---|---|
| | amount of | Added amount | | | | | |
| | test | of Reference | Measure | Test substance | recovery | Average/ | RSD/ |
| / | substance/ml | substance/mg | value/mg | content/mg/ml | rate/% | % | % |
| 50%-1 | 0.5 | 0.217 | 0.68 | 0.93 | 101.76 | 100.78 | 0.90 |
| 50%-2 | 0.5 | 0.217 | 0.68 | 0.93 | 101.44 | | |
| 50%-3 | 0.5 | 0.217 | 0.68 | 0.93 | 100.08 | | |
| 100%-1 | 0.5 | 0.435 | 0.90 | 0.93 | 99.60 | | |
| 100%-2 | 0.5 | 0.435 | 0.91 | 0.93 | 101.87 | | |
| 100%-3 | 0.5 | 0.435 | 0.90 | 0.93 | 100.79 | | |
| 150%-1 | 0.5 | 0.652 | 1.11 | 0.93 | 99.52 | | |
| 150%-2 | 0.5 | 0.652 | 1.12 | 0.93 | 100.49 | | |
| 150%-3 | 0.5 | 0.652 | 1.12 | 0.93 | 101.48 | | |

TABLE 2.8-4
Recovery rate test results of sophoridine alkaloid content

| | Sampling | | | | | | |
|---|---|---|---|---|---|---|---|
| | amount of | Added amount | | | | | |
| | test | of Reference | Measure | Test substance | recovery | Average/ | RSD/ |
| / | substance/ml | substance/mg | value/mg | content/mg/ml | rate/% | % | % |
| 50%-1 | 0.5 | 0.210 | 0.62 | 0.82 | 102.35 | 101.70 | 0.74 |
| 50%-2 | 0.5 | 0.210 | 0.62 | 0.82 | 102.18 | | |
| 50%-3 | 0.5 | 0.210 | 0.62 | 0.82 | 100.54 | | |
| 100%-1 | 0.5 | 0.420 | 0.83 | 0.82 | 100.79 | | |
| 100%-2 | 0.5 | 0.420 | 0.84 | 0.82 | 102.49 | | |
| 100%-3 | 0.5 | 0.420 | 0.84 | 0.82 | 101.80 | | |
| 150%-1 | 0.5 | 0.630 | 1.05 | 0.82 | 101.14 | | |
| 150%-2 | 0.5 | 0.630 | 1.05 | 0.82 | 101.56 | | |
| 150%-3 | 0.5 | 0.630 | 1.05 | 0.82 | 102.57 | | |

TABLE 2.8-5
Recovery rate test results of oxidized sophocarpine content

| | Sampling | | | | | | |
|---|---|---|---|---|---|---|---|
| | amount of | Added amount | | | | | |
| | test | of Reference | Measure | Test substance | recovery | Average/ | RSD/ |
| / | substance/ml | substance/mg | value/mg | content/mg/ml | rate/% | % | % |
| 50%-1 | 0.5 | 0.627 | 1.84 | 2.38 | 104.05 | 102.55 | 1.40 |
| 50%-2 | 0.5 | 0.627 | 1.84 | 2.38 | 103.59 | | |
| 50%-3 | 0.5 | 0.627 | 1.83 | 2.38 | 102.10 | | |
| 100%-1 | 0.5 | 1.254 | 2.46 | 2.38 | 101.65 | | |
| 100%-2 | 0.5 | 1.254 | 2.50 | 2.38 | 104.86 | | |
| 100%-3 | 0.5 | 1.254 | 2.48 | 2.38 | 102.83 | | |
| 150%-1 | 0.5 | 1.878 | 3.08 | 2.38 | 100.63 | | |
| 150%-2 | 0.5 | 1.878 | 3.08 | 2.38 | 100.82 | | |
| 150%-3 | 0.5 | 1.878 | 3.11 | 2.38 | 102.46 | | |

TABLE 2.8-6
Test results of recovery rate of oxymatrine content

| | Sampling | | | | | | |
|---|---|---|---|---|---|---|---|
| | amount of | Added amount | | | | | |
| | test | of Reference | Measure | Test substance | recovery | Average/ | RSD/ |
| / | substance/ml | substance/mg | value/mg | content/mg/ml | rate/% | % | % |
| 50%-1 | 0.5 | 2.119 | 6.21 | 8.07 | 102.68 | 102.51 | 0.96 |
| 50%-2 | 0.5 | 2.119 | 6.22 | 8.07 | 103.12 | | |
| 50%-3 | 0.5 | 2.119 | 6.20 | 8.07 | 101.97 | | |
| 100%-1 | 0.5 | 4.250 | 8.34 | 8.07 | 101.30 | | |
| 100%-2 | 0.5 | 4.250 | 8.47 | 8.07 | 104.41 | | |
| 100%-3 | 0.5 | 4.250 | 8.39 | 8.07 | 102.43 | | |
| 150%-1 | 0.5 | 6.326 | 10.47 | 8.07 | 101.73 | | |
| 150%-2 | 0.5 | 6.326 | 10.47 | 8.07 | 101.64 | | |
| 150%-3 | 0.5 | 6.326 | 10.57 | 8.07 | 103.32 | | |

(3) Conclusion

The recovery rates of matrine, oxymatrine, and oxysophocarpine in the test substance are ranged from 92% to 105%, with RSD values of 0.93%, 1.33%, and 1.01% for the nine recoveries, all less than 4%; and the recovery rates of sophocarpine, sophoridine, and macrozamin ranged from 90.0% to 108.0%, with RSDs of 2.01%, 1.26%, and 1.90% for the nine copies, all less than 5.0%, meeting the requirements.

2.9 Durability

(1) Experimental Steps

Different chromatographic conditions are shown in the table below.

| Parameter | Specified value | Recommended varying range |
|---|---|---|
| Column temperature (° C.) | 30° C. | 28° C., 32° C. |
| Concentration of buffering salt | 0.2% | 0.15%, 0.25% |
| pH value of buffering salt | 3.0 | 2.9, 3.1 |
| Flowing speed | 0.6 ml/min | 0.58 ml/min, 0.62 ml/min |
| Wavelength (nm) | 211 | 209, 213 |
| Chromatographic column | Waters XSelect CSH ™ C18 | Waters XSelect CSH ™ C18 |
| | (4.6 mm × 250 mm, 5 μm), Sel | (4.6 mm × 250 mm, 5 μm), Sel |
| | No. 01203827518723 | No. 01203827518752 |
| | | Waters XSelect CSH ™ C18 |
| | | (4.6 mm × 250 mm, 5 μm), Sel |
| | | No. 01203827518726 |

Preparation of blank solution: preparing 0.2% potassium dihydrogen phosphate solution-methanol=85:15 mixed solution, and filtering.

Preparation of reference substance solution: preparing a reference substance solution by the method provided under Section 2.1.

Preparation of test substance solution: accurately weighing 1 ml of Compound Kushen Injection and adding to a 50 ml volumetric flask, adding blank solution to scale, shaking, filtering, and taking the subsequent filtrate as the test substance solution; and preparing two copies using the same method.

Requirements for injection procedure (samples are injected in this order under different inspection conditions)

Injection Sequence

| Sequence | Sample | Injection number |
|---|---|---|
| 1 | Blank solution | 1 injection |
| 2 | Reference substance 1 solution | 5 injections |
| 3 | Reference substance 2 solution | 2 injections |
| 4 | Test substance-1 | 1 injection |
| 5 | Test substance-2 | 1 injection |
| 6 | Reference substance 1 solution | 1 injection |

Note: if the reference and test substance solution are stable within the detection time range, there is no need to prepare them again. If the solution is unstable and the chromatographic conditions are changed, it is necessary to prepare the reference and test substance solution again.

(2) Result Report

TABLE 2.9-1
Durability test results-1

| / | Standard | pH2.9 | pH3.1 | 209 nm | 213 nm | 0.58 ml/min | 0.62 ml/min |
|---|---|---|---|---|---|---|---|
| Macrozamin content | 0.69 | 0.69 | 0.68 | 0.71 | 0.73 | 0.73 | 0.72 |
| (%) | | | | | | | |
| Relative standard | / | 100.64 | 98.69 | 102.97 | 105.49 | 105.16 | 105.11 |
| content (%) | | | | | | | |
| Matrine content (%) | 3.49 | 3.48 | 3.50 | 3.48 | 3.48 | 3.46 | 3.48 |
| Relative standard | / | 99.72 | 100.23 | 99.76 | 99.81 | 99.19 | 99.68 |
| content (%) | | | | | | | |
| Sophocarpine content | 0.98 | 1.00 | 0.98 | 0.98 | 0.98 | 0.97 | 0.98 |
| (%) | | | | | | | |
| Relative standard | / | 101.83 | 99.62 | 99.32 | 99.69 | 98.66 | 99.19 |
| content (%) | | | | | | | |
| Sophoridine content | 0.83 | 0.83 | 0.83 | 0.83 | 0.82 | 0.83 | 0.83 |
| (%) | | | | | | | |
| Relative standard | / | 100.43 | 100.44 | 100.22 | 99.28 | 99.95 | 99.75 |
| content (%) | | | | | | | |
| Oxysophocarpine | 2.39 | 2.38 | 2.42 | 2.38 | 2.38 | 2.37 | 2.38 |
| content (%) | | | | | | | |
| Relative standard | / | 99.77 | 101.26 | 99.88 | 99.86 | 99.27 | 99.54 |
| content (%) | | | | | | | |
| Oxymatrine content | 8.15 | 8.12 | 8.10 | 8.13 | 8.14 | 8.15 | 8.10 |
| (%) | | | | | | | |
| Relative standard | / | 99.67 | 99.37 | 99.75 | 99.92 | 99.97 | 99.38 |
| content (%) | | | | | | | |

TABLE 2.9-2
Durability test results-1

| | | Chromatographic | Chromatographic | | 0.15% | 0.25% | | |
|---|---|---|---|---|---|---|---|---|
| | | column | column | | KH₂ | KH₂ | | |
| / | Standard | 1 | 2 | Standard | PO₃ | PO₃ | 28° C. | 32° C. |
| Macrozamin | 0.69 | 0.75 | 0.73 | 0.67 | 0.63 | 0.64 | 0.66 | 0.71 |
| content (%) | | | | | | | | |
| Relative | / | 109.07 | 105.61 | / | 94.26 | 95.33 | 98.66 | 106.42 |
| standard | | | | | | | | |
| content (%) | | | | | | | | |
| Matrine | 3.49 | 3.38 | 3.36 | 3.34 | 3.38 | 3.37 | 3.47 | 3.36 |
| content (%) | | | | | | | | |
| Relative | / | 96.87 | 96.44 | / | 101.21 | 100.80 | 103.78 | 100.54 |
| standard | | | | | | | | |
| content (%) | | | | | | | | |
| Sophocarpine | 0.98 | 0.98 | 0.96 | 0.92 | 0.99 | 0.94 | 0.95 | 0.94 |
| content (%) | | | | | | | | |
| Relative | / | 99.30 | 97.57 | / | 107.50 | 101.84 | 103.24 | 101.95 |
| standard | | | | | | | | |
| content (%) | | | | | | | | |
| Sophoridine | 0.83 | 0.84 | 0.83 | 0.79 | 0.80 | 0.81 | 0.82 | 0.79 |
| content (%) | | | | | | | | |
| Relative | / | 101.52 | 99.75 | / | 101.01 | 101.93 | 103.52 | 100.26 |
| standard | | | | | | | | |
| content (%) | | | | | | | | |
| Oxysophocarpine | 2.39 | 2.46 | 2.41 | 2.24 | 2.29 | 2.30 | 2.32 | 2.25 |
| content | | | | | | | | |
| (%) | | | | | | | | |
| Relative | / | 103.22 | 100.84 | / | 102.32 | 103.04 | 103.65 | 100.76 |
| standard | | | | | | | | |
| Content (%) | | | | | | | | |
| Oxymatrine | 8.15 | 8.18 | 8.01 | 7.73 | 7.68 | 7.77 | 7.92 | 7.75 |
| content (%) | | | | | | | | |
| Relative | / | 100.34 | 98.29 | / | 99.33 | 100.53 | 102.46 | 100.24 |
| standard | | | | | | | | |
| content (%) | | | | | | | | |

(3) Conclusion

The contents of the test substance solutions are basically the same under different conditions, and the content of individual indicator components are within 9000-110% relative to the standard conditions. This indicates that the content detection of this product has good durability under conditions such as column temperature, wavelength, mobile phase pH, and different chromatographic column models.

2.10 Sample Test

(1) Experimental Steps

Preparation of blank solvent: preparing 0.2% potassium dihydrogen phosphate solution-methanol=85:15 mixed solution, and filtering.

Preparation of reference substance solution: preparing a reference substance solution by the method provided under Section 2.1, and preparing two copies using the same method.

Preparation of test substance solution: accurately weighing 1 ml of individual batches of Compound Kushen Injection, adding to a 50 ml volumetric flask, adding blank solution to scale, shaking, filtering, and taking the subsequent filtrate as the test substance solution.

Requirements for Injection Procedure

Injection Sequence

| Sequence | Sample | Injection number |
|---|---|---|
| 1 | Blank solution | 1 injection |
| 2 | Reference substance 1 solution | 5 injections |
| 3 | Reference substance 2 solution | 2 injections |
| 4 | Test substance-1 | 1 injection |
| 5 | Test substance-2 | 1 injection |
| 6-12 | Test substance-3-Test substance-9 | 1 injection/each test |
| | | substance |
| 13 | Test substance-10 | 1 injection |
| 14 | Reference substance 1 solution | 1 injection |

(2) Result Report

TABLE 2.10
Content determination results

| Content | Macro- | | | | | |
|---|---|---|---|---|---|---|
| mg/ml | zamin | Matrine | Sophocarpine | Sophoridine | Oxysophocarpine | Oxymatrine |
| 20181034 | 0.53 | 4.22 | 1.11 | 0.89 | 2.36 | 8.37 |
| 20181139 | 0.72 | 3.67 | 1.03 | 0.87 | 2.28 | 7.73 |
| 20181203 | 0.73 | 3.37 | 0.93 | 0.75 | 2.24 | 7.72 |
| 20181204 | 0.72 | 3.39 | 0.94 | 0.75 | 2.20 | 7.62 |
| 20181209 | 0.65 | 2.88 | 0.82 | 0.73 | 2.59 | 9.01 |
| 20181212 | 0.63 | 2.66 | 0.75 | 0.75 | 2.84 | 9.95 |
| 20181213 | 0.70 | 2.88 | 0.82 | 0.70 | 2.48 | 8.63 |
| 20181214 | 0.70 | 2.99 | 0.84 | 0.72 | 2.51 | 8.74 |
| 20181215 | 0.68 | 3.78 | 1.06 | 0.74 | 2.25 | 7.93 |

### Example 2: Detection of 2,3-dihydroxy-2-[(4-hydroxyphenyl)methyl]butanedioic Acid in Compound Kushen Injection

1. Chromatographic Conditions, Sample Preparation, System Applicability Requirements, Calculation Formulas, Limit Requirements, Etc.

### Method Description

| Detection | | | |
|---|---|---|---|
| method | Detection conditions | | |
| Chromatographic | Waters XSelect CSH ™ C18 (5 μm, 4.6 mm × 250 mm) | | |
| column | | | |
| Mobile phase | 0.2% Potassium dihydrogen phosphate solution (adjusted to pH | | |
| | 3.0 with phosphoric acid)-methanol gradient elution | | |
| | | methanol | 0.2% Potassium dihydrogen |
| | time (min) | (%) | phosphate (%) |
| Elution | 0-10 | 3 | 97 |
| condition | 10-15 | 3-5 | 97-95 |
| | 15-24 | 5-15 | 95-85 |
| | 24-30 | 15 | 85 |
| | 30-55 | 15-85 | 85-15 |
| | 55-60 | 85 | 15 |
| | 60-75 | 3 | 97 |

| | |
|---|---|
| Column | 30° C. |
| temperature | |
| Detection | 211 nm |
| length | |
| Flowing speed | 0.6 ml/min |
| Injection | 10 μl |
| volume | |
| Solvent | 0.2% Potassium dihydrogen phosphate solution-methanol (85:15) |
| | mixed solution |
| Test substance | Accurately measuring 1 ml of Compound Kushen Injection and |
| solution | adding to a 50 ml volumetric flask, adding a blank solution (0.2% |
| | potassium dihydrogen phosphate solution-methanol = 85:15) to |
| | scale, shaking, filtering, and taking the subsequent filtrate as the |
| | test substance solution |
| reference | accurately weighing an appropriate amount of |
| substance | 2,3-dihydroxy-2-[(4-hydroxyphenyl)methyl]butanedioic acid |
| solution | reference material, adding blank solution to prepare a reference |
| | stock solution containing 0.25 mg of |
| | 2,3-dihydroxy-2-[(4-hydroxyphenyl)methyl]butanedioic acid per |
| | 1 ml, and shaking; and accurately measuring 2 ml of the reference |
| | stock solution, adding to a 10 ml volumetric flask, diluting the |
| | blank solution to scale and shaking. |
| System | reference substance solution |
| applicability | |
| solution | |
| System | Testing the reference substance solution continuously for 5 times, |
| applicability | with a peak area RSD of no more than 3.0%, a retention time |
| requirements | RSD of no more than 3.0%, and a theoretical plate number of no |
| | less than 3000 for the main peak, a tailing factor of no more than |
| | 1.5, and a resolution greater than 1.5 |
| Calculating | External standard method |
| method | |
| Standard | / |

2. Verification Content

2.1 System Applicability

(1) Experimental Steps

Preparation of blank solution: preparing 0.2% potassium dihydrogen phosphate solution-methanol=85:15 mixed solution, and filtering.

Preparation of reference substance solution: accurately weighing an appropriate amount of 2,3-dihydroxy-2-[(4-hydroxyphenyl)methyl]butanedioic acid reference substance solution, adding blank solution to prepare a reference substance stock solution containing 0.25 mg of 2,3-dihydroxy-2-[(4-hydroxyphenyl)methyl]butanedioic acid per 1 ml, and shaking; and accurately weighing 2 ml of the reference substance stock solution, adding to a 10 ml volumetric flask, diluting the blank solution to scale, and shaking.

Preparation of test substance solution: accurately weighing 1 ml of Compound Kushen Injection, adding to a 50 ml volumetric flask, adding blank solution to scale, shaking, filtering, and taking the subsequent filtrate as the test substance solution.

Requirements for Sampling Procedure

### Injection Sequence

| Sequence | Sample | Injection number |
|---|---|---|
| 1 | Blank solution | 1 injection |
| 2 | reference substance solution | 5 injections (continuous |
| | | injections) |
| 3 | test substance solution | 1 injection |

(2) Results Report

RSD values of peak area and retention time for 5 continuous injections of reference substance solution

TABLE 2.1-1
Peak area and retention time results of reference substance solution

| / | 1 | 2 | 3 | 4 | 5 | Average | RSD (%) |
|---|---|---|---|---|---|---|---|
| Retention | 31.862 | 31.823 | 31.866 | 31.959 | 31.936 | 31.889 | 0.18 |
| time (min) | | | | | | | |
| Peak area | 985829 | 991694 | 991086 | 986715 | 988522 | 988769 | 0.26 |

TABLE 2.1-2
System applicability results

| / | 1 | 2 | 3 | 4 | 5 |
|---|---|---|---|---|---|
| Theoretical | 137799.32 | 138286.39 | 137102.37 | 136849.31 | 136813.71 |
| plate number | | | | | |
| Tailing factor | 1.05 | 1.04 | 1.04 | 1.04 | 1.04 |

(3) Conclusion

From the results, it can be seen that after 5 continuous injections of the reference substance solution, the RSD values of the peak area measurement values of 2,3-dihydroxy-2-[(4-hydroxyphenyl)methyl]butanedioic acid are all less than 2.0%, the RSD values of the retention time are all less than 2.000, the numbers of theoretical plates are greater than 3000, and the tailing factors are all less than 1.5, meeting the requirements.

2.2 Specificity

(1) Experimental Steps

Preparation of blank solution: preparing 0.2% potassium dihydrogen phosphate solution-methanol=85:15 mixed solution, and filtering, obtained.

Preparation of negative sample solution: accurately weighing 1 ml of single Sophora flavescens injection (wild and cultivated) and 1 ml of single Heterosmilax yunnanensis Gagnep injection, adding to a 50 ml volumetric flask, adding blank solution to scale, shaking, filtering, and taking the subsequent filtrate as the negative sample solution.

Preparation of 0.25% Tween solution: weighing 0.25 g Tween 80, dissolving in water to 100 ml, shaking, filtering, and taking the subsequent filtrate as the 0.25% Tween solution.

Preparation of reference substance solution: preparing a reference substance solution by the method provided under Section 2.1.

Preparation of test substance solution: accurately weighing 1 ml of Compound Kushen Injection and adding to a 50 ml volumetric flask, adding blank solution to scale, and shaking.

Preparation of filter membrane interference sample: centrifuging one portion of the test substance solution; and filtering one portion of the test substance solution, discarding different volumes (1 ml, 3 ml, 5 ml, 7 ml, and 9 ml).

Requirements for Sampling Procedure

Injection Sequence

| | | Injection |
|---|---|---|
| Sequence | Sample | number |
| 1 | Blank solution | 1 injection |
| 2 | Negative Sample solution (Sophora | 1 injection |
| | flavescens alone) | |
| 3 | Negative Sample solution (Heterosmilax | 1 injection |
| | yunnanensis Gagnep alone) | |
| 4 | 0.25% Tween 80 solution | 1 injection |
| 5 | reference substance solution | 1 injection |
| 6 | Test substance solution-centrifuging | 1 injection |
| 7 | Test substance solution-filtered 1 ml | 1 injection |
| 8 | Test substance solution-filtered 3 ml | 1 injection |
| 9 | Test substance solution-filtered 5 ml | 1 injection |
| 10 | Test substance solution-filtered 7 ml | 1 injection |
| 11 | Test substance solution-filtered 9 ml | 1 injection |

(2) Result Report

Refer to FIG. 3 and the table below

Table 2.2-1 Results of Filter Membrane Interference Experiment

(Area Percentage of Discarded Different Volumes Relative to the Centrifuged Samples)

| Sample | Retention time | Peak area | Relative centrifugal % |
|---|---|---|---|
| Centrifuging | 31.936 | 683418 | / |
| 1 ml | 31.944 | 685973 | 100.37 |
| 3 ml | 31.867 | 690153 | 100.99 |
| 5 ml | 31.796 | 686450 | 100.44 |
| 7 ml | 31.772 | 686571 | 100.46 |
| 9 ml | 31.847 | 681753 | 99.76 |
| Average | 31.860 | 685720 | / |
| RSD % | 0.22 | 0.42 | / |

(3) Conclusion

From the results, it can be seen that, the blank solution, the blank mobile phase, and 0.25% Tween-80 solution do not interfere with the sample, while the negative sample solution of single Heterosmilax yunnanensis Gagnep do not interfere with 2,3-dihydroxy-2-[(4-hydroxyphenyl)methyl]butanedioic acid.

After discarding different volumes, the relative content between the area of the indicator components of the test substance solution and the area of the centrifuged test substance solution is 98.0%-102.0%, and the adsorption can be ignored.

2.3 Linearity and Range

(1) Experimental Steps

Preparation of blank solution: preparing 0.2% potassium dihydrogen phosphate solution-methanol=85:15 mixed solution, and filtering, which is obtained.

Preparation of linear stock solution: accurately weighing an appropriate amount of 2,3-dihydroxy-2-[(4-hydroxyphenyl)methyl]butanedioic acid reference substance, adding blank solution, preparing a stock solution containing 0.25 mg of 2,3-dihydroxy-2-[(4-hydroxyphenyl)methyl]butanedioic acid per 1 ml of reference substance, and shaking.

25% linear solution: accurately measuring 0.5 ml of the reference stock solution, adding to a 10 ml volumetric flask, diluting with blank solution to scale, and shaking.

50% linear solution: accurately measuring 1 ml of the reference stock solution, adding to a 10 ml volumetric flask, diluting with blank solution to scale, and shaking.

100% linear solution: accurately measuring 2 ml of the reference stock solution, adding to a 10 ml volumetric flask, diluting with blank solution to scale, and shaking.

150% linear solution: accurately measuring 3 ml of the reference stock solution, adding to a 10 ml volumetric flask, diluting with blank solution to scale, and shaking.

200% linear solution: accurately measuring 4 ml of the reference stock solution, adding to a 10 ml volumetric flask, diluting with blank solution to scale, and shaking.

Requirements for Sampling Procedure

Injection Sequence

| Sequence | Sample | Injection number |
|---|---|---|
| 1 | Blank solution | 1 injection |
| 2 | 100% reference substance solution | Continuous |
| | | 5 injections |
| 3 | 25% reference substance solution | 1 injection |
| 4 | 50% reference substance solution | 1 injection |
| 5 | 100% reference substance solution | 1 injection |
| 6 | 150% reference substance solution | 1 injection |
| 7 | 200% reference substance solution | 1 injection |
| 8 | 100% reference substance solution | 1 injection |

(2) Result Report

The regression equation, the correlation coefficient, and the linear graph results of 2,3-dihydroxy-2-[(4-hydroxyphenyl)methyl]butanedioic acid are shown in FIG. 4.

(3) Conclusion

2,3-dihydroxy-2-[(4-hydroxyphenyl)methyl]butanedioic acid is linear within the range of 0.0122 mg/ml-0.0978 mg/ml; and the linear correlation coefficient is greater than or equal to 0.999, meeting the standard.

2.4 Repeatability

(1) Experimental Steps

Preparation of blank solution: preparing 0.21 potassium dihydrogen phosphate solution-methanol=85:15 mixed solution, and filtering, which is obtained.

Preparation of reference substance solution: preparing the reference substance solution by the method under Section 2.1, and preparing two portions using the same method.

Preparation of test substance solution (6 copies): accurately measuring 1 ml of Compound Kushen Injection, adding to a 50 ml volumetric flask, adding blank solution to scale, shaking, filtering, and taking the subsequent filtrate as the test substance solution; and performing 6 operations in parallel.

Requirements for Sampling Procedure

Injection Sequence

| Sequence | Sample | Injection number |
|---|---|---|
| 1 | Blank solution | 1 injection |
| 2 | Reference substance 1 solution | 5 injections |
| | | (continuous test) |
| 3 | Reference substance 2 solution | 2 injections |
| 4 | Test substance-1 solution | 1 injection |
| 5 | Test substance-2 solution | 1 injection |
| 6 | Test substance-3 solution | 1 injection |
| 7 | Test substance-4 solution | 1 injection |
| 8 | Test substance-5 solution | 1 injection |
| 9 | Test substance-6 solution | 1 injection |
| 10 | Reference substance 1 solution | 1 injection |

(2) Result Report

TABLE 2.4
Repeatability test results

| / | 1 | 2 | 3 | 4 | 5 | 6 | Average (%) | RSD (%) |
|---|---|---|---|---|---|---|---|---|
| piscidic | 1.625 | 1.624 | 1.618 | 1.626 | 1.641 | 1.621 | 1.626 | 0.50 |
| acid (%) | | | | | | | | |

(3) Conclusion

From the results, it can be seen that the RSD of 2,3-dihydroxy-2-[(4-hydroxyphenyl)methyl]butanedioic acid content in the 6 test substances is less than 3.0%, indicating good repeatability of the test substances.

2.5 Intermediate Precision

(1) Experimental Steps

According to the repeatability measurement method, six test substance solutions of the same batch are prepared in parallel by different analysts using different apparatuses and on different dates. The solution preparation and injection procedures are the same as those under Section repeatability.

(2) Result Report

TABLE 2.5
Intermediate precision test results of piscidic acid

| | Test | Content | Average | Total | RSD |
|---|---|---|---|---|---|
| / | substance | (%) | content (%) | average (%) | (%) |
| Apparatus: | 1 | 1.625 | 1.626 | 1.629 | 0.65 |
| CHP-002 | 2 | 1.624 | | | |
| | 3 | 1.618 | | | |
| | 4 | 1.626 | | | |
| | 5 | 1.641 | | | |
| | 6 | 1.621 | | | |
| Apparatus: | 1 | 1.667 | 1.648 | | |
| CHP-042 | 2 | 1.675 | | | |
| | 3 | 1.594 | | | |
| | 4 | 1.644 | | | |
| | 5 | 1.660 | | | |
| | 6 | 1.646 | | | |

(3) Conclusion

From the results, it can be seen that, different personnel tested the samples with different apparatuses on different dates. The RSD of 2,3-dihydroxy-2-[(4-hydroxyphenyl)methyl]butanedioic acid content in the 12 test substances is 0.65%, less than 3.0%, indicating good intermediate precision.

2.6 Solution Stability

(1) Experimental Steps

Preparation of blank solution: preparing 0.2% potassium dihydrogen phosphate solution-methanol=85:15 mixed solution, and filtering, which is obtained.

Preparation of reference substance solution: preparing the reference substance solution by the method under Section 2.1, and preparing two portions using the same method.

Preparation of test substance solution: accurately measuring 1 ml of Compound Kushen Injection, adding to a 50 ml volumetric flask, adding blank solution to scale, shaking, filtering, and taking the subsequent filtrate as the test substance solution.

Requirements for Sampling Procedure

Injection Sequence

| Sequence | Sample | Injection number |
|---|---|---|
| 1 | Blank solution | 1 injection |
| 2 | Reference substance 1 solution | 5 injections |
| | | (continuous test) |
| 3 | Reference substance 2 solution | 2 injections |
| 4 | Test substance-0 h | 1 injection |
| 5 | Reference substance-4 h | 1 injection |
| 6 | Test substance-4 h | 1 injection |
| 7 | Reference substance-8 h | 1 injection |
| 8 | Test substance-8 h | 1 injection |
| 9 | Reference substance-12 h | 1 injection |
| 10 | Test substance-12 h | 1 injection |
| 11 | Reference substance-18 h | 1 injection |
| 12 | Test substance-18 h | 1 injection |
| 13 | Reference substance-24 h | 1 injection |
| 14 | Test substance-24 h | 1 injection |
| 15 | Reference substance 1 solution | 1 injection |

(2) Result Report

TABLE 2.6
Solution stability test results

| | | | | | | | Average | RSD |
|---|---|---|---|---|---|---|---|---|
| Time (h) | 0 | 4 | 8 | 12 | 18 | 24 | (%) | (%) |
| piscidic acid | 1.606 | 1.601 | 1.603 | 1.607 | 1.600 | 1.604 | 1.604 | 0.17 |
| content (%) | | | | | | | | |
| Relative 0 h | / | 99.69 | 99.85 | 100.09 | 99.64 | 99.86 | / | / |
| content (%) | | | | | | | | |

(3) Conclusion

From the results, it can be seen that after standing the test substance solution left for 24 hours, the RSD of the 2,3-dihydroxy-2-[(4-hydroxyphenyl)methyl] butanedioic acid content in the test substance is less than 3%, indicating that the test substance is stable within 24 hours.

The percentage of the indicator component area at individual time points to the 0-hour indicator component area is calculated. Compared with the initial results, the relative content of the control and test substance solution at individual time points is 98.0%-102.0%, indicating good solution stability.

2.7 Accuracy

(1) Experimental Steps

Preparation of blank solution: preparing 0.2% potassium dihydrogen phosphate solution-methanol=85:15 mixed solution, and filtering.

Preparation of reference substance solution: preparing the reference substance solution by the method under Section 2.1, and preparing two portions using the same method.

Preparation of 5000 recovery solution: accurately measuring 0.5 ml of Compound Kushen Injection, adding to a 50 ml volumetric flask, adding 2 ml of reference stock solution, adding blank solution to scale, shaking, filtering, and taking it as a 502 recovery solution (preparing 3 copies using the same method).

100% recovery solution: accurately measuring 0.5 ml of Compound Kushen Injection, adding to a 50 ml volumetric flask, adding 4 ml of the reference stock solution, adding a blank solution to scale, shaking, filtering, and taking it as a 100% recovery solution (preparing 3 copies using the same method).

150% recovery solution: accurately measuring 0.5 ml of Compound Kushen Injection, adding to a 50 ml volumetric flask, adding 6 ml of the reference stock solution, adding a blank solution to scale, shaking, filtering, and taking it as a 150% recovery solution (preparing 3 copies using the same method).

Requirements for Sampling Procedure

Injection Sequence

| Sequence | Sample | Injection number |
|---|---|---|
| 1 | Blank solution | 1 injection |
| 2 | Reference substance 1 solution | 5 injections |
| | | (continuous test) |
| 3 | Reference substance 2 solution | 2 injections |
| 4 | 50%-1 recovery rate solution | 2 injections |
| 5 | 50%-2 recovery rate solution | 2 injections |
| 6 | 50%-3 recovery rate solution | 2 injections |
| 7 | 100%-1 recovery rate solution | 2 injections |
| 8 | 100%-2 recovery rate solution | 2 injections |
| 9 | 100%-3 recovery rate solution | 2 injections |
| 10 | 150%-1 recovery rate solution | 2 injections |
| 11 | 150%-2 recovery rate solution | 2 injections |
| 12 | 150%-3 recovery rate solution | 2 injections |
| 13 | Reference substance 1 solution | 1 injection |

(2) Result Report

Recovery Rate Calculation Formula:

$$Recovery rate = \frac{measured value - amount of test substance}{added amount of control substance} * 100 \%$$

TABLE 2.7
Results of piscidic acid content recovery test

| | | Added amount | | | | |
|---|---|---|---|---|---|---|
| | Content of test | of Reference | Measured | Recovery | Average/ | RSD/ |
| | substance/mg | substance/mg | value/mg | rate/% | % | % |
| 50%-1 | 0.813 | 0.4092 | 1.2184 | 99.07 | 99.53 | 1.75 |
| 50%-2 | 0.813 | 0.4092 | 1.2149 | 98.21 | | |
| 50%-3 | 0.813 | 0.4092 | 1.2080 | 96.54 | | |
| 100%-1 | 0.813 | 0.8184 | 1.6462 | 101.81 | | |
| 100%-2 | 0.813 | 0.8184 | 1.6177 | 98.32 | | |
| 100%-3 | 0.813 | 0.8184 | 1.6275 | 99.52 | | |
| 150%-1 | 0.813 | 1.2276 | 2.0370 | 99.71 | | |
| 150%-2 | 0.813 | 1.2276 | 2.0503 | 100.79 | | |
| 150%-3 | 0.813 | 1.2276 | 2.0626 | 101.79 | | |

(3) Conclusion

The recovery rate of 2,3-dihydroxy-2-[(4-hydroxyphenyl)methyl]butanedioic acid in the test substance ranges from 92% to 105%, with an RSD value of 1.75%, which is less than 4%, meeting the requirements.

2.8 Durability

(1) Experimental Steps

Different chromatographic conditions are shown in the table below.

| Parameter | Specified value | Recommended varying range |
|---|---|---|
| Column | 30° C. | 28° C., 32° C. |
| temperature(° C.) | | |
| Concentration of | 0.2% | 0.15%, 0.25% |
| buffering salt | | |
| pH value of | 3.0 | 2.9, 3.1 |
| buffering salt | | |
| Flowing speed | 0.6 ml/min | 0.58 ml/min, 0.62 ml/min |
| Wavelength | 211 | 209, 213 |
| (nm) | | |
| Chromatographic | Waters XSelect | Waters XSelect CSH ™ |
| column | CSH ™ C₁₈ | C₁₈ (4.6 mm × 250 mm, |
| | (4.6 mm × 250 mm, | 5 μm), Sel No. |
| | 5 μm), Sel No. | 01203827518752 |
| | 01203827518723 | Waters XSelect CSH ™ |
| | | C₁₈ (4.6 mm × 250 mm, |
| | | 5 μm), Sel No. |
| | | 01203827518726 |

Preparation of blank solution: preparing 0.2% potassium dihydrogen phosphate solution-methanol=85:15 mixed solution, and filtering.

Preparation of reference substance solution: preparing the reference substance solution by the method under Section 2.1.

Preparation of test substance solution: accurately measuring 1 ml of Compound Kushen Injection, adding to a 50 ml volumetric flask, adding blank solution to scale, shaking, filtering, and taking the subsequent filtrate as the test substance solution; and preparing two copies using the same method.

Requirements for injection procedure (samples are injected in this order under different inspection conditions)

Injection Sequence

| Sequence | Sample | Injection number |
|---|---|---|
| 1 | Blank solution | 1 injection |
| 2 | Reference substance 1 solution | 5 injections |
| 3 | Reference substance 2 solution | 2 injections |
| 4 | Test substance-1 | 1 injection |
| 5 | Test substance-2 | 1 injection |
| 6 | Reference substance 1 solution | 1 injection |

Note: If the reference and test substance solution are stable within the detection time range, there is no need to prepare them again. If the solution is unstable and the chromatographic conditions are changed, it is necessary to prepare the reference and test substance solution again.

(2) Result Report

TABLE 2.8-1
Content durability test results

| / | Standard | 28° C. | 32° C. | 209 nm | 213 nm | 0.58 ml/min | 0.62 ml/min |
|---|---|---|---|---|---|---|---|
| piscidic acid | 1.576 | 1.616 | 1.597 | 1.573 | 1.577 | 1.573 | 1.588 |
| content (%) | | | | | | | |
| Relative standard | / | 102.54 | 101.33 | 99.81 | 100.06 | 99.81 | 100.76 |
| condition content | | | | | | | |
| (%) | | | | | | | |

TABLE 2.8-2
Content Durability Test Results

| | | Chromatographic | Chromatographic | | | | | |
|---|---|---|---|---|---|---|---|---|
| / | Standard | column 1 | column 2 | Standard | 0.15% | 0.25% | pH2.9 | pH3.1 |
| piscidic | 1.628 | 1.654 | 1.619 | 1.576 | 1.642 | 1.625 | 1.565 | 1.688 |
| acid content | | | | | | | | |
| (%) | | | | | | | | |
| Relative | / | 101.60 | 99.45 | / | 104.19 | 103.11 | 99.30 | 107.11 |
| standard | | | | | | | | |
| condition | | | | | | | | |
| Content | | | | | | | | |
| (%) | | | | | | | | |

(3) Conclusion

The content of the test substance solution is basically the same under different conditions, and the content of each indicator component is between 90%-110% relative to the standard conditions. This indicates that the content detection of this product has good durability under conditions such as column temperature, wavelength, mobile phase pH, and different chromatographic column models.

2.9 Sample Test

(1) Experimental Steps

Preparation of blank solvent: preparing 0.2% potassium dihydrogen phosphate solution-methanol=85:15 mixed solution, and filtering.

Preparation of reference substance solution: preparing the reference substance solution by the method under Section 2.1, and preparing two portions using the same method.

Preparation of test substance solution: accurately measuring 1 ml of individual batches of Compound Kushen Injection, adding to a 50 ml volumetric flask, adding blank solution to scale, shaking, filtering, and taking the subsequent filtrate as the test substance solution.

Requirements for Injection Procedure

Injection Sequence

| Sequence | Sample | Injection number |
|---|---|---|
| 1 | Blank solution | 1 injection |
| 2 | Reference substance 1 solution | 5 injections |
| 3 | Reference substance 2 solution | 2 injections |
| 4 | Test substance-1 | 1 injection |
| 5 | Test substance-2 | 1 injection |
| 6-12 | Test substance-3-Test substance-9 | 1 injection/each |
| | | test substance |
| 13 | Test substance-10 | 1 injection |
| 14 | Reference substance 1 solution | 1 injection |

(2) Result Report

TABLE 2.9
Determination results of piscidic acid content

| Batch | piscidic | Batch | piscidic | Batch | piscidic |
|---|---|---|---|---|---|
| number | acid | number | acid | number | acid |
| 20181034 | 1.626 | 20181215 | 2.072 | 201904013 | 2.121 |
| 20181138 | 2.020 | 20190404 | 1.993 | 20190414 | 2.074 |
| 20181139 | 1.979 | 20190405 | 1.715 | 20180503 | 1.347 |
| 20181203 | 2.194 | 20190406 | 1.763 | 20181010 | 2.005 |
| 20181204 | 2.200 | 20190407 | 2.166 | 20181134 | 1.918 |
| 20181209 | 1.798 | 20190408 | 2.165 | 20181107 | 2.016 |
| 20181212 | 1.747 | 20190409 | 2.177 | 20181202 | 1.969 |
| 20181213 | 1.847 | 20190410 | 2.147 | | |
| 20181214 | 1.877 | 20190412 | 1.662 | | |

### Example 3 Fingerprint Detection of Related Components in Compound Kushen Injection

1. Chromatographic Conditions, Elution Conditions, Sample Preparation, Etc.

Method Description

| Detection | | | |
|---|---|---|---|
| method | Detection conditions | | |
| Chromatographic | Waters XSelect CSH ™ C₁₈ (5 μm, 4.6 mm × 250 mm) | | |
| column | | | |
| Mobile phase | 0.2% potassium dihydrogen phosphate solution (adjusted to pH 3.0 with | | |
| | phosphoric acid)-methanol gradient elution | | |
| | | | 0.2% Potassium |
| | time (min) | methanol (%) | dihydrogen phosphate (%) |
| Elution | 0-10 | 3 | 97 |
| condition | 10-15 | 3-5 | 97-95 |
| | 15-24 | 5-15 | 95-85 |
| | 24-30 | 15 | 85 |
| | 30-55 | 15-85 | 85-15 |
| | 55-60 | 85 | 15 |
| | 60-75 | 3 | 97 |

| | | |
|---|---|---|
| Column | 30° | C. |
| temperature | | |
| Detection length | 211 | nm |
| Flowing speed | 0.6 | ml/min |
| Injection volume | 10 | μl |

| | |
|---|---|
| Solvent | 0.2% potassium dihydrogen phosphate solution-methanol (85:15) |
| | mixed solution |
| Test substance | Accurately measuring 1 ml of Compound Kusen Injection, adding to a 50 |
| solution | ml volumetric flask, adding a blank solution (0.2% potassium dihydrogen |
| | phosphate solution-methanol = 85:15) to scale, shaking, filtering, and taking |
| | a subsequent filtrate as the test substance solution |
| reference | Accurately weighing an appropriate amount of matrine reference substance, |
| substance | oxymatrine reference substance, and oxysophocarpine reference substance, |
| solution | adding blank solution to prepare a mixed reference substance solution I |
| | containing 0.33 mg of matrine, 0.85 mg of oxymatrine, and 0.25 mg of |
| | oxysophocarpine per 1 ml, shaking to obtain the solution; accurately weigh |
| | an appropriate amount of sophocarpine reference substance, sophoridine |
| | reference substance, and macrozamin reference substance, adding blank |
| | solution to prepare a mixed reference substance solution II containing 0.09 |
| | mg of sophocarpine, 0.08 mg of sophoridine, and 0.08 mg of macrozamin |
| | per 1 ml, and shaking, which is obtained; and accurately measure 2 ml of |
| | mixed reference substance solution I, II, and III, adding to a 10 ml volumetric |
| | flask, diluting with blank solution to scale, and shaking, which is obtained. |

2. Verifying Specific Content

2.1 System Applicability

(1) Experimental Steps

Preparation of blank solution: preparing methanol 0.2% potassium dihydrogen phosphate=15:85, and filtering.

Preparation of reference substance solution: accurately weighing an appropriate amount of matrine reference substance, oxymatrine reference substance, and oxysophocarpine reference substance, adding blank solution to prepare a mixed reference substance solution I containing 0.33 mg of matrine, 0.85 mg of oxymatrine, and 0.25 mg of oxysophocarpine per 1 ml, and shaking, which is obtained; accurately weighing an appropriate amount of sophocarpine reference substance, sophoridine reference substance, and macrozamin reference substance, and adding blank solution to prepare a mixed reference substance solution II containing 0.09 mg of sophocarpine, 0.08 mg of sophoridine, and 0.08 mg of macrozamin per 1 ml, and shaking, which is obtained; and accurately measuring 2 ml of mixed reference substance solution I and II, adding to a 10 ml volumetric flask, diluting with blank solution to scale, and shaking, which is obtained.

test substance solution: accurately measuring 1 ml of Compound Kushen Injection, adding to a 50 ml volumetric flask, adding blank solution to scale, shaking, filtering, and taking the subsequent filtrate as the test substance solution.

The injection sequence and requirements are shown in the table below.

Injection Sequence

| Sequence | Sample | Injection number |
|---|---|---|
| 1 | Blank solution | 1 injection |
| 2 | reference substance solution | 5 injections |
| | | (continuous injections) |
| 3 | Test substance solution | 1 injection |
| 4 | reference substance solution | 1 injection |

(2) Result Report

RSD values of peak area and retention time for 5 consecutive injections of the reference substance solution.

TABLE 2.1-1
Peak area and retention time results of reference substance solution

| | Macrozamin | | Matrine | | Sophocarpine | | Sophoridine | | Oxysophocarpine | | Oxymatrine | |
|---|---|---|---|---|---|---|---|---|---|---|---|---|
| Reference | Retention | Peak | Retention | Peak | Retention | Peak | Retention | Peak | Retention | Peak | Retention | Peak |
| substance | time | area | time | area | time | area | time | area | time | area | time | area |
| 1 | 16.804 | 299832 | 19.219 | 1625200 | 22.676 | 613077 | 23.512 | 362821 | 26.208 | 1601243 | 27.855 | 3704112 |
| 2 | 16.786 | 301982 | 19.243 | 1619597 | 22.697 | 607988 | 23.513 | 364852 | 26.231 | 1593477 | 27.842 | 3726630 |
| 3 | 16.719 | 299780 | 19.178 | 1616523 | 22.707 | 609700 | 23.532 | 363569 | 26.221 | 1591105 | 27.855 | 3698111 |
| 4 | 16.800 | 299063 | 19.232 | 1616141 | 22.667 | 608213 | 23.533 | 363066 | 26.219 | 1590745 | 27.859 | 3707737 |
| 5 | 16.802 | 300050 | 19.234 | 1614686 | 22.694 | 608479 | 23.538 | 363688 | 26.223 | 1588870 | 27.856 | 3702820 |
| RSD % | 0.21 | 0.36 | 0.13 | 0.26 | 0.07 | 0.35 | 0.05 | 0.22 | 0.03 | 0.30 | 0.02 | 0.30 |

TABLE 2.1-2
System applicability results

| | Macrozamin | | Matrine | | | Sophocarpine | | | Sophoridine |
|---|---|---|---|---|---|---|---|---|---|
| Reference | Plate | Tailing | Plate | | Tailing | Plate | | Tailing | Plate |
| substan | number | factor | number | Resolution | factor | number | Resolution | factor | number |
| 1 | 17476.67 | 0.99 | 30384.96 | 5.03 | 1.19 | 78536.07 | 8.86 | 0.99 | 104440.15 |
| 2 | 17309.51 | 0.99 | 30392.70 | 5.04 | 1.18 | 79022.31 | 8.92 | 0.99 | 105065.99 |
| 3 | 17110.11 | 0.99 | 29849.04 | 5.06 | 1.19 | 79432.30 | 8.90 | 1.00 | 105749.67 |
| 4 | 17418.16 | 0.99 | 30726.01 | 5.04 | 1.18 | 77228.17 | 8.91 | 0.99 | 105809.11 |
| 5 | 17240.82 | 0.99 | 30589.42 | 5.04 | 1.19 | 79305.99 | 8.93 | 0.99 | 106907.80 |
| | | Sophoridine | | Oxysophocarpine | | | Oxymatrine | | |
| | Reference | | Tailing | Plate | | Tailing | Plate | | Tailing |
| | substan | Resolution | factor | number | Resolution | factor | number | Resolution | factor |
| | 1 | 2.69 | 1.01 | 146804.80 | 9.37 | 1.08 | 127497.48 | 5.47 | 1.27 |
| | 2 | 2.67 | 1.01 | 145430.20 | 9.45 | 1.07 | 127994.51 | 5.47 | 1.27 |
| | 3 | 2.69 | 1.01 | 145669.71 | 9.38 | 1.07 | 128912.67 | 5.47 | 1.27 |
| | 4 | 2.68 | 1.01 | 146255.25 | 9.35 | 1.07 | 128684.75 | 5.47 | 1.27 |
| | 5 | 2.68 | 1.01 | 147366.56 | 9.36 | 1.07 | 128866.04 | 5.46 | 1.27 |

(3) Conclusion

From the results, it can be seen that after 5 consecutive injections of the reference substance solution, the RSD of the peak areas of oxymatrine, matrine, and oxysophocarpine is less than 2.0%, and the RSD of the retention time is less than 2.0%. The RSD of the peak areas of sophocarpine, sophoridine, and methyloxyazomethanol primrose glycoside is less than 3.0%, and the RSD of the retention time is less than 3.0%; and the theoretical number of six indicator components is greater than 3000, and the trailing factor is less than 2.0, meeting the requirements.

2.2 Establish of Fingerprint

(1) Experimental Steps

Blank solution: preparing methanol-0.2% potassium dihydrogen phosphate=15:85 mixed solution, and filtering.

Preparation of reference substance solution: preparing the reference substance solution by the method under Section 2.1.

Test substance solution for individual batches: accurately measuring 1 ml of Compound Kushen Injection from each of the batches, adding to a 50 ml volumetric flask, adding blank solution to scale, shaking, filtering, and taking the subsequent filtrate as the test substance solution.

The injection sequence and requirements are shown in the table below.

Injection Sequence

| Sequenc | Sample | Injection number |
|---|---|---|
| 1 | Blank solution | 1 injection |
| 2 | reference substance solution | 5 injections |
| | | (continuous test) |
| 3 | Test substance-1 solution | 1 injection |
| 4 | Test substance-2 solution | 1 injection |
| 5 | Test substance-3 solution | 1 injection |
| 6 | Test substance-4 solution | 1 injection |
| 7 | Test substance-5 solution | 1 injection |
| 8 | Test substance-6 solution | 1 injection |
| 9 | Test substance-7 solution | 1 injection |
| 10 | Test substance-8 solution | 1 injection |
| 11 | Test substance-9 solution | 1 injection |
| 12 | Test substance-10 solution | 1 injection |
| 13 | reference substance solution | 1 injection |

(2) Result Report

Based on the chromatographic fingerprints of 10 batches of Compound Kushen Injection, data processing was carried out using the “Similarity Evaluation System for Chromatographic Fingerprint of Traditional Chinese Medicine” (2012 edition) recommended by the Pharmacopoeia Committee. The chromatographic peak of test substance 1 (S1) is used as the reference spectrum, and the median method is used, with a time window of 0.1. After multi-point correction, full peak matching is performed to generate a standard reference fingerprint and a common pattern. (Refer to FIGS. 5-1 to 5-2)

TABLE 2.2-1
Similarity results between fingerprints of individual batches and control fingerprints

| | Similarity | | | | | | | | | |
|---|---|---|---|---|---|---|---|---|---|---|
| | Test substance | | | | | | | | | |
| / | 20181138 | 20181034 | 20181139 | 20181203 | 20181204 | 20181209 | 20181212 | 20181213 | 20181214 | 20181215 |
| 20181138 | 1.0 | 0.995 | 0.998 | 0.998 | 0.999 | 0.996 | 0.989 | 0.997 | 0.997 | 0.997 |
| 20181034 | 0.995 | 1.0 | 0.998 | 0.994 | 0.995 | 0.985 | 0.976 | 0.987 | 0.988 | 0.997 |
| 20181139 | 0.998 | 0.998 | 1.0 | 0.998 | 0.999 | 0.989 | 0.979 | 0.991 | 0.992 | 0.999 |
| 20181203 | 0.998 | 0.994 | 0.998 | 1.0 | 0.999 | 0.991 | 0.983 | 0.993 | 0.994 | 0.998 |
| 20181204 | 0.999 | 0.995 | 0.999 | 0.999 | 1.0 | 0.991 | 0.983 | 0.993 | 0.994 | 0.999 |
| 20181209 | 0.996 | 0.985 | 0.989 | 0.991 | 0.991 | 1.0 | 0.998 | 0.999 | 0.999 | 0.989 |
| 20181212 | 0.989 | 0.976 | 0.979 | 0.983 | 0.983 | 0.998 | 1.0 | 0.997 | 0.996 | 0.979 |
| 20181213 | 0.997 | 0.987 | 0.991 | 0.993 | 0.993 | 0.999 | 0.997 | 1.0 | 1.0 | 0.991 |
| 20181214 | 0.997 | 0.988 | 0.992 | 0.994 | 0.994 | 0.999 | 0.996 | 1.0 | 1.0 | 0.992 |
| 20181215 | 0.997 | 0.997 | 0.999 | 0.998 | 0.999 | 0.989 | 0.979 | 0.991 | 0.992 | 1.0 |
| R | 1.0 | 0.994 | 0.997 | 0.998 | 0.998 | 0.997 | 0.991 | 0.998 | 0.999 | 0.997 |

TABLE 2.2-2
Results of non-common peaks for individual batches

| | | | Percentage of |
|---|---|---|---|
| | Non-common | Total | non-common |
| Test substance | Peak area | peak area | peak area |
| 20181138 | 379.92 | 11177.83 | 3.40% |
| 20181034 | 456.54 | 12764.97 | 3.58% |
| 20181139 | 392.82 | 11505.22 | 3.41% |
| 20181203 | 184.33 | 11235.09 | 1.64% |
| 20181204 | 316.82 | 11129.83 | 2.85% |
| 20181209 | 424.40 | 11913.89 | 3.56% |
| 20181212 | 413.06 | 12239.61 | 3.37% |
| 20181213 | 222.73 | 11265.96 | 1.98% |
| 20181214 | 227.85 | 11493.77 | 1.98% |
| 20181215 | 194.20 | 11628.20 | 1.67% |

(3) Conclusion

After comparison with the reference substance, it can be concluded that, the first peak represents sophoramine, the second peak represents macrozamin, the third peak represents matrine, the fourth peak represents sophocarpine, the fifth peak represents sophoridine, the sixth peak represents oxysophocarpine, the seventh peak represents oxymatrine, the eighth peak represents 2,3-dihydroxy-2-[(4-hydroxyphenyl)methyl]butanedioic acid, and the tenth peak represents trifolirhizin.

From the results, it can be seen that the similarity between the 10 batches of samples and the control fingerprint is greater than 0.9, and the percentage of non-common peak areas is less than 5.0%.

2.3 Repeatability

(1) Experimental Steps

Preparation of blank solution: preparing methanol 0.2% potassium dihydrogen phosphate=15:85, and filtering.

Preparation of reference substance solution: preparing the reference substance solution by the method under Section 2.1.

Preparation of test substance solution: accurately measuring 1 ml of 6 batches of Compound Kushen Injection of the same batch number, adding to a 50 ml volumetric flask, adding blank solution to scale, shaking, filtering, and taking the subsequent filtrate as the test substance solution.

The injection sequence and requirements are shown in the table below.

Injection Sequence

| Sequence | Sample | Injection number |
|---|---|---|
| 1 | Blank solution | 1 injection |
| 2 | reference substance solution | 5 injections (continuous test) |
| 3 | Test substance-1 solution | 1 injection |
| 4 | Test substance-2 solution | 1 injection |
| 5 | Test substance-3 solution | 1 injection |
| 6 | Test substance-4 solution | 1 injection |
| 7 | Test substance-5 solution | 1 injection |
| 8 | Test substance-6 solution | 1 injection |
| 9 | reference substance solution | 1 injection |

(2) Result Report

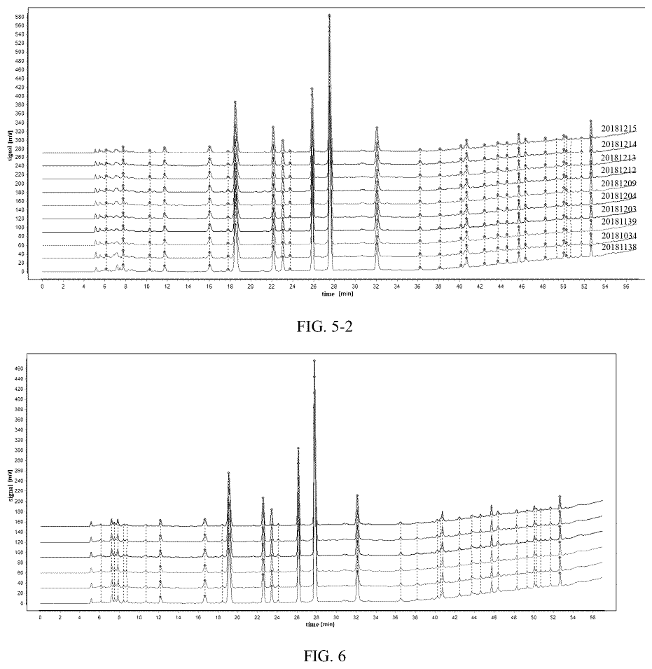

Based on the repetitive chromatogram and using the same processing method as the sample, the similarity was calculated using the “Similarity Evaluation System for Chromatographic Fingerprint of Traditional Chinese Medicine”. The relative retention time and relative peak area are calculated using peak 7 (oxymatrine) as a reference. (Refer to FIG. 6)

TABLE 2.3-1
Repetitive common peak pattern similarity results

| / | Similarity | | | | | |
|---|---|---|---|---|---|---|
| Test substance | 1 | 2 | 3 | 4 | 5 | 6 |
| 1 | 1.0 | 1.0 | 1.0 | 1.0 | 1.0 | 1.0 |
| 2 | 1.0 | 1.0 | 1.0 | 1.0 | 1.0 | 1.0 |
| 3 | 1.0 | 1.0 | 1.0 | 1.0 | 1.0 | 1.0 |
| 4 | 1.0 | 1.0 | 1.0 | 1.0 | 1.0 | 1.0 |
| 5 | 1.0 | 1.0 | 1.0 | 1.0 | 1.0 | 1.0 |
| 6 | 1.0 | 1.0 | 1.0 | 1.0 | 1.0 | 1.0 |
| R | 1.0 | 1.0 | 1.0 | 1.0 | 1.0 | 1.0 |

TABLE 2.3-2
Results of relative retention time of repetitive common peaks

| / | Common peaks | | | | | | | | | |
|---|---|---|---|---|---|---|---|---|---|---|
| Test substance | 1 | 2 | 3 | 4 | 5 | 6 | 7 | 8 | 9 | 10 |
| 1 | 0.442 | 0.603 | 0.694 | 0.816 | 0.846 | 0.942 | 1.0 | 1.149 | 1.639 | 1.888 |
| 2 | 0.442 | 0.603 | 0.693 | 0.816 | 0.845 | 0.941 | 1.0 | 1.149 | 1.639 | 1.888 |
| 3 | 0.442 | 0.603 | 0.693 | 0.816 | 0.845 | 0.941 | 1.0 | 1.149 | 1.639 | 1.888 |
| 4 | 0.442 | 0.604 | 0.694 | 0.816 | 0.845 | 0.942 | 1.0 | 1.149 | 1.638 | 1.887 |
| 5 | 0.442 | 0.603 | 0.693 | 0.816 | 0.845 | 0.941 | 1.0 | 1.150 | 1.639 | 1.888 |
| 6 | 0.442 | 0.604 | 0.693 | 0.816 | 0.845 | 0.941 | 1.0 | 1.150 | 1.639 | 1.888 |
| RSD % | 0.04 | 0.09 | 0.05 | 0.04 | 0.04 | 0.01 | 0.0 | 0.02 | 0.03 | 0.03 |

(3) Conclusion

From the results, it can be seen that, the similarity among the 6 test substances is greater than 0.99, and the RSD values of the relative retention time and relative peak area of each common peak are less than 3.0%, indicating good repeatability.

2.4 Intermediate Precision

(1) Experimental Steps

According to the repeatability measurement method, 6 test substance solutions were prepared in parallel on different dates, by different analysts, and using different apparatuses. The solution preparation and injection procedures are the same as the repeatability, and the precision of the determination results of 12 samples is evaluated.

(2) Result Report

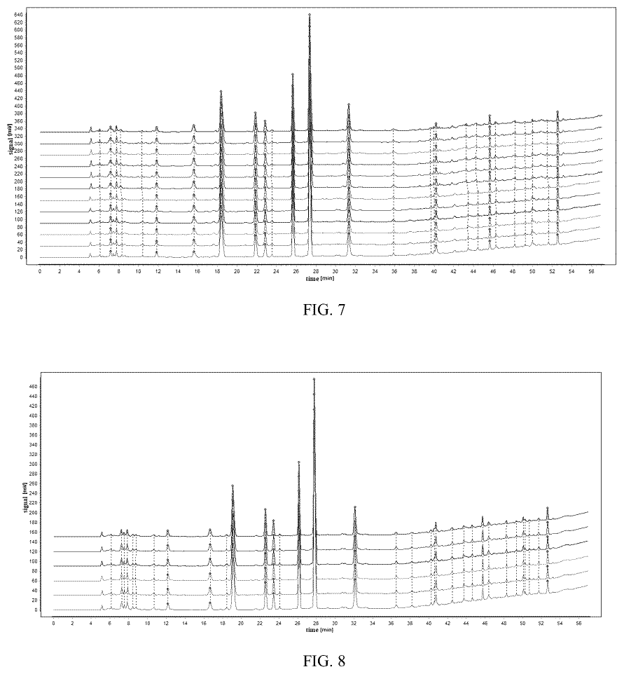

Based on the intermediate precision chromatogram, using the same processing method as the sample, the similarity is calculated using the “Evaluation System for Chromatographic Fingerprint Similarity of Traditional Chinese Medicine”, and the relative retention time and relative peak area were calculated using peak 7 (oxymatrine) as a reference. (Refer to FIG. 7)

TABLE 2.4-1
Similarity results of intermediate precision common peak patterns

| / | Similarity | | | | | | | | | | | |
|---|---|---|---|---|---|---|---|---|---|---|---|---|
| Test substance | 1-1 | 1-2 | 1-3 | 1-4 | 1-5 | 1-6 | 2-1 | 2-2 | 2-3 | 2-4 | 2-5 | 2-6 |
| 1-1 | 1.0 | 1.0 | 1.0 | 1.0 | 1.0 | 1.0 | 0.999 | 0.999 | 0.999 | 0.998 | 0.998 | 0.998 |
| 1-2 | 1.0 | 1.0 | 1.0 | 1.0 | 1.0 | 1.0 | 0.999 | 0.999 | 0.999 | 0.998 | 0.998 | 0.998 |
| 1-3 | 1.0 | 1.0 | 1.0 | 1.0 | 1.0 | 1.0 | 0.999 | 0.999 | 0.999 | 0.999 | 0.998 | 0.999 |
| 1-4 | 1.0 | 1.0 | 1.0 | 1.0 | 1.0 | 1.0 | 0.999 | 0.999 | 0.999 | 0.999 | 0.998 | 0.999 |
| 1-5 | 1.0 | 1.0 | 1.0 | 1.0 | 1.0 | 1.0 | 0.999 | 0.999 | 0.999 | 0.999 | 0.998 | 0.999 |
| 1-6 | 1.0 | 1.0 | 1.0 | 1.0 | 1.0 | 1.0 | 0.999 | 0.999 | 0.999 | 0.998 | 0.998 | 0.998 |
| 2-1 | 0.999 | 0.999 | 0.999 | 0.999 | 0.999 | 0.999 | 1.0 | 1.0 | 1.0 | 1.0 | 1.0 | 1.0 |
| 2-2 | 0.999 | 0.999 | 0.999 | 0.999 | 0.999 | 0.999 | 1.0 | 1.0 | 1.0 | 1.0 | 1.0 | 1.0 |
| 2-3 | 0.999 | 0.999 | 0.999 | 0.999 | 0.999 | 0.999 | 1.0 | 1.0 | 1.0 | 0.999 | 0.999 | 0.999 |
| 2-4 | 0.998 | 0.998 | 0.999 | 0.999 | 0.999 | 0.998 | 1.0 | 1.0 | 0.999 | 1.0 | 1.0 | 1.0 |
| 2-5 | 0.998 | 0.998 | 0.998 | 0.998 | 0.998 | 0.998 | 1.0 | 1.0 | 0.999 | 1.0 | 1.0 | 1.0 |
| 2-6 | 0.998 | 0.998 | 0.999 | 0.999 | 0.999 | 0.998 | 1.0 | 1.0 | 0.999 | 1.0 | 1.0 | 1.0 |
| R | 1.0 | 1.0 | 1.0 | 1.0 | 1.0 | 1.0 | 1.0 | 1.0 | 1.0 | 1.0 | 0.999 | 0.999 |

TABLE 2.4-2
Results of relative retention time for intermediate precision common peaks

| / | Common peaks | | | | | | | | | |
|---|---|---|---|---|---|---|---|---|---|---|
| Test substance | 1 | 2 | 3 | 4 | 5 | 6 | 7 | 8 | 9 | 10 |
| 1-1 | 0.438 | 0.599 | 0.687 | 0.813 | 0.843 | 0.941 | 1.0 | 1.155 | 1.646 | 1.895 |
| 1-2 | 0.437 | 0.597 | 0.686 | 0.812 | 0.843 | 0.941 | 1.0 | 1.156 | 1.645 | 1.895 |
| 1-3 | 0.437 | 0.597 | 0.686 | 0.812 | 0.843 | 0.941 | 1.0 | 1.156 | 1.646 | 1.896 |
| 1-4 | 0.437 | 0.596 | 0.685 | 0.812 | 0.842 | 0.941 | 1.0 | 1.156 | 1.647 | 1.896 |
| 1-5 | 0.437 | 0.597 | 0.685 | 0.811 | 0.842 | 0.941 | 1.0 | 1.156 | 1.647 | 1.896 |
| 1-6 | 0.438 | 0.600 | 0.687 | 0.813 | 0.843 | 0.941 | 1.0 | 1.156 | 1.645 | 1.894 |
| 2-1 | 0.427 | 0.544 | 0.659 | 0.787 | 0.829 | 0.935 | 1.0 | 1.134 | 1.689 | 1.944 |
| 2-2 | 0.427 | 0.542 | 0.658 | 0.786 | 0.828 | 0.935 | 1.0 | 1.133 | 1.691 | 1.946 |
| 2-3 | 0.427 | 0.542 | 0.657 | 0.786 | 0.828 | 0.935 | 1.0 | 1.133 | 1.691 | 1.946 |
| 2-4 | 0.427 | 0.543 | 0.657 | 0.786 | 0.828 | 0.935 | 1.0 | 1.134 | 1.691 | 1.947 |
| 2-5 | 0.427 | 0.544 | 0.658 | 0.787 | 0.828 | 0.935 | 1.0 | 1.135 | 1.690 | 1.945 |
| 2-6 | 0.427 | 0.545 | 0.658 | 0.787 | 0.829 | 0.935 | 1.0 | 1.136 | 1.689 | 1.944 |
| RSD % | 1.30 | 4.98 | 2.19 | 1.68 | 0.90 | 0.35 | 0.0 | 0.98 | 1.38 | 1.36 |

TABLE 2.4-3
Results of relative peak area of intermediate precision common peaks

| / | Common peaks | | | | | | | | | |
|---|---|---|---|---|---|---|---|---|---|---|
| Test substance | 1 | 2 | 3 | 4 | 5 | 6 | 7 | 8 | 9 | 10 |
| 1-1 | 0.040 | 0.068 | 0.459 | 0.179 | 0.095 | 0.419 | 1.0 | 0.228 | 0.048 | 0.057 |
| 1-2 | 0.040 | 0.068 | 0.459 | 0.178 | 0.095 | 0.419 | 1.0 | 0.228 | 0.048 | 0.058 |
| 1-3 | 0.040 | 0.068 | 0.459 | 0.179 | 0.095 | 0.419 | 1.0 | 0.228 | 0.048 | 0.058 |
| 1-4 | 0.040 | 0.068 | 0.460 | 0.178 | 0.095 | 0.419 | 1.0 | 0.228 | 0.048 | 0.058 |
| 1-5 | 0.040 | 0.068 | 0.459 | 0.178 | 0.095 | 0.420 | 1.0 | 0.228 | 0.048 | 0.058 |
| 1-6 | 0.039 | 0.067 | 0.455 | 0.177 | 0.094 | 0.416 | 1.0 | 0.226 | 0.048 | 0.057 |
| 2-1 | 0.037 | 0.075 | 0.476 | 0.192 | 0.096 | 0.429 | 1.0 | 0.240 | 0.048 | 0.054 |
| 2-2 | 0.038 | 0.076 | 0.475 | 0.191 | 0.096 | 0.428 | 1.0 | 0.240 | 0.048 | 0.054 |
| 2-3 | 0.038 | 0.076 | 0.476 | 0.192 | 0.096 | 0.429 | 1.0 | 0.240 | 0.048 | 0.054 |
| 2-4 | 0.038 | 0.076 | 0.477 | 0.192 | 0.096 | 0.429 | 1.0 | 0.241 | 0.048 | 0.054 |
| 2-5 | 0.037 | 0.075 | 0.480 | 0.192 | 0.096 | 0.430 | 1.0 | 0.242 | 0.048 | 0.055 |
| 2-6 | 0.036 | 0.075 | 0.481 | 0.193 | 0.097 | 0.430 | 1.0 | 0.241 | 0.047 | 0.055 |
| RSD % | 3.38 | 5.72 | 2.15 | 3.86 | 0.75 | 1.31 | 0.0 | 2.94 | 0.67 | 2.90 |

(3) Conclusion

From the results, it can be seen that, the similarity of the 12 test substances is greater than 0.99, and the relative retention time RSD values of individual common peaks are all less than 5%; and the relative peak area RSD value of macrozamin is 5.72, and the relative peak area RSD values of other common peaks are less than 5%. Therefore, the peak area of macrozamin is greatly affected.

2.5 Solution Stability and Double Time Spectra

(1) Experimental Steps

Preparation of blank solution: preparing methanol 0.2% potassium dihydrogen phosphate=15:85, and filtering, which is obtained.

Preparation of reference substance solution: preparing the reference substance solution by the method under Section 2.1.

Preparation of test substance solution: accurately measuring 1 ml of Compound Kushen Injection, adding to a 50 ml volumetric flask, adding blank solution to scale, shaking, filtering, and taking the subsequent filtrate as the test substance solution.

The injection sequence and requirements are shown in the table below.

Injection Sequence

| Sequence | Sample | Injection number |
|---|---|---|
| 1 | Blank solution | 1 injection |
| 2 | reference substance solution | 5 injections |
| | | (continuous test) |
| 3 | Test substance-0 h | 1 injection |
| 4 | Test substance-4 h | 1 injection |
| 5 | Test substance-8 h | 1 injection |
| 6 | Test substance-12 h | 1 injection |
| 7 | Test substance-18 h | 1 injection |
| 8 | Test substance-24 h | 1 injection |
| 9 | Test substance (double time) | 1 injection |
| 10 | reference substance solution | 1 injection |

(2) Result Report

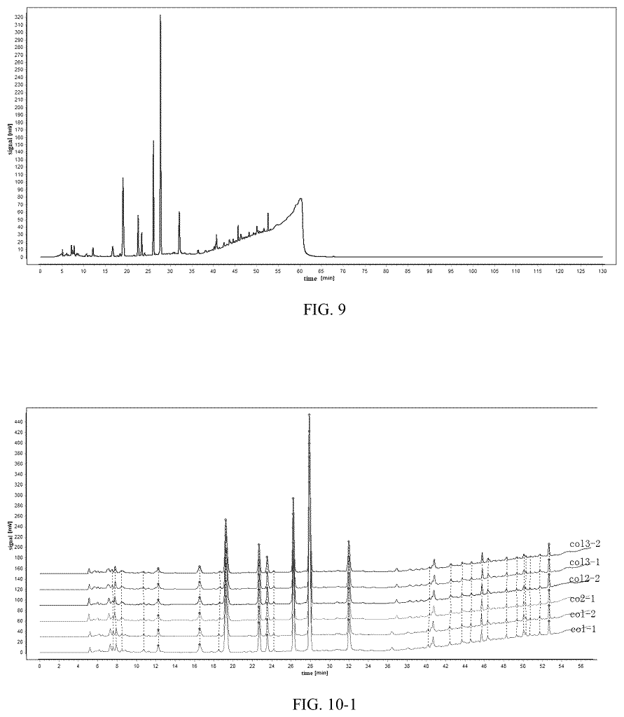

Based on the stability chromatogram and using the same processing method as the sample, the similarity is calculated using the “Similarity Evaluation System for Chromatographic Fingerprint of Traditional Chinese Medicine”. The relative retention time and relative peak area are calculated using peak 7 (oxymatrine) as a reference (see FIG. 8-9).

TABLE 2.5-1
Results of stable common peak pattern similarity

| / | Similarity | | | | | |
|---|---|---|---|---|---|---|
| Test substance | 0 h | 4 h | 8 h | 12 h | 16 h | 24 h |
| 0 h | 1.0 | 1.0 | 1.0 | 1.0 | 1.0 | 1.0 |
| 4 h | 1.0 | 1.0 | 1.0 | 1.0 | 1.0 | 1.0 |
| 8 h | 1.0 | 1.0 | 1.0 | 1.0 | 1.0 | 1.0 |
| 12 h | 1.0 | 1.0 | 1.0 | 1.0 | 1.0 | 1.0 |
| 16 h | 1.0 | 1.0 | 1.0 | 1.0 | 1.0 | 1.0 |
| 24 h | 1.0 | 1.0 | 1.0 | 1.0 | 1.0 | 1.0 |
| R | 1.0 | 1.0 | 1.0 | 1.0 | 1.0 | 1.0 |

TABLE 2.5-2
Results of stable common peak relative retention time

| / | Common peaks | | | | | | | | | |
|---|---|---|---|---|---|---|---|---|---|---|
| Test substance | 1 | 2 | 3 | 4 | 5 | 6 | 7 | 8 | 9 | 10 |
| 0 h | 0.438 | 0.599 | 0.687 | 0.813 | 0.843 | 0.941 | 1.0 | 1.155 | 1.646 | 1.895 |
| 4 h | 0.437 | 0.597 | 0.685 | 0.812 | 0.842 | 0.941 | 1.0 | 1.156 | 1.646 | 1.896 |
| 8 h | 0.439 | 0.601 | 0.688 | 0.813 | 0.843 | 0.941 | 1.0 | 1.156 | 1.645 | 1.894 |
| 12 h | 0.439 | 0.602 | 0.689 | 0.814 | 0.844 | 0.941 | 1.0 | 1.156 | 1.644 | 1.893 |
| 16 h | 0.439 | 0.602 | 0.689 | 0.814 | 0.844 | 0.941 | 1.0 | 1.156 | 1.645 | 1.894 |
| 24 h | 0.439 | 0.601 | 0.688 | 0.813 | 0.843 | 0.941 | 1.0 | 1.156 | 1.646 | 1.895 |
| RSD % | 0.18 | 0.35 | 0.20 | 0.11 | 0.07 | 0.01 | 0.0 | 0.03 | 0.05 | 0.05 |

TABLE 2.5-3
Results of stable common peak relative peak area

| / | Common peaks | | | | | | | | | |
|---|---|---|---|---|---|---|---|---|---|---|
| Test substance | 1 | 2 | 3 | 4 | 5 | 6 | 7 | 8 | 9 | 10 |
| 0 h | 0.040 | 0.068 | 0.459 | 0.179 | 0.095 | 0.419 | 1.0 | 0.228 | 0.048 | 0.057 |
| 4 h | 0.040 | 0.068 | 0.459 | 0.178 | 0.095 | 0.420 | 1.0 | 0.228 | 0.048 | 0.057 |
| 8 h | 0.040 | 0.068 | 0.459 | 0.178 | 0.095 | 0.420 | 1.0 | 0.228 | 0.048 | 0.058 |
| 12 h | 0.040 | 0.068 | 0.459 | 0.179 | 0.095 | 0.419 | 1.0 | 0.228 | 0.048 | 0.057 |
| 16 h | 0.040 | 0.068 | 0.459 | 0.179 | 0.095 | 0.420 | 1.0 | 0.228 | 0.048 | 0.057 |
| 24 h | 0.040 | 0.068 | 0.459 | 0.178 | 0.095 | 0.420 | 1.0 | 0.228 | 0.048 | 0.058 |
| RSD % | 0.14 | 0.19 | 0.03 | 0.06 | 0.11 | 0.03 | 0.0 | 0.04 | 0.21 | 0.44 |

(3) Conclusion

From the results, it can be seen that the similarity of the test substance is greater than 0.99 within 24 hours, and the relative retention time and peak area RSD values of individual common peaks are less than 3.0%. Therefore, the test substance is stable within 24 hours. There is no peak in the chromatogram again within double time, showing good results.

2.6 Durability

(1) Experimental Steps

Preparation of blank solution: preparing methanol 0.2% potassium dihydrogen phosphate=15:85, and filtering, which is obtained.

Preparation of reference substance solution: preparing the reference substance solution by the method under Section 2.1.

Preparation of test substance solution: accurately measuring 1 ml of Compound Kushen Injection, adding to a 50 ml volumetric flask, adding blank solution to scale, shaking, filtering, and taking the subsequent filtrate as the test substance solution; and preparing 2 copies using the same method.

10 μl of the above solutions are separately injected into HPLC under different conditions, and the injection sequence and requirements are shown in the table below (samples are injected according to this injection sequence under different investigation conditions).

Injection Sequence

| Sequence | Sample | Injection number |
|---|---|---|
| 1 | Blank solution | 1 injection |
| 2 | reference substance solution | 5 injections |
| 3 | Test substance-1 | 1 injection |
| 4 | Test substance-2 | 1 injection |

(3) Result Report

TABLE 2.6-1
Varied chromatographic condition parameters

| Chromatographic | | |
|---|---|---|
| condition | Specified value | Varying range |
| Chromatographic | Waters XSelect CSH ™ | Chromatographic column 2: Waters XSelect |
| column | C₁₈ (250 mm × 4.6 mm, | CSH ™ C₁₈ (250 mm × 4.6 mm, 5 μm), Sel |
| (3) | 5 μm), Sel | No. 01203827518752 |
| | No. 01203827518723 | Chromatographic column 3: Waters XSelect |
| | | CSH ™ C₁₈ (250 mm × 4.6 mm, 5 μm), Sel |
| | | No.01203827518726 |
| Apparatus (3) | Waters e2695 | Apparatus 2: Agilent 1260 |
| | | Apparatus 3: Thermo U3000 |

(2) Conclusion

Based on the durability chromatogram (different chromatographic columns and apparatuses), using the same processing method as the sample, the similarity is calculated using the “Similarity Evaluation System for Chromatographic Fingerprint of Traditional Chinese Medicine”, and the relative retention time and relative peak area are calculated using peak 7 (oxymatrine) as a reference.

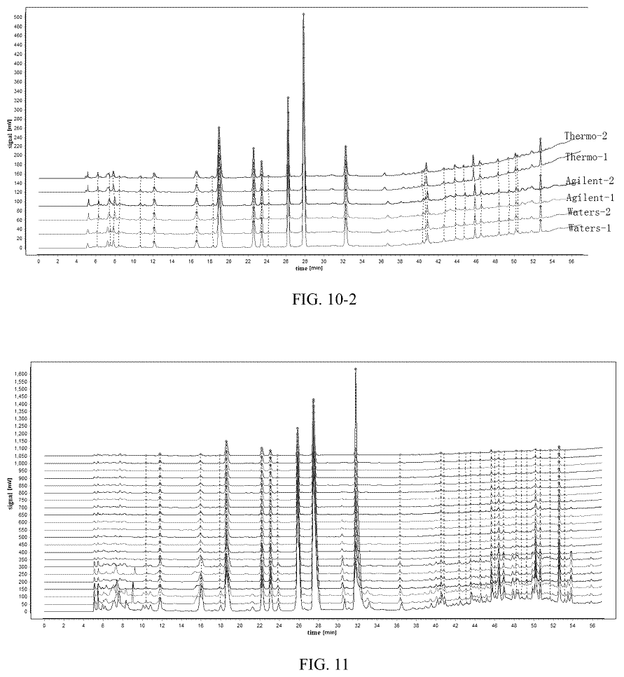

The durability results of different chromatographic columns are shown in FIG. 10-1 and the following table.

TABLE 2.6-2
Similarity results of common peak patterns in different
chromatographic columns

| / | Similarity | | | | | |
|---|---|---|---|---|---|---|
| Test substance | Col1 | | Col2 | | Col3 | |
| Col1 | 1.0 | 1.0 | 0.998 | 0.998 | 0.998 | 0.998 |
| | 1.0 | 1.0 | 0.998 | 0.998 | 0.998 | 0.998 |
| Col2 | 0.998 | 0.998 | 1.0 | 1.0 | 1.0 | 1.0 |
| | 0.998 | 0.998 | 1.0 | 1.0 | 1.0 | 1.0 |
| Col3 | 0.998 | 0.998 | 1.0 | 1.0 | 1.0 | 1.0 |
| | 0.998 | 0.998 | 1.0 | 1.0 | 1.0 | 1.0 |
| R | 0.999 | 0.999 | 1.0 | 1.0 | 1.0 | 1.0 |

TABLE 2.6-3
Results of Relative Retention Time of Common Peaks in Different
Chromatographic Columns

| / | | | | | | | | | | |
|---|---|---|---|---|---|---|---|---|---|---|
| Chromatographic | Common peaks | | | | | | | | | |
| column | 1 | 2 | 3 | 4 | 5 | 6 | 7 | 8 | 9 | 10 |
| Col1 | 0.442 | 0.603 | 0.694 | 0.816 | 0.846 | 0.942 | 1.0 | 1.149 | 1.639 | 1.888 |
| | 0.442 | 0.603 | 0.693 | 0.816 | 0.845 | 0.941 | 1.0 | 1.149 | 1.639 | 1.888 |
| Col2 | 0.444 | 0.597 | 0.696 | 0.817 | 0.846 | 0.941 | 1.0 | 1.144 | 1.634 | 1.883 |
| | 0.444 | 0.597 | 0.695 | 0.817 | 0.846 | 0.941 | 1.0 | 1.144 | 1.635 | 1.883 |
| Col3 | 0.439 | 0.586 | 0.689 | 0.813 | 0.843 | 0.940 | 1.0 | 1.141 | 1.638 | 1.886 |
| | 0.439 | 0.586 | 0.689 | 0.813 | 0.843 | 0.940 | 1.0 | 1.142 | 1.638 | 1.887 |
| RSD % | 0.55 | 1.31 | 0.41 | 0.23 | 0.15 | 0.06 | 0.0 | 0.31 | 0.13 | 0.11 |

TABLE 2.6-4
Results of relative peak areas of common peaks in different chromatographic
columns

| / | | | | | | | | | | |
|---|---|---|---|---|---|---|---|---|---|---|
| Chromatographic | Common peaks | | | | | | | | | |
| column | 1 | 2 | 3 | 4 | 5 | 6 | 7 | 8 | 9 | 10 |
| Col1 | 0.042 | 0.075 | 0.459 | 0.179 | 0.095 | 0.419 | 1.0 | 0.240 | 0.048 | 0.058 |
| | 0.042 | 0.076 | 0.460 | 0.178 | 0.095 | 0.419 | 1.0 | 0.240 | 0.048 | 0.058 |
| Col2 | 0.039 | 0.072 | 0.468 | 0.188 | 0.097 | 0.436 | 1.0 | 0.227 | 0.048 | 0.061 |
| | 0.038 | 0.072 | 0.468 | 0.188 | 0.097 | 0.436 | 1.0 | 0.227 | 0.048 | 0.059 |
| Col3 | 0.039 | 0.072 | 0.477 | 0.189 | 0.098 | 0.435 | 1.0 | 0.228 | 0.048 | 0.058 |
| | 0.039 | 0.071 | 0.477 | 0.189 | 0.098 | 0.430 | 1.0 | 0.226 | 0.048 | 0.058 |
| RSD % | 4.29 | 2.78 | 1.66 | 2.85 | 1.39 | 1.83 | 0.0 | 3.05 | 0.60 | 2.01 |

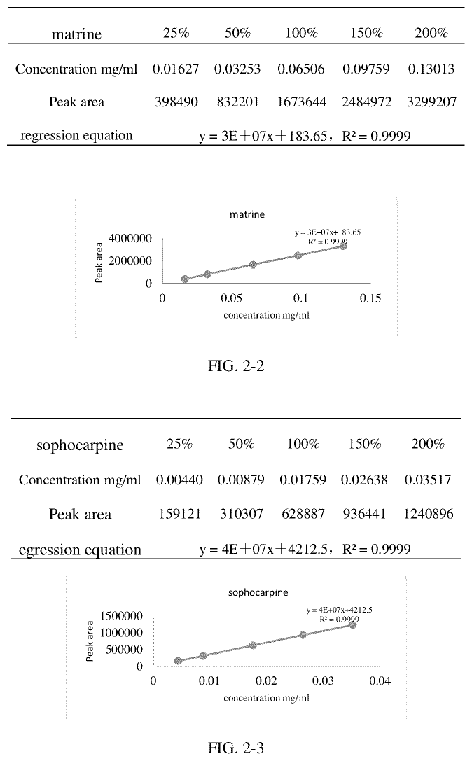

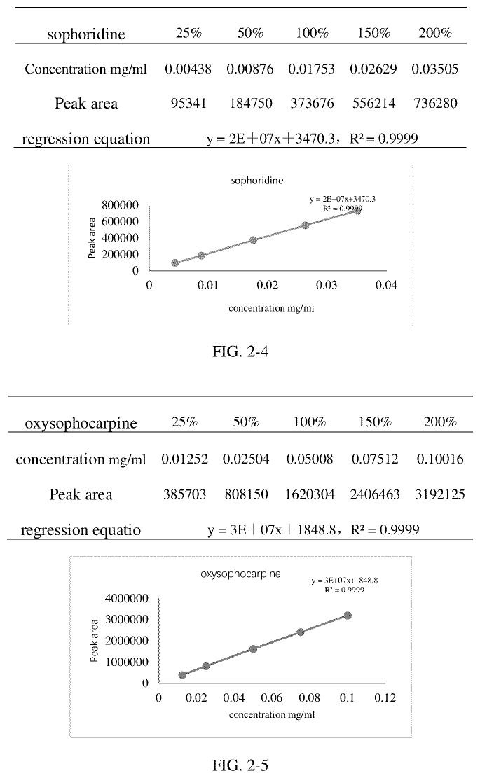

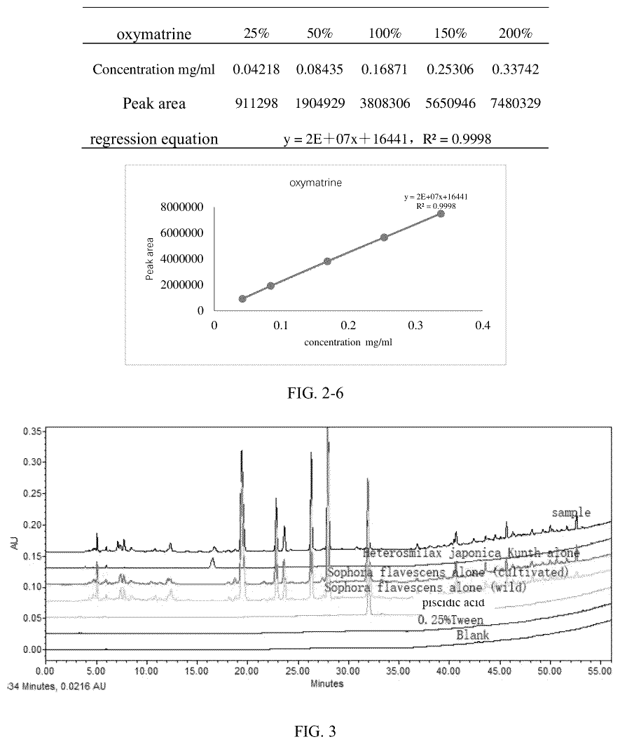

The durability results of different apparatuses are shown in FIG. 10-2 and the following table

TABLE 2.6-5
Similarity results of common peak patterns in different apparatuses

| / | Similarity | | | | | |
|---|---|---|---|---|---|---|
| Test substance | Waters | Waters | Agilent | Agilent | Thermo | Thermo |
| Waters | 1.0 | 1.0 | 0.998 | 0.998 | 0.999 | 0.999 |
| Waters | 1.0 | 1.0 | 0.998 | 0.998 | 0.999 | 0.999 |
| Agilent | 0.998 | 0.998 | 1.0 | 1.0 | 0.998 | 0.998 |
| Agilent | 0.998 | 0.998 | 1.0 | 1.0 | 0.998 | 0.998 |
| Thermo | 0.999 | 0.999 | 0.998 | 0.998 | 1.0 | 1.0 |
| Thermo | 0.999 | 0.999 | 0.998 | 0.998 | 1.0 | 1.0 |
| R | 1.0 | 1.0 | 1.0 | 0.999 | 0.999 | 0.999 |

TABLE 2.6-6
Results of common peak relative retention time in different apparatuses

| / | Common peaks | | | | | | | | | |
|---|---|---|---|---|---|---|---|---|---|---|
| Apparatus | 1 | 2 | 3 | 4 | 5 | 6 | 7 | 8 | 9 | 10 |
| Agilent | 0.426 | 0.571 | 0.661 | 0.803 | 0.836 | 0.941 | 1.0 | 1.155 | 1.645 | 1.895 |
| | 0.425 | 0.570 | 0.660 | 0.803 | 0.836 | 0.941 | 1.0 | 1.156 | 1.645 | 1.895 |
| Thermo | 0.447 | 0.620 | 0.696 | 0.819 | 0.847 | 0.943 | 1.0 | 1.166 | 1.642 | 1.893 |
| | 0.446 | 0.619 | 0.695 | 0.818 | 0.847 | 0.943 | 1.0 | 1.167 | 1.643 | 1.894 |
| Waters | 0.442 | 0.603 | 0.694 | 0.816 | 0.846 | 0.942 | 1.0 | 1.149 | 1.639 | 1.888 |
| | 0.442 | 0.603 | 0.694 | 0.816 | 0.845 | 0.941 | 1.0 | 1.149 | 1.639 | 1.888 |
| RSD % | 2.21 | 3.76 | 2.58 | 0.91 | 0.65 | 0.13 | 0.0 | 0.68 | 0.16 | 0.17 |

TABLE 2.6-7
Results of common peak relative peak area in different apparatuses

| / | Common peaks | | | | | | | | | |
|---|---|---|---|---|---|---|---|---|---|---|
| Apparatus | 1 | 2 | 3 | 4 | 5 | 6 | 7 | 8 | 9 | 10 |
| Agilent | 0.042 | 0.069 | 0.477 | 0.179 | 0.098 | 0.411 | 1.0 | 0.226 | 0.048 | 0.057 |
| | 0.042 | 0.069 | 0.478 | 0.179 | 0.098 | 0.411 | 1.0 | 0.226 | 0.048 | 0.057 |
| Thermo | 0.046 | 0.075 | 0.475 | 0.188 | 0.096 | 0.425 | 1.0 | 0.248 | 0.047 | 0.057 |
| | 0.046 | 0.075 | 0.476 | 0.188 | 0.096 | 0.425 | 1.0 | 0.248 | 0.047 | 0.057 |
| Waters | 0.042 | 0.075 | 0.459 | 0.179 | 0.095 | 0.419 | 1.0 | 0.240 | 0.048 | 0.058 |
| | 0.042 | 0.076 | 0.460 | 0.178 | 0.095 | 0.419 | 1.0 | 0.240 | 0.048 | 0.058 |
| RSD % | 4.99 | 4.46 | 1.88 | 2.70 | 1.18 | 1.51 | 0.0 | 4.17 | 1.76 | 0.76 |

(3) Conclusion

From the results, it can be seen that, in the results of different chromatographic columns, the similarity of individual common peak is greater than 0.99, and the RSD values of relative retention time and relative peak area are less than 5.0%; and, in the inspection results of different apparatus, the similarity of common peaks is greater than 0.99, and the RSD values of relative retention time and relative peak area are less than 5.0%. Therefore, this method has good durability.

2.9 Inspection of Key Production Process Points

(1) Experimental Steps

Preparation of blank solution: preparing methanol 0.2% potassium dihydrogen phosphate=15:85, and filtering.

Preparation of reference substance solution: preparing the reference substance solution by the method under Section 2.1.

Preparation of test substance solution: based on the volume of individual key points, the sampling amount is calculated. For key point 1, 1 ml is added to 25 ml volumetric flask; for key points 2 and 6, 5 ml is added to 50 ml volumetric flask; for key point 4, 2 ml is added to 25 ml volumetric flask; for key point 5, 1 ml is added to 100 ml volumetric flask; and for other key points, 1 ml is added to 50 ml volumetric flasks. All samples are added with blank solution to scale, shaken, and filtered to obtain a filtrate as the test substance solution.

The injection sequence and requirements are shown in the table below.

Injection Sequence

| Sequence | Sample | Injection number |
|---|---|---|
| 1 | Blank solution | 1 injection |
| 2 | Reference substance solution | 5 injections (continuous test) |
| 3 | Test substance-1 | 1 injection |
| 4 | Test substance-2 | 1 injection |
| 5 | Test substance-3 | 1 injection |
| 6 | Test substance-4 | 1 injection |
| 7 | Test substance-5 | 1 injection |
| 8 | Test substance-6 | 1 injection |
| 9 | Test substance-7 | 1 injection |
| 10 | Test substance-8 | 1 injection |
| 11 | Test substance-9 | 1 injection |
| 12 | Test substance-10 | 1 injection |
| 13 | Test substance-11 | 1 injection |
| 14 | Test substance-12 | 1 injection |
| 15 | Test substance-13 | 1 injection |
| 16 | Test substance-14 | 1 injection |
| 17 | Test substance-15 | 1 injection |
| 18 | Test substance-16 | 1 injection |
| 19 | Test substance-17 | 1 injection |
| 20 | Test substance-18 | 1 injection |
| 21 | Test substance-19 | 1 injection |
| 22 | Test substance-20 | 1 injection |
| 23 | Test substance-21 | 1 injection |
| 24 | Test substance-22 | 1 injection |
| 25 | Reference substance solution | 1 injection |

(2) Result Report

(Refer to FIG. 11 and the table below)

TABLE 2.9-1
Similarity results of common peak patterns in production processes

| / | | | | | | | | | | | |
|---|---|---|---|---|---|---|---|---|---|---|---|
| Test | Similarity | | | | | | | | | | |
| substanc | 1 | 2 | 3 | 4 | 5 | 6 | 7 | 8 | 9 | 10 | 11 |
| 1 | 1.0 | 0.973 | 0.958 | 0.817 | 0.820 | 0.786 | 0.800 | 0.799 | 0.799 | 0.799 | 0.799 |
| 2 | 0.973 | 1.0 | 0.993 | 0.923 | 0.921 | 0.901 | 0.906 | 0.906 | 0.906 | 0.906 | 0.906 |
| 3 | 0.958 | 0.993 | 1.0 | 0.945 | 0.948 | 0.927 | 0.936 | 0.936 | 0.936 | 0.935 | 0.935 |
| 4 | 0.817 | 0.923 | 0.945 | 1.0 | 0.997 | 0.998 | 0.996 | 0.996 | 0.996 | 0.996 | 0.996 |
| 5 | 0.820 | 0.921 | 0.948 | 0.997 | 1.000 | 0.996 | 0.998 | 0.998 | 0.998 | 0.998 | 0.998 |
| 6 | 0.786 | 0.901 | 0.927 | 0.998 | 0.996 | 1.0 | 0.996 | 0.997 | 0.996 | 0.996 | 0.996 |
| 7 | 0.800 | 0.906 | 0.936 | 0.996 | 0.998 | 0.996 | 1.0 | 1.0 | 0.999 | 1.0 | 1.0 |
| 8 | 0.799 | 0.906 | 0.936 | 0.996 | 0.998 | 0.997 | 1.0 | 1.0 | 1.0 | 1.0 | 1.0 |
| 9 | 0.799 | 0.906 | 0.936 | 0.996 | 0.998 | 0.996 | 0.999 | 1.0 | 1.0 | 1.0 | 1.0 |
| 10 | 0.799 | 0.906 | 0.935 | 0.996 | 0.998 | 0.996 | 1.0 | 1.0 | 1.0 | 1.0 | 1.0 |
| 11 | 0.799 | 0.906 | 0.935 | 0.996 | 0.998 | 0.996 | 1.0 | 1.0 | 1.0 | 1.0 | 1.0 |
| 12 | 0.800 | 0.905 | 0.936 | 0.995 | 0.998 | 0.996 | 0.999 | 0.999 | 0.999 | 0.999 | 0.999 |
| 13 | 0.798 | 0.904 | 0.935 | 0.995 | 0.997 | 0.995 | 0.999 | 0.999 | 0.999 | 0.999 | 0.999 |
| 14 | 0.799 | 0.905 | 0.935 | 0.994 | 0.997 | 0.995 | 0.998 | 0.999 | 0.999 | 0.999 | 0.999 |
| 15 | 0.799 | 0.905 | 0.935 | 0.995 | 0.998 | 0.996 | 0.999 | 1.0 | 0.999 | 1.0 | 1.0 |
| 16 | 0.799 | 0.904 | 0.934 | 0.992 | 0.996 | 0.993 | 0.998 | 0.998 | 0.998 | 0.998 | 0.998 |
| 17 | 0.799 | 0.903 | 0.934 | 0.991 | 0.994 | 0.991 | 0.997 | 0.997 | 0.997 | 0.997 | 0.997 |
| 18 | 0.797 | 0.901 | 0.932 | 0.990 | 0.993 | 0.991 | 0.996 | 0.996 | 0.996 | 0.996 | 0.996 |
| 19 | 0.800 | 0.903 | 0.934 | 0.990 | 0.993 | 0.991 | 0.996 | 0.996 | 0.997 | 0.997 | 0.997 |
| 20 | 0.797 | 0.901 | 0.932 | 0.990 | 0.993 | 0.991 | 0.996 | 0.996 | 0.996 | 0.996 | 0.996 |
| 21 | 0.797 | 0.901 | 0.932 | 0.990 | 0.993 | 0.991 | 0.996 | 0.996 | 0.996 | 0.996 | 0.996 |
| 22 | 0.792 | 0.893 | 0.924 | 0.980 | 0.983 | 0.981 | 0.988 | 0.988 | 0.988 | 0.988 | 0.988 |
| R | 0.903 | 0.971 | 0.987 | 0.984 | 0.986 | 0.974 | 0.980 | 0.980 | 0.980 | 0.980 | 0.980 |
| / | | | | | | | | | | | |
| Test | Similarity | | | | | | | | | | |
| substanc | 12 | 13 | 14 | 15 | 16 | 17 | 18 | 19 | 20 | 21 | 22 |
| 1 | 0.800 | 0.798 | 0.799 | 0.799 | 0.799 | 0.799 | 0.797 | 0.800 | 0.797 | 0.797 | 0.792 |
| 2 | 0.905 | 0.904 | 0.905 | 0.905 | 0.904 | 0.903 | 0.901 | 0.903 | 0.901 | 0.901 | 0.893 |
| 3 | 0.936 | 0.935 | 0.935 | 0.935 | 0.934 | 0.934 | 0.932 | 0.934 | 0.932 | 0.932 | 0.924 |
| 4 | 0.995 | 0.995 | 0.994 | 0.995 | 0.992 | 0.991 | 0.990 | 0.990 | 0.990 | 0.990 | 0.980 |
| 5 | 0.998 | 0.997 | 0.997 | 0.998 | 0.996 | 0.994 | 0.993 | 0.993 | 0.993 | 0.993 | 0.983 |
| 6 | 0.996 | 0.995 | 0.995 | 0.996 | 0.993 | 0.991 | 0.991 | 0.991 | 0.991 | 0.991 | 0.981 |
| 7 | 0.999 | 0.999 | 0.998 | 0.999 | 0.998 | 0.997 | 0.996 | 0.996 | 0.996 | 0.996 | 0.988 |
| 8 | 0.999 | 0.999 | 0.999 | 1.0 | 0.998 | 0.997 | 0.996 | 0.996 | 0.996 | 0.996 | 0.988 |
| 9 | 0.999 | 0.999 | 0.999 | 0.999 | 0.998 | 0.997 | 0.996 | 0.997 | 0.996 | 0.996 | 0.988 |
| 10 | 0.999 | 0.999 | 0.999 | 1.0 | 0.998 | 0.997 | 0.996 | 0.997 | 0.996 | 0.996 | 0.988 |
| 11 | 0.999 | 0.999 | 0.999 | 1.0 | 0.998 | 0.997 | 0.996 | 0.997 | 0.996 | 0.996 | 0.988 |
| 12 | 1.0 | 1.0 | 1.0 | 1.0 | 0.999 | 0.998 | 0.998 | 0.998 | 0.998 | 0.998 | 0.991 |
| 13 | 1.0 | 1.0 | 0.998 | 0.999 | 0.999 | 0.997 | 0.996 | 0.997 | 0.996 | 0.996 | 0.989 |
| 14 | 1.0 | 0.998 | 1.0 | 0.999 | 0.999 | 0.999 | 0.999 | 0.999 | 0.999 | 0.999 | 0.992 |
| 15 | 1.0 | 0.999 | 0.999 | 1.0 | 0.999 | 0.998 | 0.997 | 0.998 | 0.997 | 0.997 | 0.990 |
| 16 | 0.999 | 0.999 | 0.999 | 0.999 | 1.0 | 0.999 | 0.999 | 0.999 | 0.999 | 0.999 | 0.994 |
| 17 | 0.998 | 0.997 | 0.999 | 0.998 | 0.999 | 1.0 | 1.0 | 1.0 | 1.0 | 1.0 | 0.996 |
| 18 | 0.998 | 0.996 | 0.999 | 0.997 | 0.999 | 1.0 | 1.0 | 1.0 | 1.0 | 1.0 | 0.996 |
| 19 | 0.998 | 0.997 | 0.999 | 0.998 | 0.999 | 1.0 | 1.0 | 1.0 | 1.0 | 1.0 | 0.996 |
| 20 | 0.998 | 0.996 | 0.999 | 0.997 | 0.999 | 1.0 | 1.0 | 1.0 | 1.0 | 1.0 | 0.997 |
| 21 | 0.998 | 0.996 | 0.999 | 0.997 | 0.999 | 1.0 | 1.0 | 1.0 | 1.0 | 1.0 | 0.997 |
| 22 | 0.991 | 0.989 | 0.992 | 0.990 | 0.994 | 0.996 | 0.996 | 0.996 | 0.997 | 0.997 | 1.0 |
| R | 0.980 | 0.979 | 0.979 | 0.980 | 0.979 | 0.978 | 0.977 | 0.978 | 0.977 | 0.977 | 0.970 |

(3) Conclusion

From the results, it can be seen that, the similarity between the key points of the production process is greater than 0.9, in which the similarity between the key points 8-22 (water precipitation solution sample after sterilization) is greater than 0.98, indicating a high similarity among the key points. However, from the figure, some components show slight losses.

### Example 4 Selection of Detection Methods

1. Investigation of Different Chromatographic Columns

Experimental Steps:

(1) Chromatographic conditions: mobile phase 0.2% potassium dihydrogen phosphate solution (adjusted to pH 3.0 with phosphoric acid) (A)-methanol (B) gradient elution, 0-10 min, 3% B; 10-15 min, 3%-5% B; 15-24 min 5%-15% B; 24-30 min, 15% B; 30-55 min, 15%-85% B; 55-75 min, 3%₀B. The column temperature is 30° C., the flow rate is 0.6 ml/min, and the wavelength is 211 nm.

(2) Preparation of test substance: accurately measuring 1 ml of Compound Kushen Injection, adding to a 50 ml volumetric flask, adding blank solution (0.2% potassium dihydrogen phosphate solution methanol=85:15) to scale, shaking, filtering, taking the subsequent filtrate as the test substance solution, injecting the sample according to the above chromatographic conditions and observing.

The chromatographic columns inspected are as follows:

(1) Waters XSelect CSH™ C₁₈

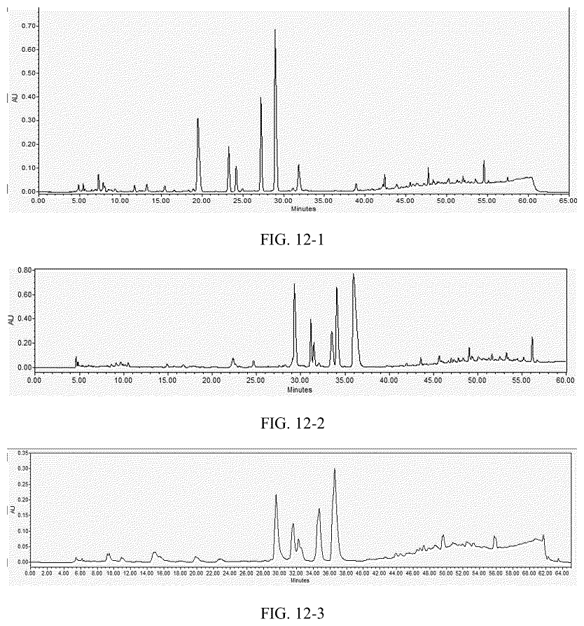

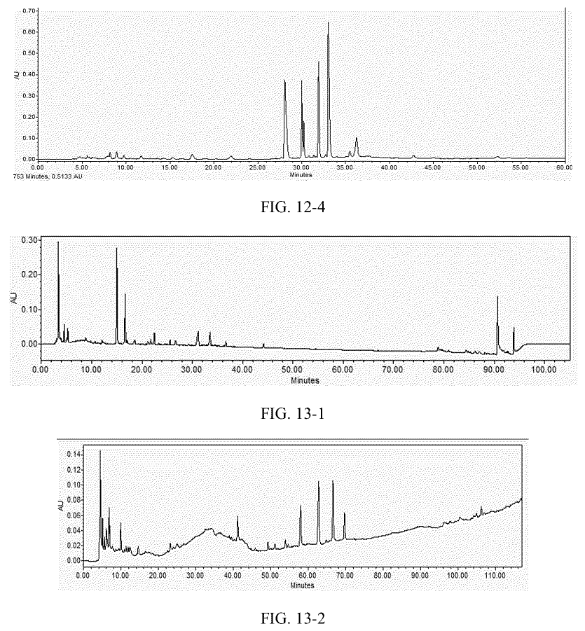

The experimental results are shown in FIG. 12-1

(2) TechMate C₁₈-ST

The experimental results are shown in FIG. 12-2

(3) Welch Ultimate AQ-C₁₈

The experimental results are shown in FIG. 12-3

(4) Waters SunFire C₁₈

The experimental results are shown in FIG. 12-4

In summary, the optimal chromatographic column is Waters XSelect CSH™ C₁₈ (4.6 mm×250 mm, 5 μm).

2. Investigation of Different Mobile Phase Systems

Experimental Steps:

Preparation of test substance: accurately measuring 1 ml of Compound Kushen Injection, adding to a 50 ml volumetric flask, adding blank solution (0.2% potassium dihydrogen phosphate solution methanol=85:15) to scale, shaking, filtering, and taking the subsequent filtrate as the test substance solution, injecting the sample according to the above chromatographic conditions and observing.

2.1 Adjusting of the Mobile Phase Gradient According to the Fingerprint Conditions in the Drug Standard of Compound Kushen Injection

Chromatographic conditions: column: Waters XSelect CSH™ C₁₈ (4.6 mm×250 mm, 5 μm)

Detection wavelength: 225 nm injection volume: 10 μl Column temperature: 30° C. flow rate: 0.8 ml/min

Mobile phase: acetonitrile: 0.01M ammonium acetate (9:1), 0.01M ammonium acetate (adjusted to pH 8.0) gradient elution

This method is based on the inspection made after adjusting the gradient based on the fingerprint conditions in the injection drug standard

| | Acetonitrile: 0.01M | 0.01M |
|---|---|---|
| Time/min | ammonium acetate | ammonium acetate |
| 0-80 | 5-60 | 95-40 |
| 80-90 | 60-90 | 40-10 |
| 90-105 | 5 | 95 |

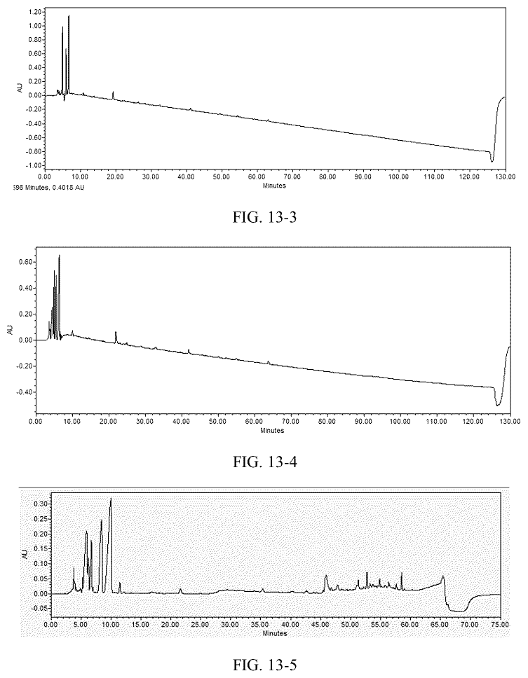

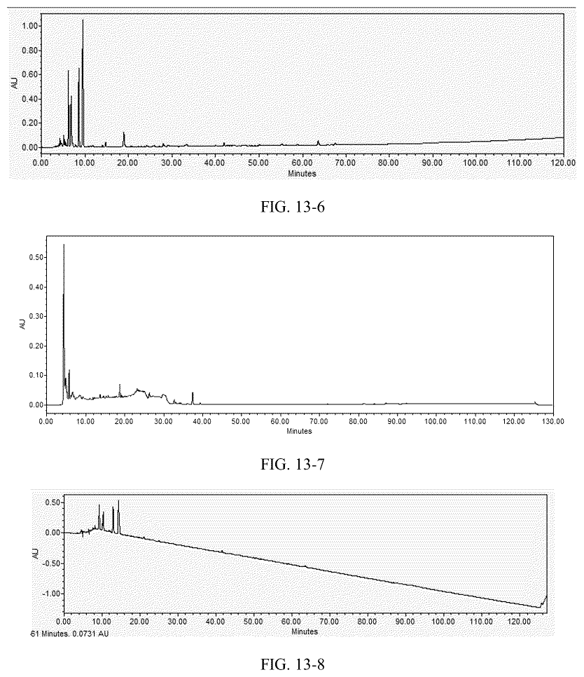

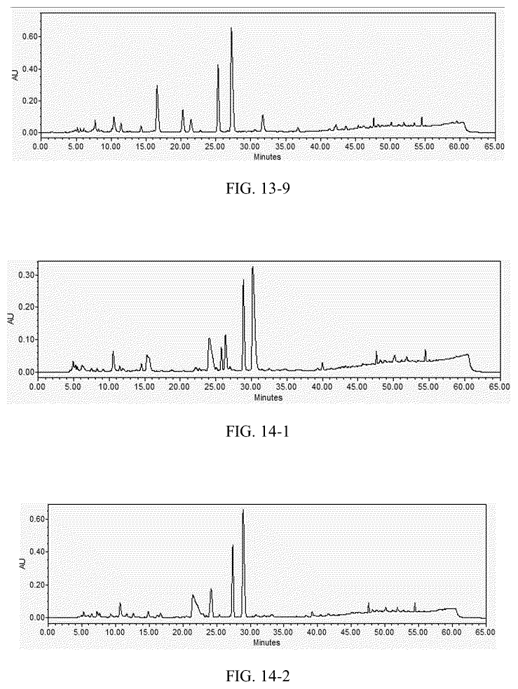

The experimental results are shown in FIG. 13-1

2.2 Other Methods

Chromatographic column: Waters XSelect CSH™ C₁₈ (4.6 mm×250 mm, 5 μm)

Detection wavelength: 211 nm, column temperature: 30° C., flow rate: 0.6 ml/min, injection amount: 10 μl

The mobile phase systems inspected are as follow:

(1) Methanol-water: 10% methanol water to 90% methanol water, gradient elution for 120 minutes

The experimental results are shown in FIG. 13-2

(2) Methanol-0.1% formic acid water: 10% methanol 90% (0.1% formic acid water) to 90% methanol 10% (0.1% formic acid water), gradient elution for 120 minutes

The experimental results are shown in FIG. 13-3

(3) Methanol-0.1% acetic acid water: 10% methanol 90% (0.1% acetic acid water) to 90% methanol 10% (0.1% acetic acid water), gradient elution for 120 minutes

The experimental results are shown in FIGS. 13-4

(4) Methanol-0.01% acetic acid water: 10% methanol 90% (0.01% acetic acid water) to 90% methanol 10% (0.01% acetic acid water), gradient elution for 120 minutes

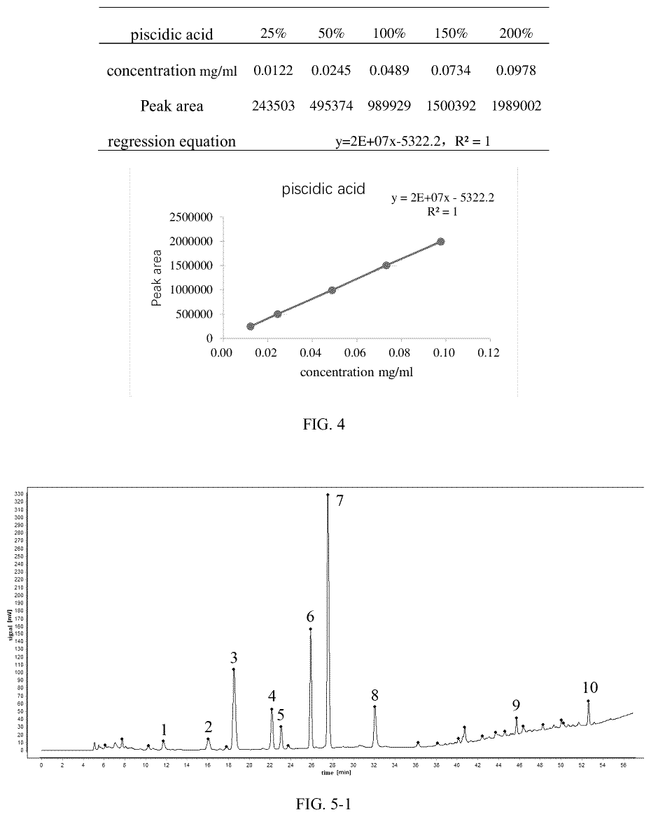

The experimental results are shown in FIGS. 13-5

(5) Methanol 0.4% phosphoric acid: 10% methanol 90% (0.1% phosphoric acid) to 90% methanol 10% (0.1% phosphoric acid), gradient elution for 120 minutes

The experimental results are shown in FIGS. 13-6

(6) Acetonitrile-water: 10% acetonitrile water to 90% acetonitrile water, gradient elution for 120 minutes

The experimental results are shown in FIGS. 13-7

(7) Methanol-0.01M ammonium acetate: 10% methanol 90% (0.01M ammonium acetate, adjusted to pH 4.0) to 90% methanol 10% (0.01M ammonium acetate, adjusted to pH 4.0), gradient elution for 120 minutes

The experimental results are shown in FIGS. 13-8

(8) Methanol-0.2% potassium dihydrogen phosphate (adjusted to pH 3.0 with phosphoric acid): this is the final chromatographic condition determined in this patent application, with gradient elution of 3% methanol 97% (0.2% potassium dihydrogen phosphate).

The experimental results are shown in FIGS. 13-9

In summary, the optimal conditions include methanol 0.2% potassium dihydrogen phosphate, adjusting the pH value of phosphoric acid to 3, and gradient elution.

3. Investigation of Different pH Values

Experimental Steps:

Preparation of test substance: accurately measuring 1 ml of Compound Kushen Injection, adding to a 50 ml volumetric flask, adding a blank solution (0.2% potassium dihydrogen phosphate solution methanol=85:15) to scale, shaking, filtering, taking the subsequent filtrate as the test substance solution, injecting the sample according to the above chromatographic conditions and observing.

3.1 Chromatographic Conditions:

Chromatographic column: Waters XSelect CSH™ C₁₈ (4.6 mm×250 mm, 5 μm)

Detection wavelength: 211 nm, column temperature: 30° C., flow rate: 0.6 ml/min, injection amount: 10 μl

The pH values of potassium dihydrogen phosphate inspected are as follow:

(1) Methanol-0.1% potassium dihydrogen phosphate (adjusted to pH 5.0 with phosphoric acid)

The experimental results are shown in FIG. 14-1

(2) Methanol-0.1% potassium dihydrogen phosphate (adjusted to pH 4.0 with phosphoric acid)

The experimental results are shown in FIG. 14-2

(3) Methanol-0.1% potassium dihydrogen phosphate (adjusted to pH 3.0 with phosphoric acid).

The experimental results are shown in FIG. 14-3

3.2 Experimental Results

Refer to FIGS. 14-1-3.

In summary, adjusting the pH value of potassium dihydrogen phosphate to 3 with phosphoric acid is the optimal condition.

4. Investigation of Potassium Dihydrogen Phosphate Concentration

Experimental Steps:

Preparation of test substance: accurately measuring 1 ml of Compound Kushen Injection, adding to a 50 ml volumetric flask, adding a blank solution (0.2% potassium dihydrogen phosphate solution methanol=85:15) to scale, shaking, filtering, taking the subsequent filtrate as the test substance solution, injecting the sample according to the above chromatographic conditions and observing.

Chromatographic Conditions:

Chromatographic column: Waters XSelect CSH™ C₁₈ (4.6 mm×250 mm, 5 μm)

Detection wavelength: 211 nm, column temperature: 30° C., flow rate: 0.6 ml/min, injection amount: 10 μl

The concentrations of potassium dihydrogen phosphate are investigated respectively, and as follows:

(1) Methanol-0.1% potassium dihydrogen phosphate (adjusted to pH 3.0 with phosphoric acid)

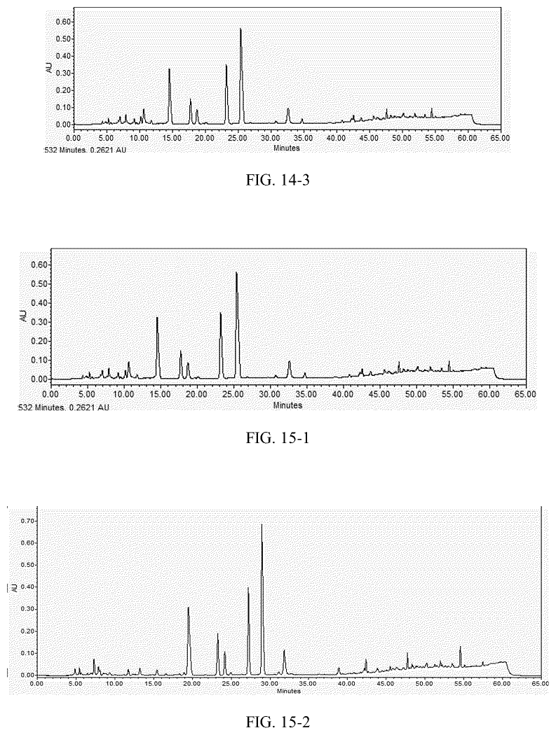

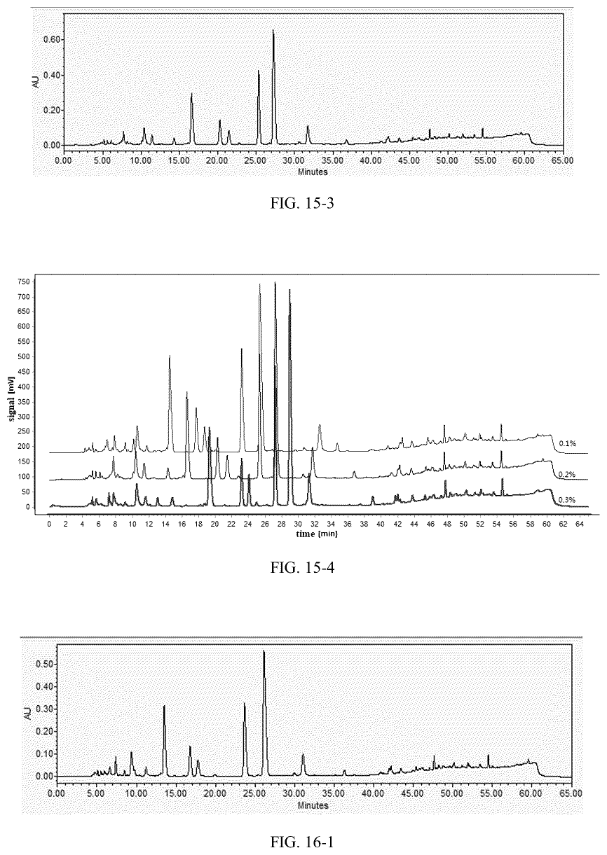

The experimental results are shown in FIG. 15-1

(2) Methanol-0.34% potassium dihydrogen phosphate (adjusted to pH 3.0 with phosphoric acid)

The experimental results are shown in FIG. 15-2

(3) Methanol-0.2% potassium dihydrogen phosphate (adjusted to pH 3.0 with phosphoric acid)

The experimental results are shown in FIG. 15-3

The superposition diagram of different concentrations of potassium dihydrogen phosphate is shown in FIG. 15-4.

In summary, 0.2% potassium dihydrogen phosphate as the mobile phase is the optimal condition.

5. Gradient Optimization

Experimental Steps:

Preparation of test substance: accurately measuring 1 ml of Compound Kushen Injection, adding to a 50 ml volumetric flask, adding a blank solution (0.2% potassium dihydrogen phosphate solution methanol=85:15) to scale, shaking, filtering, taking the subsequent filtrate as the test substance solution, injecting the sample according to the above chromatographic conditions and observing.

Chromatographic column: Waters XSelect CSH™ C₁₈ (4.6 mm×250 mm, 5 μm); mobile phase 0.2% potassium dihydrogen phosphate solution (adjusted to pH 3.0 with phosphoric acid)-methanol (B) gradient adjustment; detection wavelength: 211 nm, column temperature: 30° C., flow rate: 0.6 ml/min, injection amount: 10 μl.

Experimental Methods

The elution gradients investigated are as follow:

Method 1:

Elution Conditions

| | | 0.2% potassium |
|---|---|---|
| | | dihydrogen |
| Time | Methanol (%) | phosphate (%) |
| 0-10 | 5 | 97-95 |
| 10-25 | 5-15 | 95-85 |
| 25-32 | 15 | 85 |
| 32-55 | 15-80 | 85-20 |
| 55-65 | 3 | 97 |

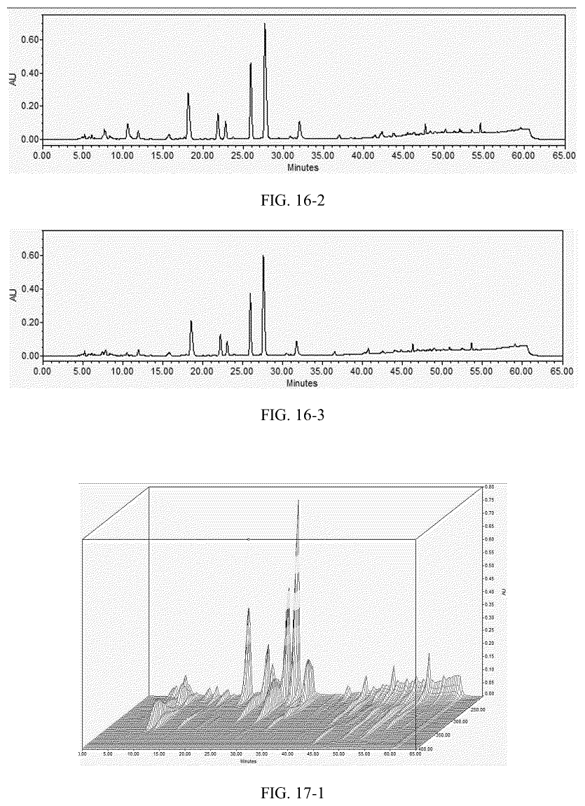

The experimental results are shown in FIG. 16-1

Method 2:

Elution Conditions

| | | 0.2% potassium |
|---|---|---|
| | | dihydrogen |
| Time | Methanol (%) | phosphate (%) |
| 0-8 | 3 | 97-95 |
| 8-15 | 3-5 | 97-95 |
| 15-25 | 5-15 | 95-98 |
| 25-32 | 5 | 85 |
| 32-35 | 15-80 | 85-20 |
| 55-65 | 3 | 97 |

The experimental results are shown in FIG. 16-2

Method 3:

Elution Conditions

| | | 0.2% potassium |
|---|---|---|
| | | dihydrogen |
| Time | Methanol (%) | phosphate (%) |
| 0-10 | 3 | 97 |
| 10-15 | 3-5 | 97-95 |
| 15-24 | 5-15 | 95-85 |
| 24-30 | 15 | 85 |
| 30-55 | 15-85 | 85-15 |
| 55-75 | 3 | 97 |

The experimental results are shown in FIG. 16-3

In summary, the peak resolution in Method 3 (FIG. 16-3) is the highest, therefore the elution program conditions of Method 3 is optimal.

6. Confirmation of Detection Wavelength

Experimental Steps:

Preparation of test substance: accurately measuring 1 ml of Compound Kushen Injection, adding to a 50 ml volumetric flask, adding blank solution (0.2% potassium dihydrogen phosphate solution methanol=85:15) to scale, shaking, filtering, taking the subsequent filtrate as the test substance solution, injecting the sample according to the above chromatographic conditions and observing.

Chromatographic column: Waters XSelect CSH™ C18 (4.6 mm×250 mm, 5 μm); Mobile phase 0.2% potassium dihydrogen phosphate solution (adjusted to pH 3.0 with phosphoric acid) (A)-methanol (B) gradient elution; full wavelength scanning, column temperature: 30° C., flow rate: 0.6 ml/min, injection volume: 10 μl.

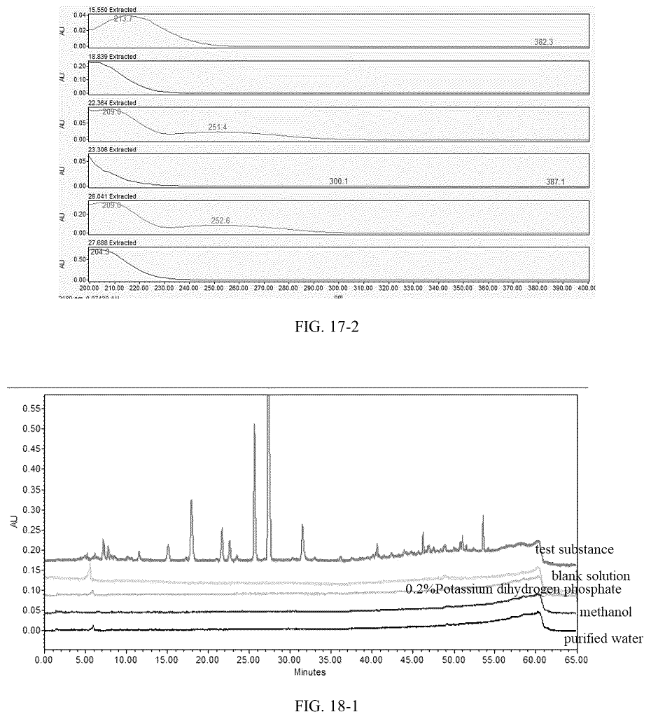

The experimental results are shown in FIGS. 17-1-17-2

In summary, from the wavelength scanning results, it can be seen that under this condition, the Compound Kushen Injection has terminal absorption. Based on various absorption peaks and references, 211 nm was selected as the detection wavelength for the Compound Kushen Injection.

7. Determination of Chromatographic Conditions

(1) Chromatographic Conditions

Chromatographic column: Waters XSelect CSH™ C₁₈ (5 μm, 4.6 mm×250 mm)

Mobile phase: 0.2% potassium dihydrogen phosphate solution (adjusted to pH 3.0 with phosphoric acid)-methanol gradient elution

Column temperature: 30° C.

Flow rate: 0.6 ml/min

Detection wavelength: 211 nm

Injection volume: 10 μl

Gradient elution table

| | | 0.2% potassium |
|---|---|---|
| | | dihydrogen |
| Time | Methanol (%) | phosphate (%) |
| 0-10 | 3 | 97 |
| 10-15 | 3-5 | 97-95 |
| 15-24 | 5-15 | 95-85 |
| 24-30 | 15 | 85 |
| 30-55 | 15-85 | 85-15 |
| 55-75 | 3 | 97 |

(2) Determination Method

According to the determined chromatographic conditions, 10 μl of the reference substance solution and the test substance solution is separately injected into a liquid chromatograph and record the chromatogram.

8. Optimization and Confirmation of the Preparation Method for the Test Substance Solution

Experimental method: same as in step 7 of Example 4, respectively investigating:

(1) Test substance (prepared from water) and blank solution

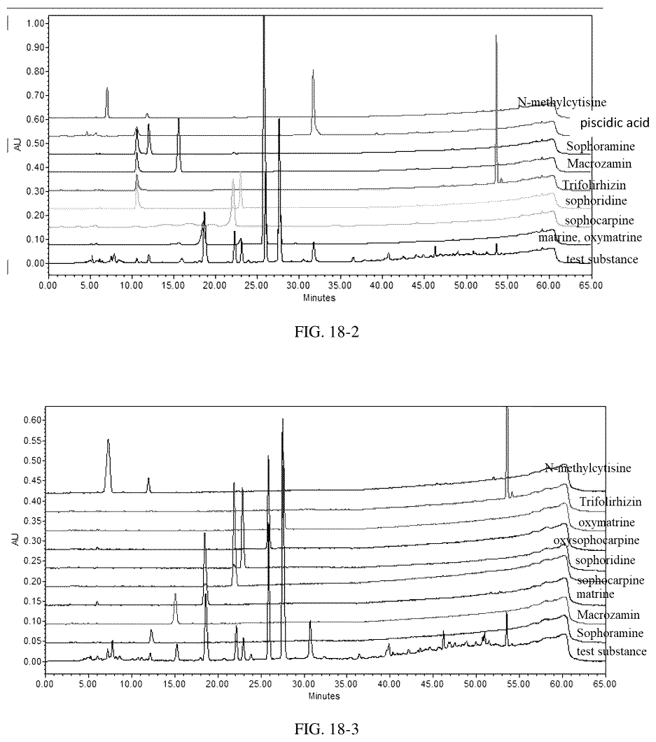

The experimental results are shown in FIG. 18-1

(2) Preparation of reference substance with methanol and test substance with purified water

The experimental results are shown in FIG. 18-2

(3) Preparation of blank solution for test and control samples (blank solution: 0.2% potassium dihydrogen phosphate solution methanol mixed solution)

The experimental results are shown in FIG. 18-3

In summary, compared to methanol preparation, the blank solution was used to prepare the reference substance, with symmetrical peak shapes and smooth baseline. Therefore, the blank solution was used to prepare the test substance and the reference substance.

1. A method for detecting contents and fingerprints of active ingredients in Compound Kushen Injection, comprising: performing detection by using a high-performance liquid chromatography, wherein conditions for the high-performance liquid chromatography comprise a C₁₈ column as a chromatographic column; and the active ingredients comprise matrine, oxymatrine, macrozamin, sophocarpine, oxysophocarpine and sophoridine, or/and 2,3-dihydroxy-2-[(4-hydroxyphenyl)methyl]butanedioic acid.

2. The method according to claim 1, wherein the chromatographic column is selected from the group consisting of Waters XSelect CSH™ C₁₈, TechMate C₁₈-ST, Welch Ultimate AQ-C₁₈, and Waters SunFire C₁₈, more preferably Waters XSelect CSH™ C₁₈, with a dimension of 5 m and 4.6 mm×250 mm.

3. The method according to claim 2, wherein the method further comprises a mobile phase comprising methanol in the organic phase and a phosphate buffer gradient elution in the aqueous phase; preferably 0.1%-0.34% potassium dihydrogen phosphate-methanol gradient elution; and more preferably, 0.2% potassium dihydrogen phosphate-methanol gradient elution.

4. The method according to claim 3, wherein the pH value of potassium dihydrogen phosphate is adjusted to 2.9-3.1, more preferably to 3.0, with phosphoric acid.

5. The method according to claim 3, wherein conditions for gradient elution are:

| | | 0.2% potassium |
|---|---|---|
| | | dihydrogen phosphate |
| | | (adjusted to pH3.0 with |
| time (min) | methanol (%) | phosphoric acid) (%) |
| 0-10 | 3 | 97 |
| 10-15 | 3-5 | 97-95 |
| 15-24 | 5-15 | 95-85 |
| 24-30 | 15 | 85 |
| 30-55 | 15-85 | 85-15 |
| 55-60 | 85 | 15 |
| 60-75 | 3 | 97 |

6. The method according to claim 1, wherein conditions for the high performance liquid chromatography in the method comprise a column temperature of 28-32° C., preferably 30° C.

7. The method according to claim 1, wherein conditions for the high performance liquid chromatography in the method comprise a flow rate of 0.58-0.62 ml/ml, preferably 0.6 ml/min.

8. The method according to claim 1, wherein conditions for the high performance liquid chromatography in the method comprise a detection wavelength of 209-213 nm, preferably 211 nm.

9. The method according to claim 1, wherein conditions for the high performance liquid chromatography in the method comprise an injection amount of 3-20 μl, preferred 5-15 μl, more preferred 8-12 μl, and most preferably 10 μl.

10. The method according to claim 1, wherein conditions for the high performance liquid chromatography in the method comprise preparation of blank solution: adjusting a pH value of potassium dihydrogen phosphate solution to 3.0 with phosphoric acid, preparing a mixed solution of 0.2% potassium dihydrogen phosphate solution-methanol=85:15, and filtering.

11. The method according to claim 1, wherein conditions for the high performance liquid chromatography in the method comprise:
preparation of reference substance solution:
accurately weighing an appropriate amount of matrine reference substance, oxymatrine reference substance, and oxysophocarpine reference substance, adding the blank solution to prepare a mixed reference substance solution I containing 0.33 mg of matrine, 0.85 mg of oxymatrine, and 0.25 mg of oxysophocarpine per 1 ml, and shaking, which is obtained; accurately weighing an appropriate amount of sophocarpine reference substance, sophoridine reference substance, and macrozamin reference substance, adding the blank solution to prepare a mixed reference substance solution II containing 0.09 mg of sophocarpine, 0.08 mg of sophoridine, and 0.08 mg of macrozamin per 1 ml, and shaking, which is obtained; and accurately weighing 2 ml of the mixed reference substance solution I and II, adding to a 10 ml volumetric flask, diluting with the blank solution to scale, and shaking, which is obtained; or
accurately weighing an appropriate amount of 2,3-dihydroxy-2-[(4-hydroxyphenyl)methyl]butanedioic acid reference substance, adding the blank solution to prepare a reference substance stock solution containing 0.25 mg of 2,3-dihydroxy-2-[(4-hydroxyphenyl)methyl]butanedioic acid per 1 ml, and shaking, which is obtained; and accurately weighing 2 ml of the reference substance stock solution, adding to a 10 ml volumetric flask, diluting with the blank solution to scale, and shaking, which is obtained.

12. The method according to claim 1, wherein conditions for the high performance liquid chromatography in the method comprise the preparation of the test substance solution: accurately weighing 1 ml of Compound Kushen Injection, adding to a 50 ml volumetric flask, adding a blank solution to scale, shaking, filtering, and taking the subsequent filtrate as the test substance solution.

13. A method for detecting the content of active ingredients in Compound Kushen Injection according to claim 1, wherein performing detection by using a high-performance liquid chromatography method, and wherein conditions for the high-performance liquid chromatography comprise:

| | Detection conditions | | |
|---|---|---|---|
| Chromatographic | Waters XSelect CSH ™ C18 (5 μm, 4.6 mm × 250 mm) | | |
| column | | | |
| Mobile phase | 0.2% Potassium dihydrogen phosphate solution | | |
| | (adjusted to pH 3.0 with phosphoric acid)- | | |
| | Methanol gradient elution | | |
| | | Methanol | 0.2% Potassium |
| | Time (min) | (%) | dihydrogen phosphate(%) |
| Elution | 0-10 | 3 | 97 |
| gradient | 10-15 | 3-5 | 97-95 |
| | 15-24 | 5-15 | 95-85 |
| | 24-30 | 15 | 85 |
| | 30-55 | 15-85 | 85-15 |
| | 55-60 | 85 | 15 |
| | 60-75 | 3 | 97 |
| | | |
|---|---|---|
| Column | 30° | C. |
| temperature | | |
| Detection | 211 | nm |
| length | | |
| Flowing speed | 0.6 | ml/min |
| Injection | 10 | μl |

volume
(1) Preparation of a blank solution: adjusting the pH value of potassium dihydrogen phosphate solution to 3.0 with phosphoric acid, preparing a mixed solution of 0.2% potassium dihydrogen phosphate solution-methanol=85:15, and filtering, which is obtained;
(2) Preparation of a reference substance solution: accurately weighing an appropriate amount of matrine reference substance, oxymatrine reference substance, and oxysophocarpine reference substance, adding the blank solution to prepare a mixed reference substance solution I containing 0.33 mg of matrine, 0.85 mg of oxymatrine, and 0.25 mg of oxysophocarpine per 1 ml, and shaking, which is obtained; accurately weighing an appropriate amount of sophocarpine reference substance, sophoridine reference substance, and macrozamin reference substance, adding a blank solution to prepare a mixed reference substance solution II containing 0.09 mg of sophocarpine, 0.08 mg of sophoridine, and 0.08 mg of macrozamin per 1 ml, and shaking, which is obtained; and accurately weighing 2 ml of mixed reference substance solution I and II, adding to a 10 ml volumetric flask, diluting with the blank solution to scale, and shaking, which is obtained; or,
accurately weighing an appropriate amount of 2,3-dihydroxy-2-[(4-hydroxyphenyl)methyl]butanedioic acid reference substance, adding the blank solution to prepare a reference substance stock solution containing 0.25 mg of 2,3-dihydroxy-2-[(4-hydroxyphenyl)methyl]butanedioic acid per 1 ml, and shaking, which is obtained; and accurately weighing 2 ml of the reference substance stock solution, adding to a 10 ml volumetric flask, diluting with the blank solution to scale, and shaking, which is obtained;
(3) Preparation of test substance solution: accurately weighing 1 ml of Compound Kushen Injection, adding to a 50 ml volumetric flask, adding the blank solution to scale, shaking, filtering to obtain a subsequent filtrate as the test substance solution; and
(4) Injecting the blank solution, the reference substance solution, and the test substance solution into the liquid chromatograph in sequence, recording the chromatogram, and calculating the content using an external standard method.

14. A method for detecting a fingerprint of Compound Kushen Injection according to claim 1, wherein the method comprises constructing a fingerprint of the Compound Kushen Injection containing matrine, oxymatrine, macrozamin, sophocarpine, oxysophocarpine, and sophoridine.

15. The method for detecting a fingerprint of Compound Kushen Injection according to claim 14, wherein the method comprises: performing detection by using a high-performance liquid chromatography, and wherein the conditions for the high-performance liquid chromatography comprise:

| | Detection conditions | | |
|---|---|---|---|
| Chromatographic | Waters XSelect CSH ™ C₁₈ (5 μm, 4.6 mm × 250 mm) | | |
| column | | | |
| Mobile phase | 0.2% Potassium dihydrogen phosphate solution | | |
| | (adjusted to pH 3.0 with | | |
| | phosporic acid)-Methanol gradient elution | | |
| | | Methanol | 0.2% Potassium |
| | Time (min) | (%) | dihydrogen phosphate(%) |
| Elution | 0-10 | 3 | 97 |
| gradient | 10-15 | 3-5 | 97-95 |
| | 15-24 | 5-15 | 95-85 |
| | 24-30 | 15 | 85 |
| | 30-55 | 15-85 | 85-15 |
| | 55-60 | 85 | 15 |
| | 60-75 | 3 | 97 |
| | | |
|---|---|---|
| Column | 30° | C. |
| temperature | | |
| Detection | 211 | nm |
| length | | |
| Flowing speed | 0.6 | ml/min |
| Injection | 10 | μl |
| volume | | |

(1) Preparation of a blank solution: adjusting the pH value of potassium dihydrogen phosphate solution to 3.0 with phosphoric acid, preparing a mixed solution of 0.2% potassium dihydrogen phosphate solution-methanol=85:15, and filtering, which is obtained;
(2) Preparation of reference substance solution: accurately weighing an appropriate amount of matrine reference substance, oxymatrine reference substance, and oxysophocarpine reference substance, adding the blank solution to prepare a mixed reference substance solution I containing 0.33 mg of matrine, 0.85 mg of oxymatrine, and 0.25 mg of oxysophocarpine per 1 ml, and shaking, which is obtained; accurately weighing an appropriate amount of sophocarpine reference substance, sophoridine reference substance, and macrozamin reference substance, adding the blank solution to prepare a mixed reference substance solution II containing 0.09 mg of sophocarpine, 0.08 mg of sophoridine, and 0.08 mg of macrozamin per 1 ml, and shaking, which is obtained; and accurately weighing 2 ml of the mixed reference substance solution I and II, adding to a 10 ml volumetric flask, diluting with the blank solution to scale, and shaking; or
(3) Preparation of test substance solution: accurately weighing 1 ml of the Compound Kushen Injection, adding to a 50 ml volumetric flask, adding the blank solution to scale, shaking, and filtering to obtain a subsequent filtrate as the test substance solution;
(4) Injecting samples in the order of the blank solution, reference substance solution, and the test substance solution to construct a fingerprint of the Compound Kushen Injection containing matrine, oxymatrine, macrozamin, sophocarpine, oxysophocarpine, and sophoridine; and
(5) Detection: injecting samples in the order of the blank solution, the reference substance solution, and the test substance solution to perform detection.

16. The method according to claim 15, wherein the fingerprint in step (4) has 10 common characteristic peaks, wherein, based on peak 7-oxymatrine as a reference, the relative retention time of peak 1-sophoramine is 0.442; the relative retention time of peak 2-macrozamin is 0.603; the relative retention time of peak 3-matrine is 0.693; the relative retention time of peak 4-sophocarpine is 0.816; the relative retention time of peak 5-sophoridine is 0.845; the relative retention time of peak 6-oxysophocarpine is 0.941; the relative retention time of peak 7-oxymatrine is 1.0; the relative retention time of peak 8-2,3-dihydroxy-2-[(4-hydroxyphenyl)methyl]butanedioic acid is 1.149; the relative retention time of peak 9 is 1.639; and the relative retention time of peak 10-trifolirhizin is 1.888.
